(19) United States
(12) Patent Application Publication
(10) Pub. No.: US 2024/0235377 A1
(43) Pub. Date: Jul. 11, 2024

(54) POWER SUPPLY CONTROL DEVICE

(71) Applicant: ROHM CO., LTD., KYOTO (JP)

(72) Inventor: Shidong GUAN, KYOTO (JP)

(21) Appl. No.: 18/395,075

(22) Filed: Dec. 22, 2023

(30) Foreign Application Priority Data
Dec. 27, 2022 (JP) 2022-210815
Dec. 27, 2022 (JP) 2022-210816
Dec. 27, 2022 (JP) 2022-210820
Oct. 11, 2023 (JP) 2023-175940

(51) Int. Cl. H02M 1/32; H02M 1/00; H02M 3/158

(52) U.S. Cl. CPC H02M 1/322; H02M 1/0009; H02M 1/0019; H02M 3/158

(57) ABSTRACT

The present disclosure provides a power supply control device. An output voltage is generated from an input voltage by switching driving an output stage based on a feedback voltage corresponding to the output voltage. An overcurrent protection signal is output when a value of a current flowing through the output stage exceeds a predetermined overcurrent threshold. An overcurrent protection operation is performed in response to the overcurrent protection signal, and the overcurrent protection operation limits an increase in the current flowing through the output stage exceeding the overcurrent threshold. The overcurrent threshold is set according to an elapsed time from a start of switching driving of the output stage.

### TECHNICAL FIELD

The present disclosure relates to a power supply control device.

### BACKGROUND

In a switch power supply device that generates an output voltage from an input voltage, a power supply control device controlling an output stage is provided. In the power supply control device, a protection function that performs a predetermined protection operation upon detecting an overcurrent state of the output stage is usually provided.

### PRIOR ART DOCUMENT

### Patent Publication

[Patent publication 1] International Publication No. 2020/095748

### BRIEF DESCRIPTION OF THE DRAWINGS

FIG. 1 is a diagram of a brief overall configuration of a switching power supply device of embodiments of the present disclosure.

FIG. 2 is a diagram of an overall configuration of a switching power supply device including an internal configuration diagram of a power supply control device according to an embodiment EX1_1 of embodiments of the present disclosure.

FIG. 3 is a timing diagram of a basic switching control according to the embodiment EX1_1 of embodiments of the present disclosure.

FIG. 4 is a diagram of currents associated with an output stage according to the embodiment EX1_1 of embodiments of the present disclosure.

FIG. 5 is a timing diagram when an overcurrent protection operation is performed according to the embodiment EX1_1 of embodiments of the present disclosure.

FIG. 6 is a timing diagram when a switching power supply device of the embodiment EX1_1 of embodiments of the present disclosure is started.

FIG. 7 is a diagram of a poor start.

FIG. 8 is a diagram of a variation example of an overcurrent threshold according to the embodiment EX1_1 of embodiments of the present disclosure.

FIG. 9 is a diagram of an example of a circuit for setting an overcurrent threshold according to the embodiment EX1_1 of embodiments of the present disclosure.

FIG. 10 is a timing diagram related to circuits in FIG. 9 according to the embodiment EX1_1 of embodiments of the present disclosure.

FIG. 11 is a diagram of another example of changes in an overcurrent threshold according to the embodiment EX1_1 of embodiments of the present disclosure.

FIG. 12 is a diagram of an example of a circuit for setting an overcurrent threshold according to the embodiment EX1_1 of embodiments of the present disclosure.

FIG. 13 is a timing diagram related to circuits in FIG. 12 according to the embodiment EX1_1 of embodiments of the present disclosure.

FIG. 14 is a diagram of a brief overall configuration of a switching power supply device according to an embodiment EX1_2 of embodiments of the present disclosure.

FIG. 15 is a diagram of a partial configuration of a step-up switching power supply device according to an embodiment EX1_3 of embodiments of the present disclosure.

FIG. 16 is a diagram of an overall configuration of a switching power supply device including an internal configuration diagram of a power supply control device according to an embodiment EX2_1 of embodiments of the present disclosure.

FIG. 17 is a timing diagram of a basic switching control according to the embodiment EX2_1 of embodiments of the present disclosure.

FIG. 18 is a diagram of currents associated with an output stage according to the embodiment EX2_1 of embodiments of the present disclosure.

FIG. 19 is a timing diagram when an overcurrent protection operation is performed according to the embodiment EX2_1 of embodiments of the present disclosure.

FIG. 20 is a diagram for illustrating changes in an output voltage and an error voltage corresponding to changes in an output current in a hypothetical configuration.

FIG. 21 is a diagram for illustrating changes in an output voltage and an error voltage corresponding to changes in an output current in an improved configuration.

FIG. 22 is a diagram of a variation configuration of an error voltage change suppression circuit according to an embodiment EX2_3 of embodiments of the present disclosure.

FIG. 23 is a diagram of a partial configuration of a power supply control device according to an embodiment EX2_4 of embodiments of the present disclosure.

FIG. 24 is a diagram of an overall configuration of a switching power supply device including an internal configuration diagram of a power supply control device according to an embodiment EX3_1 of embodiments of the present disclosure.

FIG. 25 is a timing diagram of a basic switching control according to the embodiment EX3_1 of embodiments of the present disclosure.

FIG. 26 is a timing diagram related to a pulse skip control according to the embodiment EX3_1 of embodiments of the present disclosure.

FIG. 27 is a timing diagram related to a pulse skip control according to the embodiment EX3_1 of embodiments of the present disclosure.

FIG. 28 is a diagram of a relationship example between a target temperature and a skip determination voltage according to the embodiment EX3_1 of embodiments of the present disclosure.

FIG. 29 is a diagram of a relationship example between a target temperature and a skip determination voltage according to the embodiment EX3_1 of embodiments of the present disclosure.

FIG. 30 is a diagram of a configuration of a skip determination voltage generation circuit according to the embodiment EX3_1 of embodiments of the present disclosure.

FIG. 31 is a diagram of a partial configuration of a power supply control device according to an embodiment EX3_2 of embodiments of the present disclosure.

FIG. 32 is a diagram of a partial configuration of a power supply control device according to an embodiment EX3_3 of embodiments of the present disclosure.

### DETAILED DESCRIPTION OF THE EMBODIMENTS

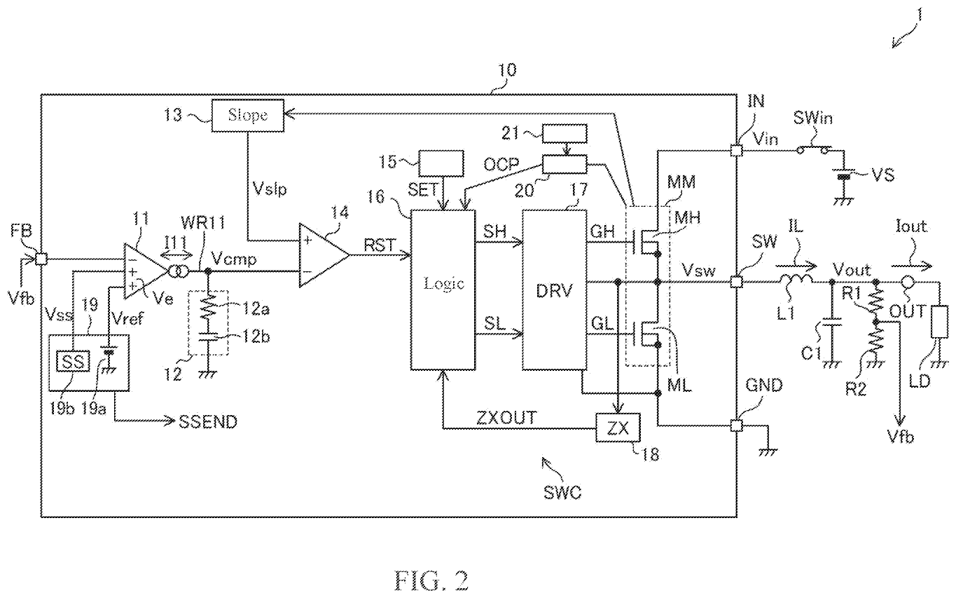

Details of examples of the embodiments of the present disclosure are provided with the accompanying drawings below. In the reference drawings, the same parts are denoted by the same numerals or symbols, and repeated description related to the same parts are in principle omitted. Moreover, in the present application, in order to keep the description simple, by means of describing numerals or symbols of reference information, signals, physical quantities, functional units, circuits, elements or parts, names of information, signals, physical quantities, functional units, circuits, elements or parts corresponding to the numerals or symbols are sometimes omitted or abbreviated. For example, an overcurrent protection circuit (referring to FIG. 2) referenced by “20” below can be expressed as an overcurrent protection circuit 20, or can be referred to as a circuit 20 for short, with however both referring to the same circuit.

Some terms and definitions of configurations used in the description of the embodiments of the present disclosure are first explained below. A so-called “ground portion” refers to a reference conductive portion having a reference voltage of 0 V potential or the 0 V potential itself. The reference conductive portion can be a conductor formed of such as metal. The 0 V potential is sometimes referred to as a ground potential. In the embodiments of the disclosure, a voltage expressed without a specifically configured reference represents a potential viewed from a ground portion.

For any concerned signal or voltage, the level refers to the level of a potential, and a high level has a potential greater than that of a low potential. For any concerned signal or voltage, the signal or voltage at a high level strictly means that the level of the signal or voltage is at a high level, and the signal or voltage at a low level strictly means that the level of the signal or voltage is at a low level.

For any concerned signal or voltage, switching from a low level to a high level is referred to as a rising edge. The rising edge can also be replaced by a leading edge. For any concerned signal or voltage, switching from a high level to a low level is referred to as a falling edge. The falling edge can also be replaced by a trailing edge.

For any transistor formed as a field-effect transistor (FET) including a metal-oxide-semiconductor field-effect transistor (MOSFET), an on state refers to a state of conduction between the drain and the source of the transistor, and an off state refers to a state of non-conduction (a state of disconnection) between the drain and the source of the transistor. The same applies to those categorized as non-FET transistors. Unless otherwise specified, a MOSFET is to be understood as an enhanced MOSFET. The term MOSFET is an abbreviation of metal-oxide-semiconductor field-effect transistor. Moreover, unless otherwise specified, in any MOSFET, it is considered that the back gate is shorted with the source.

In the description below, for any transistor, the on state and the off state may also be expressed simply as on and off. For any transistor, switching from a state of disconnection to a state of conduction is expressed as turning on, and switching from a state of conduction to a state of disconnection is expressed as turning off. Moreover, for any transistor, a period in which the transistor becomes in an on state is referred to as an on period, and a period in which the transistor becomes in an off state is referred to as an off period. For any signal of which the signal level is a high level or a low level, a period in which the level of the signal becomes a high level is referred to as a high level period, and a period in which the level of the signal becomes a low level is referred to as a low level period. The same applies to any voltage of which the voltage level adopts a high level or a low level.

Unless otherwise specified, a connection formed between multiple parts of a circuit, such as any circuit elements, wires and nodes that form a circuit, is to be understood as an electrical connection.

For any two voltages Va and Vb used for comparison, “Va>Vb” means that the voltage Va is greater than the voltage Vb, and “Va<Vb” means that the voltage Va is lower than the voltage Vb. The same applies to other equations including physical quantities other than voltages.

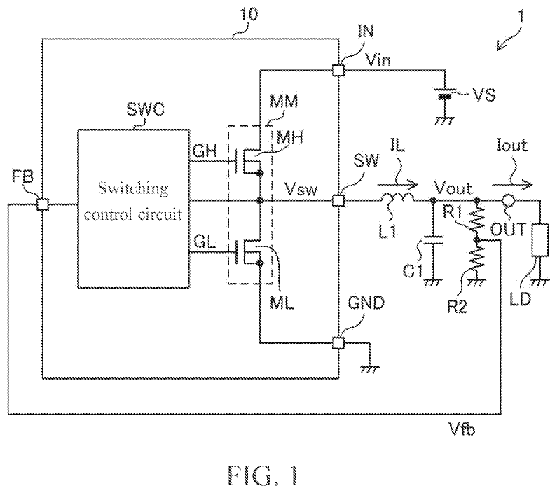

FIG. 1 shows a diagram of an overall configuration of a switching power supply device 1 according to an embodiment of the present disclosure. The switching power supply device 1 in FIG. 1 includes a power supply control device 10, and multiple discrete components externally connected to the power supply control device 10. The multiple discrete components include a coil L1 serving as an output coil, a capacitor C1 serving as an output capacitor, and resistors R1 and R2 serving as feedback resistors. The switching power supply device 1 is configured as a step-down switching power supply device (direct-current/direct-current (DC/DC) converter) that generates a desired output voltage Vout from an input voltage Vin supplied from a voltage source VS. The output voltage Vout is generated at an output terminal OUT. That is to say, the output terminal OUT is an application end of the output voltage Vout (a terminal applied with the output voltage Vout). The output voltage Vout is supplied to a load LD connected to the output terminal OUT. Moreover, a current flowing through the output terminal OUT to the load LD is referred to as an output current Iout.

The input voltage Vin and the output voltage Vout are positive DC voltages, and the output voltage Vout is lower than the input voltage Vin. For example, when the input voltage Vin is 12 V, the output voltage Vout is stabilized at a desired positive voltage value (such as 3.3 V or 5 V) less than 12 V by adjusting resistance values of resistors R1 and R2.

The power supply control device 10 is an electronic component including: a semiconductor chip having a semiconductor integrated circuit formed on a semiconductor substrate, a housing (a package) accommodating the semiconductor chip, and a plurality of external terminals exposed outside the power supply control device 10 from the housing. The power supply control device 10 is formed by packaging the semiconductor chip in the housing (package) formed of a resin. In FIG. 1, as a part of the plurality of external terminals provided at the power supply control device 10, only an input terminal IN, a switch terminal SW, a feedback terminal FB and a ground terminal GND (the same applies to FIG. 2 to be described shortly) are depicted; however, other external terminals (for example, an enable terminal, a power good terminal and a bootstrap terminal) are also disposed at the power supply control device 10. An output stage MM and a switching control circuit SWC shown in FIG. 1 are formed by semiconductor integrated circuits.

An external configuration of the power supply control device 10 is described below. The input voltage Vin is supplied from external voltage source VS provided outside the power supply control device 10 to the input terminal IN. The coil L1 is connected in series between the switch terminal SW and the output terminal OUT. That is to say, one end of the coil L1 is connected to the switch terminal SW, and the other end of the coil L1 is connected to the output terminal OUT. Moreover, the output terminal OUT is grounded via the capacitor C1. In addition, the output terminal OUT is connected to one end of the resistor R1, and the other end of the resistor R1 is grounded via the resistor R2. A feedback voltage Vfb is generated at a connection node between the resistors R1 and R2. The connection node between the resistors R1 and R2 is connected to the feedback terminal FB, and the feedback voltage Vfb is accordingly input to the feedback terminal FB. The ground terminal GND is grounded.

Moreover, a current flowing through the coil L1 is referred to as a coil current IL. The coil current IL from the switch terminal SW toward the output terminal OUT is positive in polarity, and the coil current IL in an opposite direction is negative in polarity.

An internal configuration of the power supply control device 10 is described below. The power supply control device 10 includes the output stage MM, and the switching control circuit SWC configured to control the output stage MM.

The output stage MM includes transistors MH and ML which are N-channel MOSFETs. The transistors MH and ML are a pair of switching elements connected in series between the input terminal IN and the ground terminal GND (in other words, a ground portion), the input voltage Vin is switched by performing a switching drive on the transistors MH and ML, and a switching voltage Vsw in a rectangular wave appears in the switch terminal SW. The transistor MH is disposed at a high potential side compared to the transistor ML. More specifically, a drain of the transistor MH is connected to the input terminal IN which is an application end of the input voltage Vin, and receives a supply of the input voltage Vin. A source of the transistor MH and a drain of the transistor ML are commonly connected to the switch terminal SW. A source of the transistor ML is connected to the ground terminal GND (hence grounded). However, there are cases where a resistor for current detection is placed between the source of the transistor ML and the ground terminal GND.

The transistor MH functions as an output element (an output transistor), and the transistor ML functions as a rectifier (a synchronous rectifier transistor). Under the switching drive of the output stage MM, the output element (MH) and the rectifier (ML) are alternately turned on and turned off. The coil L1 and the capacitor C1 form a rectifier and smoothing circuit that generates the output voltage Vout by rectifying and smoothing the switching voltage Vsw in a rectangular wave appearing in the switch terminal SW. The resistors R1 and R2 form a feedback voltage generation circuit that generates the feedback voltage Vfb corresponding to the output voltage Vout by dividing the output voltage Vout. The feedback voltage Vfb is proportional to the output voltage Vout, and the feedback voltage Vfb also rises or decreases as the output voltage Vout increases or decreases. Moreover, the output voltage Vout itself can also be used as a change in the feedback voltage Vfb. In all cases, the feedback voltage Vfb is a voltage corresponding to the output voltage Vout.

Gate signals GH and GL are respectively supplied to the gates of the transistors MH and ML as drive signals, and the transistors MH and ML are turned on or turned off according to the gate signals GH and GL. The transistor MH is in an on state when the gate signal GH is at a high level, and the transistor MH is in an off state when the gate signal GH is at a low level. Similarly, the transistor ML is in an on state when the gate signal GL is at a high level, and the transistor ML is in an off state when the gate signal GL is at a low level. Basically, the transistors MH and ML are turned on and turned off alternately; however, there are cases where both of the transistors MH and ML are kept as turned off. The transistors MH and ML are not set to be in an on state at the same time. Moreover, at least one of the output element (MH) and the rectifier (ML) can be arranged outside the power supply control device 10. There are cases where the output stage MM is entirely disposed outside the power supply control device 10.

During an on period of the transistor MH, the coil current IL flows through a channel (between the drain and the source) of the transistor MH. During an off period of the transistor MH, the coil current IL flows through a channel of the transistor ML or a parasitic diode of the transistor ML.

The switching control circuit SWC generates the desired output voltage Vout at the output terminal OUT by controlling the respective on/off states of the transistors MH and ML by level controls of the gate signals GH and GL based on the feedback voltage Vfb.

Moreover, although not specifically depicted, an internal power supply circuit that generates an internal power supply voltage based on the input voltage Vin is provided in the power supply control device 10. The circuits in the power supply control device 10 are driven based on the input voltage Vin or the internal power supply voltage. Although not specifically depicted, the circuits of the power supply control device 10 are grounded. Moreover, the gate signal GL is a signal regarding the ground potential as a reference, and in contrast, the gate signal GH is a signal regarding a potential of the switch terminal SW as a reference. The gate signal GH at a low level has the potential of the switch terminal SW, and the gate signal GH at a high level is greater than the potential of the switch terminal SW by a predetermined voltage. The predetermined voltage herein is greater than a gate threshold voltage of the transistor MH. A step-up power supply for generating the gate signal GH can be generated by using a well-known bootstrap circuit (not shown). The transistor MH can also be implemented by a P-channel MOSFET, and in this case, no step-up power supply is needed.

Moreover, as a variation, a diode rectification approach can also be used in the switching power supply device 1. In this case, as a rectifier in substitution for the transistor ML, a synchronous rectifier diode having an anode connected to the ground terminal GND and a cathode connected to the switch terminal SW is provided in the switching power supply device 1. In this case, only the output element (MH) is turned on or turned off during the switching drive of the output stage MM. In all cases, by switching the output element (MH) between on and off during the switching drive of the output stage MM, the output voltage Vout is generated based on the current (IL) flowing through the coil L1.

In the multiple embodiments below, some specific configuration examples, operation examples, application techniques and variation techniques with respect to the switching power supply device 1 are described. Unless otherwise specified and without any contradiction, the matters enumerated in this embodiment are applicable to the various embodiments below. In the various embodiments, the description of the embodiments can be considered as overruling in case of any matters contradictory to the matters described above. Provided there are not contradictions, the matters described in any one of the embodiments EX1_1 to EX1_3 below are also applicable to any other embodiment. Provided there are not contradictions, the matters described in any one of the embodiments EX2_1 to EX2_5 below are also applicable to any other embodiment. Provided there are not contradictions, the matters described in any one of the embodiments EX3_1 to EX3_4 below are also applicable to any other embodiment. Basically, the matters shown in the embodiments EX1_1 to EX1_3 are merely applied to the embodiments EX1_1 to EX1_3, the matters shown in the embodiments EX2_1 to EX2_5 are merely applied to the embodiments EX2_1 to EX2_5, and the matters shown in the embodiments EX3_1 to EX3_4 are merely applied to the embodiments EX3_1 to EX3_4. However, provided that there are no contradictions, the matters described in any one of the embodiments EX1_1 to EX1_3, EX2_1 to EX2_5 and EX3_1 to EX3_4 are also applicable to any other embodiment.

### Embodiment EX_1

The embodiment EX1_1 is described below. FIG. 2 shows a diagram of a configuration of the switching power supply device 1 according to the embodiment EX1_1. In the embodiment EX1_1, a switch SWin is placed between the voltage source VS and the input terminal IN. A positive DC voltage is output from an output terminal of the voltage source VS. When the switch SWin is off, the output terminal of the voltage source VS and the input terminal IN are disconnected in between, and the output voltage of the voltage source VS is not applied to the input terminal IN. When the switch SWin is off, except during a transient response, the voltage of the input terminal IN is 0 V. When the switch SWin is on, the output voltage of the voltage source VS is used as the input voltage Vin and applied to the input terminal IN. Unless otherwise specified below, it is assumed that the switch SWin is kept on.

An internal configuration of the power supply control device 10 of the embodiment EX1_1 is described below. The power supply control device 10 includes an output stage MM, an error amplifier 11, a phase compensation circuit 12, a slope voltage generation circuit 13, a reset comparator 14, a setting signal generation circuit 15, a logic circuit 16, a driver 17, a reverse current detection circuit 18, a comparison voltage supply circuit 19, an overcurrent protection circuit 20 and a threshold setting circuit 21. In the embodiment EX1_1, the switching control circuit SWC in FIG. 1 has various parts denoted by numerals 11 to 21. Signals RST, SET, SH, SL, ZXOUT, OCP and SSEND described below are binary signals with a signal level in a high level or a low level. The signal SET functions as a setting signal, and the signal RST functions as a reset signal. Alternatively, it can also be considered that only the signal SET at a high level functions as a setting signal, and only the signal RST at a high level functions as a reset signal.

The error amplifier 11 is a current output transconductance amplifier. The error amplifier 11 includes an inverting input terminal, a first non-inverting input terminal, a second non-inverting input terminal and an output terminal. The inverting input terminal of the error amplifier 11 is connected to the feedback terminal FB to receive the feedback voltage Vfb. A soft-start voltage Vss and a reference voltage Vref are respectively supplied to the first non-inverting input terminal and the second non-inverting input terminal of the error amplifier 11. The voltages Vss and Vref are supplied from the comparison voltage supply circuit 19 to the error amplifier 11. The output terminal of the error amplifier 11 is connected to a wiring WR11 (an error output wiring).

The error amplifier 11 uses the lower one of the soft-start voltage Vss and the reference voltage Vref supplied to the first and second non-inverting input terminals as a comparison voltage, and compares the comparison voltage with the feedback voltage Vfb. The comparison voltage is represented by “Ve” herein. If “Vss<Vref”, then “Ve=Vss”; if “Vss>Vref”, then “Ve=Vref”. If “Vss=Vref”, then “Ve=Vss=Vref”. The reference voltage Vref is fixed at a predetermined positive DC voltage. On the other hand, the soft-start voltage Vss increases gradually from a voltage lower than the reference voltage Vref to a voltage greater than the reference voltage Vref (details described below) during a predetermined period.

The error amplifier 11 generates a voltage according to a difference between the feedback voltage Vfb and the comparison voltage Ve in the wiring WR11 by outputting a current signal Ill corresponding to the difference between the feedback voltage Vfb and the comparison voltage Ve from its output terminal. The voltage applied to the wiring RW11 is an error voltage Vcmp. However, a voltage after level shifting the voltage applied to the wiring WR11 can also be the error voltage Vcmp. A charge of the current signal Ill is input/output with respect to the wiring WR11. More specifically, the error amplifier 11 outputs a current of the current signal Ill from the error amplifier 11 to the wiring WR11 in a manner that a potential of the wiring WR11 increases when the feedback voltage Vfb is lower than the comparison voltage Ve, and sinks the current of the current signal Ill from the wiring WR11 to the error amplifier 11 in a manner that the potential of the wiring WR11 decreases when the feedback voltage Vfb is greater than the comparison voltage Ve. As an absolute value of the difference between the feedback voltage Vfb and the comparison voltage Ve increases, a size of the current of the current signal Ill also increases.

The phase compensation circuit 12 is disposed between the wiring WR11 and the ground portion, and receives an input of the current signal Ill and compensates for a phase of the voltage of the wiring WR11 (a phase of the error voltage Vcmp). The phase compensation circuit 12 includes a series circuit of a resistor 12a (a phase compensation resistor) and a capacitor 12b (a phase compensation capacitor). More specifically, one end of the resistor 12a is connected to the wiring WR11, and the other end of the resistor 12a is grounded via the capacitor 12b. By appropriately setting a resistance value of the resistor 12a and an electrostatic capacitance value of the capacitor 12b, the phase of the voltage of the wiring WR11 (the phase of the error voltage Vcmp) can be compensated to prevent an oscillation in an output feedback loop.

The slope voltage generation circuit 13 generates and outputs a slope voltage Vslp in a ramp waveform. The slope voltage Vslp has information indicating a value of the coil current IL (hereinafter referred to as current information of the coil L1 below). More specifically, the circuit 13 generates a sensing voltage proportional to a current flowing to the transistor MH (hence the coil current IL) during an on period of the transistor MH, and a slope voltage gradually increasing from 0 V during an on period of the transistor MH. A voltage obtained by adding the sensing voltage and the slope voltage generated by the circuit 13 during an on period of the transistor MH (that is, a sum of the sensing voltage and the slope voltage) is used as the slope voltage Vslp. Thus, during an on period of the transistor MH, the slope voltage Vslp monotonically increases. By adding the slope voltage, a sub-harmonic oscillation that may occur under current mode control can be suppressed.

Moreover, given that the sensing voltage has current information of the coil L1, any method for generating the sensing voltage can be used. For example, the sensing voltage can be generated by detecting a current flowing to the transistor ML (hence the coil current IL) during an on period of the transistor ML. Alternatively, the sensing voltage can be generated by detecting the coil current IL directly by a current sensor. The slope voltage Vslp only needs to function in an obvious way during an on period of the transistor MH, and can be fixed at 0 V during an off period of the transistor MH.

The error voltage Vcmp and the slope voltage Vslp are supplied to the reset comparator 14. The reset comparator 14 generates and outputs the signal RST based on the error voltage Vcmp and the slope voltage Vslp. In the reset comparator 14, an inverting input terminal is connected to the wiring WR11 and receives the error voltage Vcmp, and a non-inverting input terminal receives the slope voltage Vslp. Thus, the reset comparator 14 outputs the signal RST at a low level when “Vemp>Vslp” holds true, and outputs the signal RST at a high level when “Vemp<Vslp” holds true. When “Vemp=Vslp” holds true, the signal RST is at a low level or a high level.

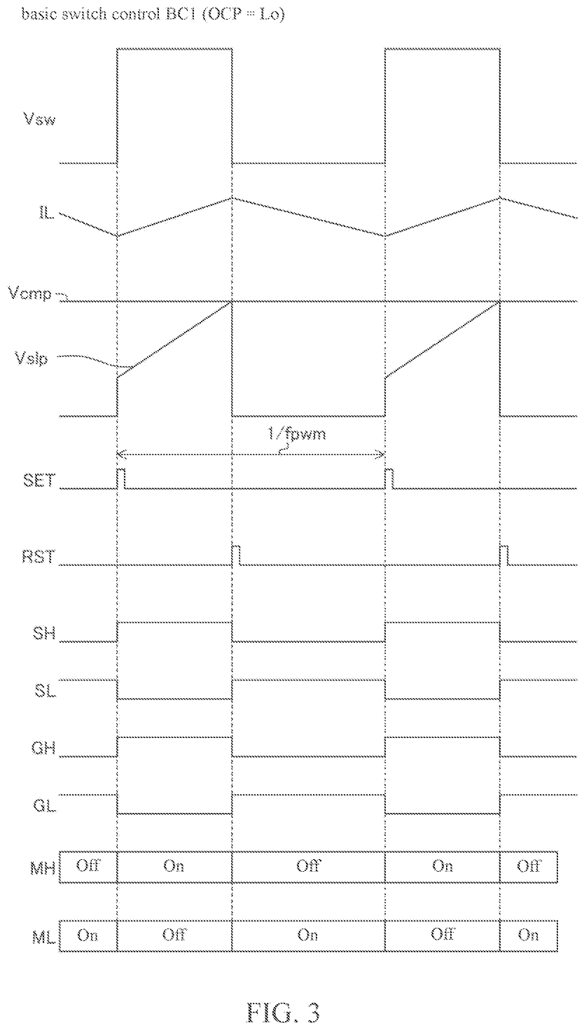

FIG. 3 shows waveforms of several signals including the signal RST. During an on period of the transistor MH, the slope voltage Vslp monotonically increases. When the slope voltage Vslp switches from a state of “Vemp>Vslp” to a state of “Vemp<Vslp” during a rising process, the reset comparator 14 causes the signal RST to generate a rising edge. Since the rising edge of the signal RST is used as an opportunity to transit to an off period of the transistor MH and to return the slope voltage Vslp to 0 V, a high level period of the signal RST is relatively small. Except for a special condition such as immediately after power is supplied to the power supply control device 10, “Vcmp>0” holds true.

The setting signal generation circuit 15 generates and outputs the signal SET having a predetermined frequency fpwm. The signal SET is a signal that generates a pulse at the frequency fpwm. That is to say, in each cycle of the signal SET, a pulse that becomes a high level only in a minute time is generated in the signal SET. The setting signal generation circuit 15 can be formed by using an oscillator oscillating at the frequency fpwm. A length of one cycle of the signal SET is a reciprocal of the frequency fpwm. A rising edge is generated in the signal SET at an interval of the reciprocal of the frequency fpwm. The reciprocal of the frequency fpwm is referred to as a pulse width modulation (PWM) cycle below.

The logic circuit 16 generates and outputs control signals SH and SL based on the signals SET and RST. As shown in FIG. 3, the logic circuit 16 generates a rising edge in the control signal SH and generates a falling edge in the control signal SL by using a rising edge of the signal SET as an opportunity, and generates a falling edge in the control signal SH and generates a rising edge in the control signal SL by using a rising edge of the signal RST as an opportunity. Moreover, after the rising edge in the control signal SL is generated by using the rising edge of the signal RST as an opportunity, when a reverse current detection signal ZXOUT at a high level is input to the logic circuit 16, the logic circuit 16 does not wait for a next rising edge of the signal SET but generates a falling edge in the control signal SL.

Herein, an output signal (including a signal OCP) of the overcurrent protection circuit 20 is input to the logic circuit 16. It is also to be described below that, the operation of the logic circuit 16 is stopped during a period in which an overcurrent protection operation is performed based on the output signal of the overcurrent protection circuit 20.

The driver 17 is connected to the gates of the transistors MH and ML, the switch terminal SW and the ground terminal GND. The driver 17 individually turns on or turns off the transistors MH and ML by respectively supplying the gate signals GH and GL corresponding to the control signals SH and SL to the gates of the transistors MH and ML. The driver 17 turns on the transistor MH by setting the gate signal GH to a high level when the control signal SH is at a high level, and turns off the transistor MH by setting the gate signal GH to a low level when the control signal SH is at a low level. The driver 17 turns on the transistor ML by setting the gate signal GL to a high level when the control signal SL is at a high level, and turns off the transistor ML by setting the gate signal GL to a low level when the control signal SL is at a low level.

The logic circuit 16 does not set both of the control signals SH and SL at a high level at the same time. Thus, the transistor ML is always off during an on period of the transistor MH, and the transistor MH is always off during an on period of the transistor ML.

The reverse current detection circuit 18 compares the switching voltage Vsw with the ground potential during an on period of the transistor ML to detect whether there is a reverse current, and generates a reverse current detection signal ZXOUT indicating the detection result. The reverse current detection signal ZXOUT is supplied to the logic circuit 16. The reverse current refers to a current flowing from the switch terminal SW to the ground portion through the transistor ML, and is equivalent to the coil current IL in a negative value. A level of the reverse current detection signal ZXOUT is low when the switching voltage Vsw is lower than the ground potential, and is high when the switching voltage Vsw is greater than the ground potential. That is to say, the level of the reverse current detection signal ZXOUT becomes a high level when the coil current IL in a negative value is generated. By switching the transistor ML from on to off upon detecting the reverse current so as to cut off the reverse current, efficiency during a light load can be improved. The signal ZXOUT is kept at a low level unless otherwise specifically necessary.

The comparison voltage supply circuit 19 includes a reference voltage source 19a, and an SS circuit 19b which is a soft-start circuit. The reference voltage source 19a generates and outputs the reference voltage Vref. The reference voltage Vref has a fixed predetermined positive DC voltage value. The SS circuit 19b generates and outputs a soft-start voltage Vss. Characteristics of the voltage Vss are described below in detail. The voltages Vref and Vss generated by the circuit 19 are supplied to the error amplifier 11.

The overcurrent protection circuit 20, based on a size of a current flowing to the output stage MM, detects whether the output stage MM is in a state of overcurrent, and generates and outputs a signal OCP corresponding to the detection result. Upon detecting that the output stage MM is in a state of overcurrent, the overcurrent protection circuit 20 supplies the signal OCP at a high level to the logic circuit 16. Operation details of the overcurrent protection circuit 20 and the threshold setting circuit 21 as well as those of the logic circuit 16 in response to the signal OCP at a high level are described below. First of all, a basic switching control BC1 shown in FIG. 3 is described below.

### [Basic Switching Control BC1]

The switching control circuit SWC can switch and drive the output stage MM by using PWM control. PWM is an abbreviation for pulse width modulation. FIG. 3 shows a timing diagram of the basic switching control BC1 that can be performed by the switching control circuit SWC. The basic switching control BC1 is a PWM control performed in a current continuous mode, and is a PWM control performed while the signal OCP is maintained at a low level. In the current continuous mode, the coil current IL always flows from the switch terminal SW to the output terminal OUT. On the premise that the signal OCP is maintained at a low level, the logic circuit 16 generates a rising edge in the control signal SH and generates a falling edge in the control signal SL by using a rising edge of the signal SET as an opportunity, and generates a falling edge in the control signal SH and generates a rising edge in the control signal SL by using a rising edge of the signal RST as an opportunity. In the basic switching control BC1, a switching operation of alternately and periodically turning on and turning off the transistors MH and ML at the frequency fpwm is performed.

In the basic switching control BC1, the control signals SH and SL are PWM signals having the frequency fpwm. In the basic switching control BC1, a switching drive is performed on the transistors MH and ML at the frequency fpwm, and as a result, the switching voltage Vsw has the frequency fpwm. That is to say, in the basic switching control BC1, a switching frequency of the output stage MM is consistent with the frequency fpwm. In the basic switching control BC1, the output voltage Vout is stabilized at a target voltage Vtg by adjusting a length of a high level period of the control signal SH (that is, an on period of the transistor MH) in each cycle. However, during execution of the soft-start operation, the output voltage Vout is lower than the target voltage Vtg. The target voltage Vtg is determined by a ratio of the output voltage Vout to the feedback voltage Vfb and the reference voltage Vref, and is represented by “Vtg=(Vout/Vfb)×Vref”. The ratio of the output voltage Vout to the feedback voltage Vfb is equal to a voltage dividing ratio of the output voltage Vout of the feedback voltage generation circuit (R1 and R2).

An increase in the output current Iout causes a decrease in the output voltage Vout, and when viewing from the target voltage Vtg, the decrease in the output voltage Vout causes an increase in the error voltage Vcmp. A decrease in the output current Iout causes an increase in the output voltage Vout, and when viewing from the target voltage Vtg, the increase in the output voltage Vout causes a decrease in the error voltage Vcmp. An on duty cycle increases in response to the increase in the error voltage Vcmp and decreases in response to the decrease in the error voltage Vcmp, and the reset comparator 14 generates the signal RST based on the error voltage Vcmp and the slope voltage Vslp. The on duty cycle represents a ratio of a length of an on period of the transistor MH with respect to a sum of a length of an on period of the transistor MH and a length of an off period of the transistor MH.

In the basic switching control BC1, the logic circuit 16 can set an upper duty cycle limit for the on duty cycle, and generate the control signals (SH and SL) in a manner that the on duty cycle does not exceed the upper duty cycle limit. Thus, for example, assuming that the switching frequency is 1 MHz and the upper duty cycle limit is 95%, when no rising edge is generated in the signal RST after 0.95 ms has elapsed from a rising edge generated in the control signal SH, the logic circuit 16 can immediately generate a falling edge in the control signal SH and generate a rising edge in the control signal SL instead of depending on the signal RST.

### [Overcurrent Protection Operation]

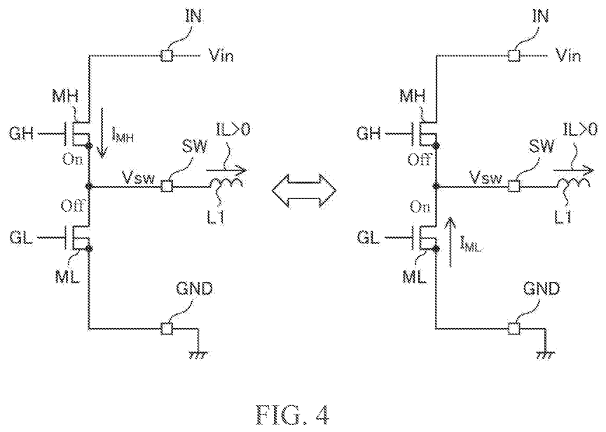

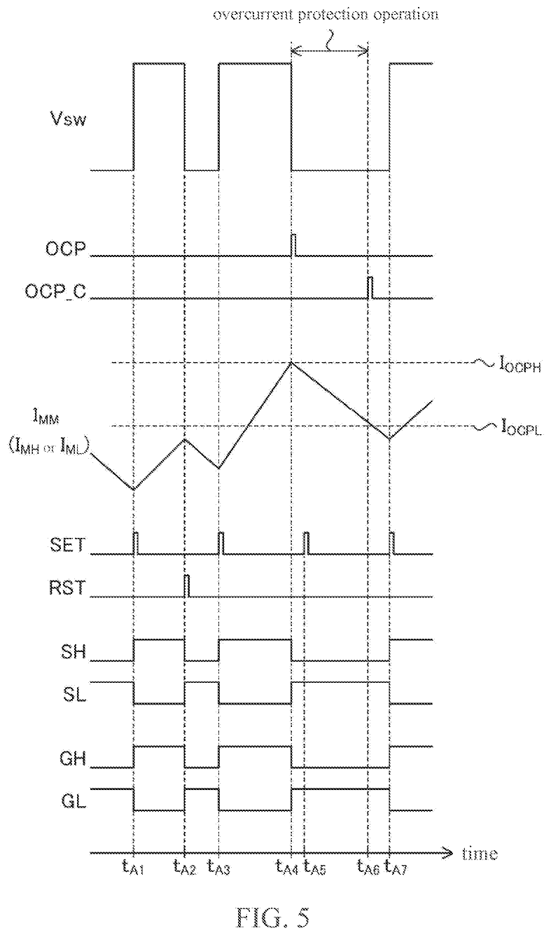

Next, the overcurrent protection operation implemented by the overcurrent protection circuit 20 is described. Herein, as shown in FIG. 4, when “IL>0”, a symbol “I_{MH}” is used to represent a current flowing to the transistor MH, and a symbol “I_{ML}” is used to represent a current flowing to the transistor ML. The current I_{MH} represents a current flowing from the drain to the source of the transistor MH during an on period of the transistor MH, and the current I_{ML} represents a current flowing from the source to the drain of the transistor ML during an on period of the transistor ML. Thus, a value of the current I_{MH} represents a value (a size) of the current flowing to the transistor MH during an on period of the transistor MH, and a value of the current I_{ML} represents a value (a size) of the current flowing to the transistor ML during an on period of the transistor ML. Moreover, a symbol “I_{MM}” is used to represent a current flowing to the output stage MM (referring to FIG. 5). During an on period of the transistor MH, “I_{MM}=I_{MH}=IL”; during an on period of the transistor ML, “I_{MM}=I_{ML}=IL”.

FIG. 5 shows a timing diagram when an overcurrent protection operation is performed. In FIG. 5, waveforms of the switching voltage Vsw, the signal OCP, a signal OCP_C, the current I_{MM}, the signal SET, the signal RST, the control signal SH, the control signal SL, the gate signal GH and the gate signal GL are sequentially represented from top to bottom. The signals OCP and OCP_C are signals output from the overcurrent protection circuit 20. Similar to the signal OCP, the signal OCP_C is a binary signal having a high level or a low level.

The signals OCP and OCP_C in principle have a low level. The overcurrent protection circuit 20 causes the signal OCP to have a high level only within a minute time when a predetermined overcurrent detection condition is established, and causes the signal OCP_C to have a high level only within a minute time when a predetermined release condition is established. The signal OCP at a high level functions as an overcurrent protection signal (in other words, as an overcurrent detection signal), and the signal OCP_C at a high level functions as a release signal.

As the time progresses, timings t_{A1}, t_{A2}, t_{A3}, t_{A4}, t_{A5}, t_{A6} and t_{A7} sequentially arrive. The basic switching control BC1 is performed continually from a timing before the timing t_{A1} to a timing before the timing t_{A4}. At the timing t_{A1}, a rising edge is generated in the signal SET. The timing t_{A3} is a timing of one PWM cycle (that is, the time (1/fpwm)) after the timing t_{A1}, the timing t_{A5} is a timing of two PWM cycles (that is, the time (2/fpwm)) after the timing t_{A1}, and the timing t_{A7} is a timing of three PWM cycles (that is, the time (3/fpwm)) after the timing t_{A1}.

The transistor MH is turned on and the transistor ML is turned off by using a rising edge of the signal SET at the timing t_{A1} as an opportunity. Then, the transistor MH is turned off and the transistor ML is turned on by using a rising edge of the signal RST at the timing t_{A2} as an opportunity. Then, the transistor MH is turned on and the transistor ML is turned off further by using a rising edge of the signal SET at the timing t_{A3} as an opportunity. From the timing t_{A3} to the timing t_{A4}, the current I_{MM} consistent with the current I_{MH} gradually increases. Before the timing t_{A4}, a value of the current I_{MM} is less than a predetermined overcurrent threshold I_{OCPH}. At the timing t_{A4}, the value of the current I_{MM} has reached and exceeds the overcurrent threshold I_{OCPH}. Moreover, after the timing t_{A2}, no rising edge is generated in the signal RST until the timing t_{A4}. In the example in FIG. 5, a next rising edge (not shown) of the signal RST is generated at the timing t_{A7} after the rising edge of the signal RST at the timing t_{A2}.

The overcurrent protection circuit 20 has a function of detecting a size relationship between the value of the current I_{MM} (the value of the current I_{MH} herein) and the predetermined overcurrent threshold I_{OCPH} during an on period of the transistor MH. At the timing t_{A4}, the value of the current I_{MM} (the value of the current I_{MH} herein) changes from a state of not exceeding the overcurrent threshold I_{OCPH} to a state of exceeding the overcurrent threshold I_{OCPH}, and the overcurrent protection circuit 20, upon detecting the change, determines that the output stage MM is in an overcurrent state and generates a rising edge in the signal OCP. Thus, at the timing t_{A4} herein, a rising edge is generated in the signal OCP (that is, an overcurrent protection signal is output from the circuit 20 at the timing t_{A4}). By changing from a state of “I_{MM}≤I_{OCPH}” to a state of “I_{MM}>I_{OCPH}”, the overcurrent detection condition is established.

The overcurrent protection circuit 20 generates a falling edge in the signal OCP after a predetermined minute time has elapsed from generating a rising edge in the signal OCP. The signal OCP at a high level is input to the logic circuit 16. At the timing t_{A4}, by using the signal OCP at a high level as an opportunity, the logic circuit 16 does not depend on the level of the signal RST but executes the overcurrent protection operation. The logic circuit 16 does not depend on the level of the signal SET during execution of the overcurrent protection operation, and keep the transistor MH off and keep the transistor ML on. Thus, during execution of the overcurrent protection operation, the current I_{MM} flowing to the output stage MM gradually decreases as accumulated energy of the coil L1 decreases. During execution of the overcurrent protection operation, “I_{MM}=I_{ML}”.

The overcurrent protection circuit 20 has a function of detecting a size relationship between the value of the current I_{MM} (the value of the current I_{ML} herein) and a predetermined release threshold I_{OCPL} during an on period of the transistor ML. At the timing t_{A6}, the value of the current I_{MM} (the value of the current I_{ML} herein) changes from a state of exceeding the release threshold I_{OCPL} to a state of being lower than the release threshold I_{OCPL}, and the overcurrent protection circuit 20, upon detecting the change, determines that the overcurrent state of the output stage MM is eliminated and generates a rising edge in the signal OCP_C. Thus, at the timing t_{A6} herein, a rising edge is generated in the signal OCP_C (that is, a release signal is output from the circuit 20 at the timing t_{A6}). By changing from a state of “I_{MM}≥I_{OCPL}” to a state of “I_{MM}<I_{OCPL}”, the release condition is established. The overcurrent protection circuit 20 generates a falling edge in the signal OCP_C after a predetermined minute time has elapsed from generating a rising edge in the signal OCP_C. The release threshold I_{OCPL} is lower than the overcurrent threshold I_{OCPH}.

The signal OCP_C at a high level is input to the logic circuit 16. The logic circuit 16 receives the signal OCP_C at a high level at the timing t_{A6}, and ends the overcurrent protection operation. Thus, in the example in FIG. 5, the overcurrent protection operation starts at the timing t_{A4}, and the overcurrent protection operation ends at the timing t_{A6}.

Then, at the timing t_{A7}, a rising edge is generated in the signal SET. Since the overcurrent protection operation is not performed at the timing t_{A7}, the transistor MH is turned on and the transistor ML is turned off by using a rising edge of the signal SET at the timing t_{A7} as an opportunity. At the timing t_{A5}, a rising edge is also generated in the signal SET. However, because the timing t_{A5} belongs to a period of execution of the overcurrent protection operation, the rising edge of the signal SET at the timing t_{A5} is considered invalid in the logic circuit 16. Thus, the logic circuit 16 does not depend on the rising edge of the signal SET at the timing t_{A5}, but maintain the control signal SH at a low level and maintain the control signal SL at a high level from the timing t_{A4} to the timing t_{A7}.

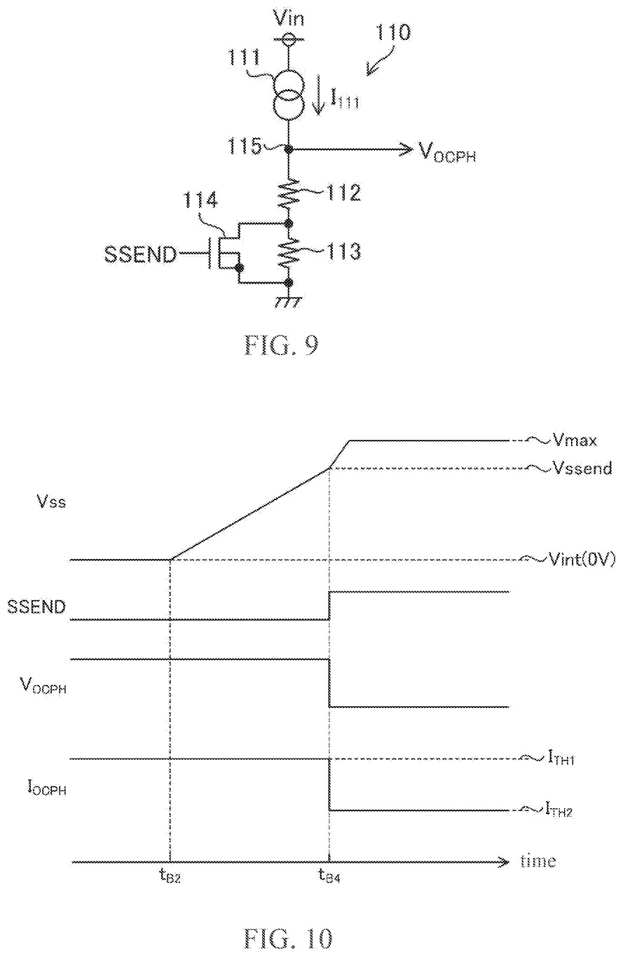

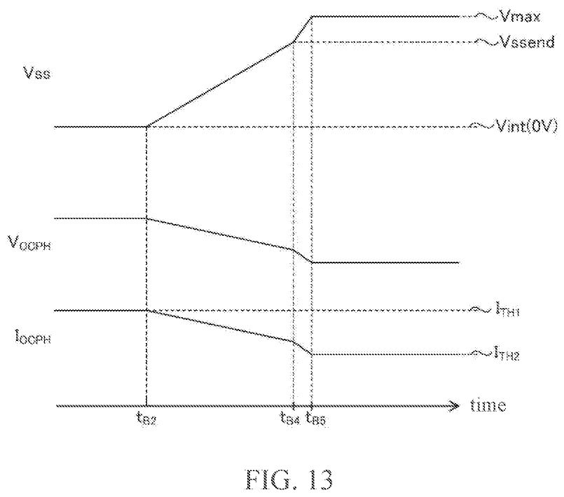

The overcurrent protection circuit 20 is capable of detecting the current I_{MH} based on a drain-source voltage of the transistor MH (hence a voltage between the input terminal IN and the switch terminal SW herein) and an on resistance of the transistor MH. The overcurrent protection circuit 20 is capable of detecting the current I_{ML} based on a drain-source voltage of the transistor ML (hence a voltage between the ground terminal GND and the switch terminal SW herein) and an on resistance of the transistor ML. The on resistances of the transistors MH and ML are known to the overcurrent protection circuit 20. In practice, the overcurrent protection circuit 20 can detect a size relationship between the current I_{MH} and the overcurrent threshold I_{OPCH} by comparing the drain-source voltage of the transistor MH with a predetermined first voltage threshold. The first voltage threshold is equivalent to a product of the overcurrent threshold I_{OCPH} and the on resistance of the transistor MH. The first voltage threshold is equivalent to a value of a voltage V_{OCPH} described below (referring to FIG. 9 and FIG. 12). Similarly, the overcurrent protection circuit 20 can detect a size relationship between the current I_{ML} and the release threshold I_{OPCL} by comparing the drain-source voltage of the transistor ML with a predetermined second voltage threshold. The second voltage threshold is equivalent to a product of the release threshold I_{OCPL} and the on resistance of the transistor ML.

During the overcurrent protection operation executed at an opportunity when “I_{MM}>I_{OCPH}” is established, the transistor MH is kept in an off state, and thus the current I_{MM} flowing to the output stage MM gradually decreases as the accumulated energy of the coil L1 decreases. Thus, in the overcurrent protection operation, an increase in the current I_{MM} exceeding the overcurrent threshold I_{OCPH} is limited (suppressed). That is to say, with execution of the overcurrent protection operation, a further increase in the value of the current I_{MM} exceeding the overcurrent threshold I_{OCPH} is limited (suppressed).

Moreover, a variation configuration in which the logic circuit 16, starting from the overcurrent protection operation, continues the overcurrent protection operation (that is, maintain an off state of the transistor MH) until a predetermined cooling time has elapsed, is used. When the variation configuration above is used, after the overcurrent protection operation starts at the timing t_{A4}, the overcurrent protection operation does not end even if a rising edge is generated in the signal OCP_C, until a timing after a cooling time (hereinafter referred to as an elimination allowed timing) has elapsed from the timing t_{A4}. In the variation configuration, when a rising edge is generated in the signal OCP_C between the timing t_{A4} and the elimination allowed timing, the logic circuit 16 causes the overcurrent protection operation to end at the elimination allowed timing. In the variation configuration, when a rising edge is not generated in the signal OCP_C between the timing t_{A4} and the elimination allowed timing, the logic circuit 16 causes the overcurrent protection operation to end when a rising edge is later generated in the signal OCP_C.

### [Soft-Start Operation]

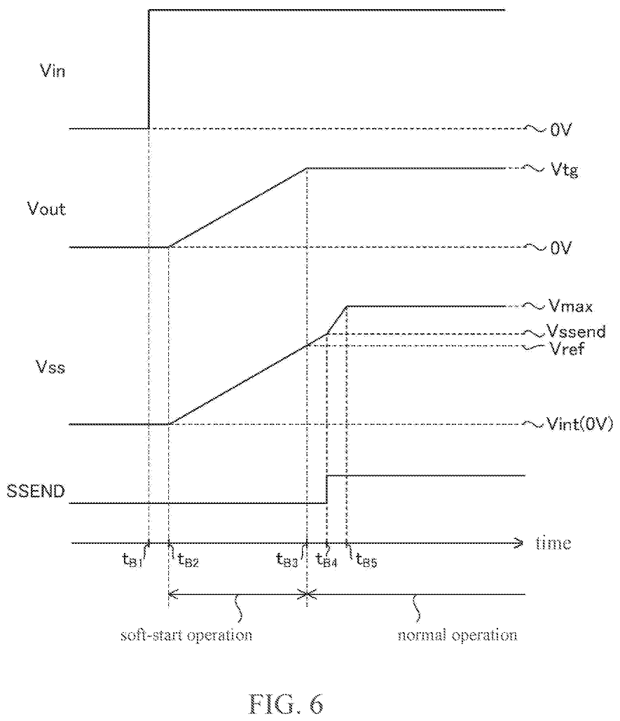

Next, the soft-start operation implemented by the SS circuit 19b is described. FIG. 6 shows a timing diagram related to the soft-start operation. In FIG. 6, waveforms of the input voltage Vin, the output voltage Vout, the soft-start voltage Vss and a signal SSEND are sequentially depicted. The signal SSEND is a signal output from the comparison voltage generation signal 19 (referring to FIG. 2). As the time progresses, timings t_{B1}, t_{B2}, t_{B3}, t_{B4} and t_{B5} sequentially arrive.

At the timing t_{B1}, the input voltage Vin equivalent to the output voltage of the voltage source VS is supplied to the power supply control device 10. In practice, the value of the input voltage Vin is caused to increase from 0 V to the value of the output voltage of the voltage source VS at a cost of a certain period of time; however, such increase considered occurring at the timing t_{B1}. Starting from the timing t_{B1}, a predetermined initial sequence operation is performed in the power supply control device 10 based on the input voltage Vin. In the initial sequence operation, a level of the signal SSEND is set to an initial level, that is, a low level.

When the initial sequence operation is completed, at the timing t_{B2}, the SS circuit 19b causes the soft-start voltage Vss to increase. At the timing t_{B2}, the soft-start voltage Vss has a predetermined initial voltage Vint, and increases from the initial voltage Vint. The initial voltage Vint herein is 0 V. However, given that the initial voltage Vint is lower than the reference voltage Vref, the initial voltage Vint can be different from 0 V.

Moreover, both of the gate signals GH and GL are fixed at a low level until the timing t_{B2}. At the timing t_{B2}, the error amplifier 11 is activated and starts to generate the error voltage Vcmp, and a switching drive of the output stage MM starts from the timing t_{B2}. At the timing t_{B2} and after the timing t_{B2}, an input voltage input to the second non-inverting input terminal of the error amplifier 11 is fixed at the reference voltage Vref.

The SS circuit 19b causes the soft-start voltage Vss to rise (increase) monotonically at a fixed increase rate from the timing t_{B2} to the timing t_{B4}. However, the increase rate between the timing t_{B2} and the timing t_{B4} is not necessarily fixed. At the timing t_{B3}, “Vss=Vref”; at the timing t_{B4}, “Vss=Vssend”. Herein, the voltage Vssend is a predetermined voltage greater than the reference voltage Vref, and is, for example, 1.1 times the reference voltage Vref. The SS circuit 19b causes the soft-start voltage Vss to rise drastically toward an upper limit voltage Vmax when the soft-start voltage Vss reaches the voltage Vssend during a rising process of the soft-start voltage Vss. Thus, starting from the timing t_{B4}, the soft-start voltage Vss rises drastically from the voltage Vssend to the upper limit voltage Vmax. At the timing t_{B5}, the soft-start voltage Vss reaches the upper limit voltage Vmax. After the soft-start voltage Vss reaches the upper limit voltage Vmax, “Vss=Vmax” is maintained. The upper limit voltage Vmax is one of the voltages generated in the power supply control device 10 based on the input voltage Vin. Summarizing a size relationship of voltages associated with the soft-start voltage Vss, “Vint<Vref<Vssend<Vmax”.

Within a period from the timing t_{B2} to the timing t_{B3}, a soft-start operation of “Ve=Vss” is performed. After the timing t_{B3}, a normal operation of “Ve=Vref” is performed. Between the timings t_{B2} and t_{B3}, the output voltage Vout increases gradually from OV to the target voltage Vtg. Once the output voltage Vout reaches the target voltage Vtg at the timing t_{B3} or near the timing t_{B3}, the output voltage Vout is stabilized at the target voltage Vtg.

The SS circuit 19b can generate the soft-start voltage Vss having the characteristics (the characteristics between the timings t_{B2} and t_{B4}) by using an integration circuit. The comparison voltage generation circuit 19 generates a rising edge in the signal SSEND when the soft-start voltage Vss reaches the voltage Vssend during a rising process of the soft-start voltage Vss, and then fixes the level of the signal SSEND at a high level. In the example in FIG. 6, a rising edge is generated in the signal SSEND at the timing t_{B4}. The signal SSEND at a high level means that the soft-start voltage Vss has reached the voltage Vssend. After the soft-start voltage Vss has reached the voltage Vssend, pull-up of such as a constant current circuit is used to increase the voltage Vss to the upper limit voltage Vmax. Moreover, the increase rate of the soft-start voltage Vss between the timings t_{B2} and t_{B5} can also be set to be fixed.

If the signal OCP is maintained at a low level after the timing t_{B2}, a normal operation is performed by the basic switching control BC1 (referring to FIG. 3) after execution of the soft-start operation by the basic switching control BC1.

### [Influences of Overcurrent Protection Operation at Start]

An operation shown in FIG. 6 is referred to as a normal start operation. In the normal start operation in FIG. 6, the signal OCP is maintained at a low level after the timing t_{B2} and at least up to the timing t_{B5}. It is assumed that, if a rising edge is generated in the signal OCP immediately after the timing t_{B2} and the overcurrent protection operation is performed, it is possible that a poor start such as that shown in FIG. 7 may occur. In a poor start, the output voltage Vout is decreased during an off period of the transistor MH by the overcurrent protection operation, and then even if the transistor MH is turned on by releasing the overcurrent protection operation, a rising edge is still again generated in the signal OCP and so the overcurrent protection operation is then again performed. The situation repeats, such that the output voltage Vout cannot be increased to the target voltage Vtg. Even if a rising edge is generated in the signal OCP immediately after the timing t_{B2} and the overcurrent protection operation is performed, the output voltage Vout also increases to the target voltage Vtg according to conditions. However, in this case, compared to a normal start operation, a large amount of time is needed (hence a delayed start) for the output voltage Vout to increase to the target voltage Vtg.

Accompanied with high threshold voltages of various circuit elements, sometimes a greater input voltage Vin is used. Moreover, in order to reduce pulsation in the output voltage Vout, a capacitor C1 with a large capacitance is often used. The capacitance of the capacitor C1 gets larger as the input voltage Vin is greater, and the overcurrent protection operation occurring at a start is more likely resulted.

### [Variable Setting of Overcurrent Threshold]

Taking the situation above into consideration, in the power supply control device 10, the overcurrent threshold I_{OCPH} is set variably according to an elapsed time (hereinafter referred to as an elapsed time T_{ELP}) from a start of a switching drive of the output stage MM. The elapsed time T_{ELP} is equivalent to an elapsed time from the timing t_{B2}. The overcurrent threshold I_{OCPH} is set by the threshold setting circuit 21 according to the elapsed time T_{ELP}. At this point in time, the threshold setting circuit 21 changes the release threshold I_{OCPL} as the overcurrent threshold I_{OCPH} changes. For example, “I_{OCPL}=I_{OCPH}×k_{A}”, where k_{A} has a predetermined positive value less than 1 (for example, 0.8).

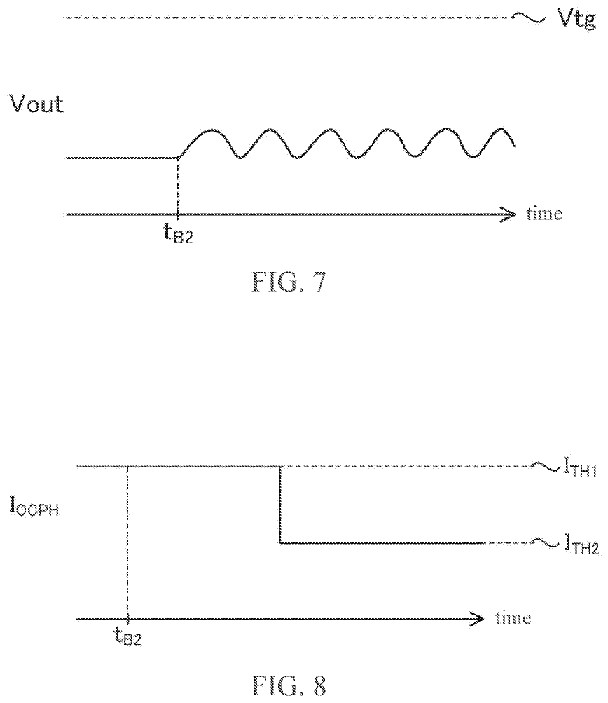

As shown in FIG. 8, the threshold setting circuit 21 can lower the overcurrent threshold I_{OCPH} stepwise as the elapsed time T_{ELP} increases. For example, the threshold setting circuit 21 can set a predetermined threshold I_{TH1} for the overcurrent threshold I_{OCPH} when the elapsed time T_{ELP} is less than a predetermined time T_{TH}, and set a predetermined threshold I_{TH2} for the overcurrent threshold I_{OCPH} when the elapsed time T_{ELP} exceeds the predetermined time T_{TH}. Herein, “I_{TH1}>I_{TH2}>0”. In FIG. 8, the overcurrent threshold I_{OCPH} is changed in two steps according to the elapsed time T_{ELP}, but can also change in three or more steps.

The threshold setting circuit 21 can lower the overcurrent threshold I_{OCPH} stepwise according to the soft-start voltage Vss of which a level changes depending on the elapsed time T_{ELP}.

FIG. 9 shows a circuit 110 configured to lower the overcurrent threshold I_{OCPH} in two steps. The circuit 110 can be provided in advance in the threshold setting circuit 21, and the overcurrent threshold I_{OCPH} is set variably in the circuit 110. FIG. 10 shows a timing diagram at a start when the overcurrent threshold I_{OCPH} is set in the circuit 110.

The circuit 110 includes a constant current source 111, resistors 112 and 113, and a transistor 114. The transistor 114 is an N-channel MOSFET. The constant current source 111 is disposed between an application end of the input voltage Vin and a node 115, and supplies a constant current I₁₁₁ from the application end of the input voltage Vin toward the node 115. The first end of the resistor 112 is connected to the node 115, and a second end of the resistor 112 is grounded via the resistor 113. A drain of the transistor 114 is a connection node between the resistors 112 and 113 (hence connected to the second end of the resistor 112). A source of the transistor 114 is grounded. The signal SSEND is input to a gate of the transistor 114. In the circuit 110, a voltage at the node 115 is referred to as the voltage V_{OCPH}.

When the signal SSEND is at a low level, the transistor 114 is turned off, and the current I₁₁₁ flows through both the resistors 112 and 113. When the signal SSEND is at a high level, the transistor 114 is turned on, the current I₁₁₁ flows through the resistor 112 and a channel of the transistor 114, but substantially does not flow to the resistor 113 (an on resistance of the transistor 114 herein is sufficiently small and is thus regarded as zero). Thus, in the circuit 110, the voltage V_{OCPH} in an off period of the transistor 114 is greater than the voltage V_{OCPH} in an on period of the transistor 114 because of a voltage drop of the resistor 113 caused by the current I₁₁₁.

When the overcurrent threshold I_{OCPH} is set variably in the circuit 110, the threshold setting circuit 21 causes the overcurrent threshold I_{OCPH} to be proportional to the value of the voltage V_{OCPH} at the node 115 by a positive constant of proportionality. That is to say, for the voltage V_{OCPH} at the node 115, “I_{OCPH}=k_{P1}×V_{OCPH}” holds true, where k_{P1} is a siemens unit, and “k_{P1}>0”. When the overcurrent threshold I_{OCPH} is set variably in the circuit 110, the overcurrent threshold I_{OCPH} has the threshold I_{TH1} before the timing t_{B4}, switches from the threshold I_{TH1} to the threshold I_{TH2} at the timing t_{B4}, and is fixed at the threshold I_{TH2} after that. The overcurrent protection circuit 20 can compare a size of the drain-source voltage of the transistor MH with a size of the voltage V_{OCPH} at the node 115 during an on period of the transistor MH, and determine that “I_{MM}=I_{MH}>I_{OCPH}” when the former is greater than the latter, and “I_{MM}=I_{MH}<I_{OCPH}” when the former is less than the latter.

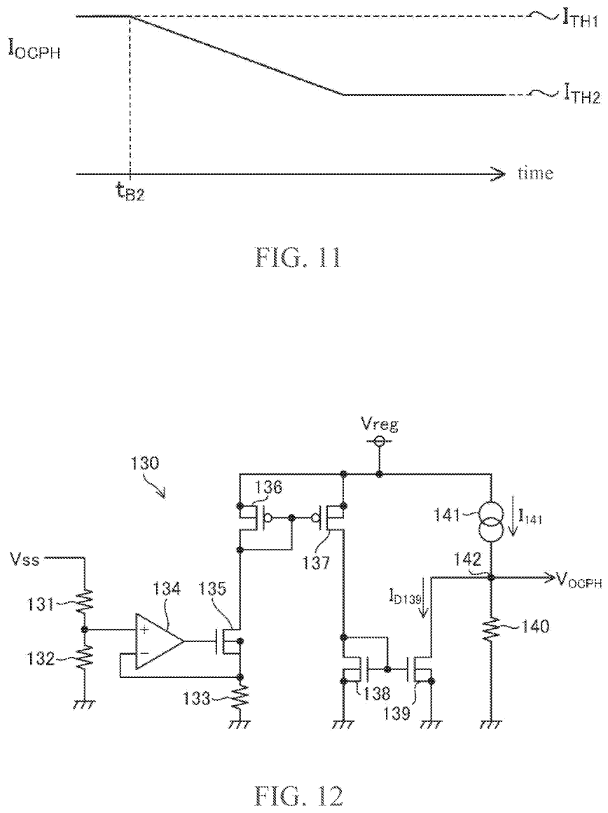

As shown in FIG. 11, the threshold setting circuit 21 can also continuously lower the overcurrent threshold I_{OCPH} as the elapsed time T_{ELP} increases. For example, the threshold setting circuit 21 can generate the overcurrent threshold I_{OCPH} in a way that “I_{OCPH}=I_{TH1}−k_{B}·T_{ELP}” holds true. A lower limit of the overcurrent threshold I_{OCPH} is the threshold I_{TH2}, and the overcurrent threshold I_{OCPH} is set to and fixed at the threshold I_{TH2} once the overcurrent threshold I_{OCPH} has decreased to the threshold I_{TH2}. k_{B} is a coefficient having a positive predetermined value.

The threshold setting circuit 21 can continuously lower the overcurrent threshold I_{OCPH} according to the soft-start voltage Vss of which a level changes depending on the elapsed time T_{ELP}.

FIG. 12 shows a circuit 130 configured to continuously lower the overcurrent threshold I_{OCPH}. The circuit 130 can be provided in advance in the threshold setting circuit 21, and the overcurrent threshold I_{OCPH} is set variably in the circuit 130. FIG. 13 shows a timing diagram at a start when the overcurrent threshold I_{OCPH} is set in the circuit 130.

A configuration of the circuit 130 is described below. The circuit 130 includes resistors 131 to 133 and 140, an operational amplifier 134, transistors 135 to 139, and a constant current source 141. The transistors 135, 138 and 139 are N-channel MOSFETs, and the transistors 136 and 137 are P-channel MOSFETs.

The soft-start voltage Vss is supplied to one end of the resistor 131, and the other end of the resistor 131 is grounded via the resistor 132. A connection node between the resistors 131 and 132 is connected to a non-inverting input terminal of the operational amplifier 134. An inverting input terminal of the operational amplifier 134 is connected to a source of the transistor 135, and is grounded via the resistor 133. An output terminal of the operational amplifier 134 is connected to a gate of the transistor 135. A drain of the transistor 135 is commonly connected to a drain and a gate of the transistor 136 and a gate of the transistor 137. An internal power supply voltage Vreg is supplied to each of sources of the transistors 136 and 137. The internal power supply voltage Vreg has a positive DC voltage value, and is generated in the power supply control device 10 based on the input voltage Vin. A drain of the transistor 137 is commonly connected to a drain and a gate of the transistor 138 and a gate of the transistor 139. Each of sources of the transistors 138 and 139 is grounded. A drain of the transistor 139 is connected to a node 142.

The constant current source 141 is disposed between an application end of the internal power supply voltage Vreg and the node 142, and supplies a constant current I₁₄₁ from the application end of the internal power supply voltage Vreg to the node 142. One end of the resistor 140 is connected to the node 142, and the other end of the resistor 140 is grounded.

An operation of the circuit 130 is described below. A divided voltage of the soft-start voltage Vss is generated at a connection node between the resistors 131 and 132. The operational amplifier 134 controls a gate potential of the transistor 135 in a manner that a voltage at the connection node between the resistors 131 and 132 is equal to a voltage drop generated in the resistor 133. Thus, a drain current corresponding to the voltage at the connection node between the resistors 131 and 132 (hence a drain current corresponding to the soft-start voltage Vss) flows to the transistor 136. The transistors 136 and 137 form a first current mirror circuit, and the transistors 138 and 139 form a second current mirror circuit. Thus, a current I_{D139} proportional to the drain current of the transistor 136 is generated in the transistor 139. The current I_{D139} serves as a drain current of the transistor 139, and flows from the node 142 to the ground portion through the transistor 139.

In the circuit 130, a voltage at the node 142 is the voltage V_{OCPH}. When a resistance value of the resistor 140 is represented by a symbol “R₁₄₀”, the voltage V_{OCPH} at the node 142 is represented by “V_{OCPH}=(I₁₄₁−I_{D139})·R₁₄₀”. The current I_{D139} is proportional to the soft-start voltage Vss, and increases as the soft-start voltage Vss increases. Thus, the voltage V_{OCPH} at the node 142 decreases as the soft-start voltage Vss increases. Moreover, the current I_{D139} is the largest when “Vss=Vmax”; however, when “Vss=Vmax”, “I₁₄₁>I_{D139}” also holds true.

When the overcurrent threshold I_{OCPH} is set variably in the circuit 130, the threshold setting circuit 21 causes the overcurrent threshold I_{OCPH} to be proportional to the value of the voltage V_{OCPH} at the node 142 by a positive constant of proportionality. That is to say, for the voltage V_{OCPH} at the node 142, “I_{OCPH}=k_{P2}×V_{OCPH}” holds true, where k_{P2} is a siemens unit, and “k_{P2}>0”. When the overcurrent threshold I_{OCPH} is set variably in the circuit 130, the overcurrent threshold I_{OCPH} has the threshold I_{TH1} before the timing t_{B2}, gradually decreases from the threshold I_{TH1} to the threshold I_{TH2} as the voltage V_{OCPH} decreases between the timings t_{B2} and t_{B5}, has the threshold I_{TH2} at the timing t_{B5}, and is fixed at the threshold I_{TH2} after that. The overcurrent protection circuit 20 can compare a size of the drain-source voltage of the transistor MH with a size of the voltage V_{OCPH} at the node 142 in an on period of the transistor MH, and determine that “I_{MM}=I_{MH}>I_{OCPH}” when the former is greater than the latter, and “I_{MM}=I_{MH}<I_{OCPH}” when the former is less than the latter.

According to this embodiment, since the overcurrent threshold I_{OCPH} increases immediately after or near a start of an increase of the output voltage Vout from 0 V, it is unlikely that an overcurrent protection operation is caused. As a result, a poor start or a delayed start above is suppressed. In a first hypothetical configuration when it is always set as “I_{OCPH}=I_{TH2}”, the capacitance of the capacitor C1 needs to be set to be relatively small in order to prevent a poor start or a delayed start. According to the configuration of this embodiment, since even if the capacitance of the capacitor C1 is set to be greater than that of the hypothetical configuration, both a poor start and a delayed start can be suppressed, and so the capacitance of the capacitor C1 in practice can be set to be greater than that of the hypothetical configuration. Pulsation in the output voltage Vout can be reduced by increasing the capacitance of the capacitor C1. Moreover, in a second hypothetical configuration when it is always set as “I_{OCPH}=I_{TH1}”, since the overcurrent threshold I_{OCPH} is overly high after a start of the switching power supply device 1 is complete, it is difficult to perform an appropriate overcurrent protection.

### Embodiment EX1_2

The embodiment EX1_2 is described below. The embodiment EX1_2 and an embodiment EX1_3 described below are embodiments based on the embodiment EX1_1. Provided that there are no contradictions, for the matters not particularly described in the embodiment EX1_2, the details of the embodiment EX1_1 are also applicable to the embodiment EX1_2 (the same applies to the embodiment EX1_3 described below).

In the embodiment EX1_1, the switching drive of the output stage MM begins with supplying the input voltage Vin to the power supply control device 10.

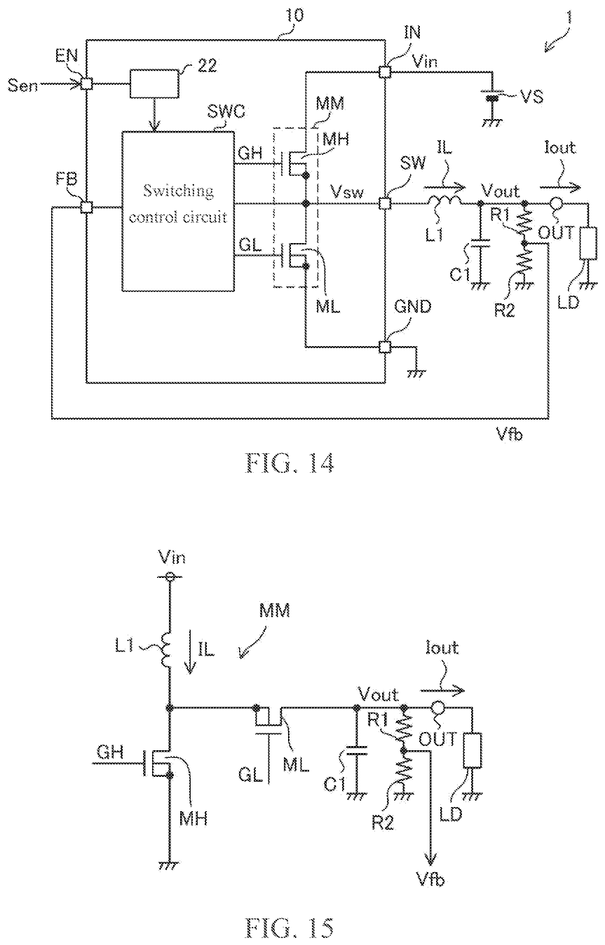

As shown in FIG. 14, an enable terminal EN can be provided in the power supply control device 10 as one of the external terminals, and in this case, the switching drive of the output stage MM sometimes begins according to an enable signal Sen supplied to the enable terminal EN. The enable signal Sen is input from an external device (such as a microcomputer) different from the power supply control device 10 to the enable terminal EN.

On the premise that the output voltage of the voltage source VS is used as the input voltage Vin supplied to the input terminal IN, the operation of the power supply control device 10 of the embodiment EX1_2 is described. An enable circuit 22 disposed in the power supply control device 10 can detect at which level of a first level and a second level the enable signal Sen is by binarizing the enable signal Sen in the enable terminal EN. Between the first level and the second level, one level is greater than the other level. When the level of the enable signal Sen changes from the first level to the second level, the enable circuit 22 outputs a predetermined enable signal to the switching control circuit SWC. The switching control circuit SWC starts the switching drive of the output stage MM by using the enable signal received as an opportunity.

In the embodiment EX1_2, the initial sequence operation is completed within a period in which the enable signal Sen is at the first level. In the embodiment EX1_2, a timing at which the level of the enable signal Sen changes from the first level to the second level (more specifically, a timing at which the enable signal is received in the switching control circuit SWC) is equivalent to the timing t_{B2} in FIG. 6. The operation after the level of the enable signal Sen changes to the second level is the same as that of the embodiment EX1_1. Then, when the level of the enable signal Sen returns from the second level to the first level, the switching drive of the output stage MM is stopped.

### Embodiment EX1_3

The embodiment EX1_3 is described below. In the embodiment EX1_3, supplement items and variation techniques of the matters are described.

The configurations of the switching power supply device 1 and the power supply control device 10 can be any as desired, provided that a configuration having a soft-start function (gradually increasing the output voltage Vout to the target voltage Vtg from a start of supplying the input voltage Vin) is included. In the configuration in FIG. 2, the switching drive is performed on the output stage MM by a current mode control with reference to the coil current IL. However, in the present disclosure, whether to use or not use the current mode control is optional (thus, the switching drive of the output stage MM is not necessarily based on the coil current IL).

The switching control circuit SWC can be considered as configured to include a control signal generation circuit that generates a control signal (SH or SL) based on the feedback voltage Vfb and the driver 17 that performs the switching drive on the output stage MM based on the control signal. The control signal generation circuit generates the control signals (SH and SL) to reduce an error between the feedback voltage Vfb and the comparison voltage Ve. In the configuration in FIG. 2, the control signal generation circuit includes various parts denoted by the numerals 11 to 16 and 18 to 21.

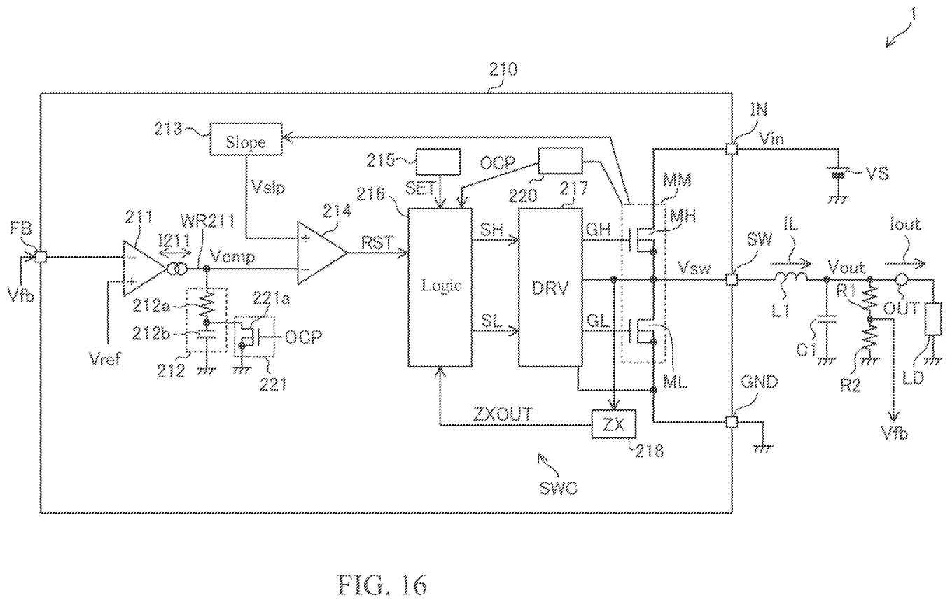

The switching power supply device 1 is a step-down switching power supply device; however, a switching power supply device applying the techniques of the present disclosure can also be a step-up switching power supply device. The step-up switching power supply device generates the output voltage Vout greater than the input voltage Vin by stepping up the input voltage Vin. When the switching power supply device 1 is a step-up switching power supply device, as shown in FIG. 15, a first end of the coil L1 is connected to an application end of the input voltage Vin (a terminal applied with the input voltage Vin), a second end of the coil L1 is connected to the drain of the transistor MH and the source of the transistor ML, the source of the transistor MH is grounded, and the drain of the transistor ML is connected to the output terminal OUT and is grounded via the capacitor C1. In the configuration in FIG. 15, the transistor ML serving as a rectifier can also be replaced by a synchronous rectifier diode having an anode connected to the drain of the transistor MH and a cathode connected to the output terminal OUT. In all cases, by switching the output element (MH) between on and off during the switching drive of the output stage MM, the output voltage Vout is generated based on the current (IL) flowing to the coil L1.

### <<Note 1>>

Note 1 is attached to the present disclosure to show specific configuration examples of the embodiments above (more particularly the embodiments EX1_1 to EX1_3).

A power supply control device according to an aspect of the present disclosure is configured as (a first configuration), a power supply control device (10) configured to control an output stage (MM) of a switching power supply device (1) that generates an output voltage (Vout) from an input voltage (Vin), the power supply control device comprising:
a switching control circuit (SWC), configured to switch and drive the output stage based on a feedback voltage (Vfb) corresponding to the output voltage, wherein the output voltage is generated from the input voltage through a switching drive of the output stage, wherein the switching control circuit includes:
   a threshold setting circuit (21), configured to set an overcurrent threshold (I_{OCPH}); and
   an overcurrent protection circuit (20), configured to output an overcurrent protection signal when a value of a current flowing through the output stage exceeds the overcurrent threshold, and perform an overcurrent protection operation that limits an increase in the current flowing through the output stage exceeding the overcurrent threshold in response to an output of the overcurrent protection signal, wherein
the threshold setting circuit sets the overcurrent threshold according to an elapsed time (T_{ELP}) from a start of the switching drive of the output stage.

Thus, execution of an undesired overcurrent protection operation immediately following a start of a switching drive can be suppressed. As a result, a poor start or a delayed start can be suppressed.

The power supply control device of the first configuration can also be configured as (a second configuration), wherein the threshold setting circuit is configured to set the overcurrent threshold to a first threshold (I_{TH1}) or a second threshold (I_{TH2}) lower than the first threshold, and switch the overcurrent threshold from the first threshold to the second threshold as the elapsed time increases.

Thus, since an overcurrent threshold immediately following or near a start of a switching drive is increased, execution of an undesired overcurrent protection operation can be suppressed. As a result, a poor start or a delayed start can be suppressed.

The power supply control device of the second configuration can also be configured as (a third configuration), wherein
the switching control circuit is configured to switch and drive the output stage so as to reduce an error between the feedback voltage and a comparison voltage (Ve),
the switching control circuit, after the start of the switching drive of the output stage, uses a soft-start voltage (Vs) that gradually increases from an initial voltage (Vint) lower than a predetermined reference voltage (Vref) as the comparison voltage, and uses the reference voltage as the comparison voltage after the soft-start voltage exceeds the reference voltage, and
the threshold setting circuit switches the overcurrent threshold from the first threshold to the second threshold according to the soft-start voltage that depends on the elapsed time.

The power supply control device of the third configuration can also be configured as (a fourth configuration), wherein the threshold setting circuit is configured to switch the overcurrent threshold from the first threshold to the second threshold when the soft-start voltage reaches a predetermined voltage (Vssend) greater than the reference voltage.

The power supply control device of the first configuration can also be configured as (a fifth configuration), wherein as the elapsed time increases and after the overcurrent threshold is continuously lowered from a first threshold to a second threshold lower than the first threshold, the threshold setting circuit is configured to set the overcurrent threshold as the second threshold.

Thus, since an overcurrent threshold immediately following or near a start of a switching drive is increased, execution of an undesired overcurrent protection operation can be suppressed. As a result, a poor start or a delayed start can be suppressed.

The power supply control device of the fifth configuration can also be configured as (a sixth configuration), wherein
the switching control circuit is configured to switch and drive the output stage so as to reduce an error between the feedback voltage and a comparison voltage (Ve),
the switching control circuit, after the start of the switching drive of the output stage, uses a soft-start voltage (Vs) that gradually increases from an initial voltage (Vint) lower than a predetermined reference voltage (Vref) as the comparison voltage, and uses the reference voltage as the comparison voltage after the soft-start voltage exceeds the reference voltage, and
after the overcurrent threshold is continuously lowered from the first threshold to the second threshold according to the soft-start voltage that depends on the elapsed time, the threshold setting circuit sets the overcurrent threshold as the second threshold.

The power supply control device of the sixth configuration can also be configured as (a seventh configuration), wherein
the switching control circuit, after the start of the switching drive of the output stage, gradually increases the soft-start voltage to a predetermined upper limit voltage (Vmax) greater than the initial voltage, and
the threshold setting circuit is configured to continuously lower the overcurrent threshold from the first threshold to the second threshold according to the soft-start voltage during a rising period of the soft-start voltage, and set the overcurrent threshold to the second threshold after the soft-start voltage reaches the upper limit voltage.

The power supply control device of any one of the first to seventh configurations can also be configured as (an eighth configuration), wherein the switching drive of the output stage begins with supplying the input voltage to the power supply control device.

The power supply control device of any one of the first to seventh configurations can also be configured as (a ninth configuration), comprising an enable terminal (EN), configured to receive an enable signal (Sen), wherein the switching drive of the output stage begins when a level of the enable signal changes from a first level to a second level while the input voltage is being supplied to the power supply control device.

The power supply control device of any one of the first to ninth configurations can also be configured as (a tenth configuration), wherein the output stage includes:
an output element (MH) comprising a switching element; and
a rectifier (ML) connected to the output element,
a coil (L1) is connected to a connection node between the output element and the rectifier, and
the output voltage is generated based on the current flowing through the coil by switching the output element between on and off during the switching drive of the output stage.

### Embodiment EX2_1

The embodiment EX2_1 is described below. FIG. 16 shows a diagram of a configuration of the switching power supply device 1 according to the embodiment EX2_1. The switching power supply device 1 of the embodiment EX2_1 includes a power supply control device 210 as the power supply control device 10.

An internal configuration of the power supply control device 210 of the embodiment EX2_1 is described below. The power supply control device 210 includes an output stage MM, an error amplifier 211, a phase compensation circuit 212, a slope voltage generation circuit 213, a reset comparator 214, a setting signal generation circuit 215, a logic circuit 216, a driver 217, a reverse current detection circuit 218, an overcurrent protection circuit 220 and an error voltage change suppression circuit 221. In the embodiment EX2_1, the switching control circuit SWC in FIG. 1 has various parts denoted by numerals 211 to 218, 220 and 221. Signals RST, SET, SH, SL, ZXOUT and OCP described below are binary signals with a signal level in a high level or a low level. The signal SET functions as a setting signal, and the signal RST functions as a reset signal. Alternatively, it can also be considered that only the signal SET at a high level functions as a setting signal, and only the signal RST at a high level functions as a reset signal.

The error amplifier 211 is a current output transconductance amplifier. The error amplifier 211 includes an inverting input terminal, a non-inverting input terminal and an output terminal. The inverting input terminal of the error amplifier 211 is connected to the feedback terminal FB to receive the feedback voltage Vfb. A predetermined reference voltage Vref is supplied to the non-inverting input terminal of the error amplifier 211. The reference voltage Vref is a DC voltage having a positive predetermined voltage value, and is generated by a reference voltage generation circuit (not shown) in the power supply control device 210. An output terminal of the error amplifier 211 is connected to a wiring WR211 (an error output wiring).

The error amplifier 211 generates a voltage according to a difference between the feedback voltage Vfb and the reference voltage Vref in the wiring WR211 by outputting a current signal 1211 corresponding to the difference between the feedback voltage Vfb and the reference voltage Vref from its output terminal. The voltage applied to the wiring WR211 is the error voltage Vcmp. However, a voltage after level shifting the voltage applied to the wiring WR211 can also be the error voltage Vcmp. A charge of the current signal 1211 is input/output to the wiring WR211. More specifically, the error amplifier 211 outputs a current of the current signal 1211 from the error amplifier 211 to the wiring WR211 in a manner that a potential of the wiring WR211 increases when the feedback voltage Vfb is lower than the reference voltage Vref, and sinks the current of the current signal 1211 from the wiring WR211 to the error amplifier 211 in a manner that the potential of the wiring WR211 decreases when the feedback voltage Vfb is greater than the reference voltage Vref. As an absolute value of the difference between the feedback voltage Vfb and the reference voltage Vref increases, a size of the current of the current signal 1211 also increases.

Moreover, at a start of the power supply control device 210, a soft-start voltage that slowly increases from 0 V to a voltage exceeding the reference voltage Vref can be generated in the power supply control device 210. In this case, the error amplifier 211 compares the lower one of the reference voltage Vref and the soft-start voltage with the feedback voltage Vfb, and generates the current signal 1211 based on the comparison result. However, in the embodiment EX2_1, a condition after the soft-start voltage is greater than the reference voltage Vref is taken into consideration, and the presence of the soft-start voltage is omitted.

The phase compensation circuit 212 is disposed between the wiring WR211 and the ground portion, and receives an input of the current signal 1211 and compensates for a phase of the voltage of the wiring WR211 (a phase of the error voltage Vcmp). The phase compensation circuit 212 includes a series circuit of a resistor 212a (a phase compensation resistor) and a capacitor 212b (a phase compensation capacitor). More specifically, one end of the resistor 212a is connected to the wiring WR211, and the other end of the resistor 212a is grounded via the capacitor 212b. By appropriately setting a resistance value of the resistor 212a and an electrostatic capacitance value of the capacitor 212b, the phase of the voltage of the wiring WR211 (the phase of the error voltage Vcmp) can be compensated to prevent an oscillation in an output feedback loop.

The slope voltage generation circuit 213 generates and outputs a slope voltage Vslp in a ramp waveform. The slope voltage Vslp has information indicating a value of the coil current IL (hereinafter referred to as current information of the coil L1). More specifically, the circuit 213 generates a sensing voltage proportional to a current flowing to the transistor MH (hence the coil current IL) during an on period of the transistor MH, and a slope voltage gradually increasing from 0 V during an on period of the transistor MH. A voltage obtained by adding the sensing voltage and the slope voltage generated by the circuit 213 during an on period of the transistor MH (that is, a sum of the sensing voltage and the slope voltage) is used as the slope voltage Vslp. Thus, during an on period of the transistor MH, the slope voltage Vslp monotonically increases. By adding the slope voltage, a sub-harmonic oscillation that may occur in a current mode control can be suppressed.

Moreover, given that the sensing voltage has current information of the coil L1, any method for generating the sensing voltage can be used. For example, the sensing voltage can be generated by detecting a current flowing to the transistor ML (hence the coil current IL) during an on period of the transistor ML. Alternatively, the sensing voltage can be generated by detecting the coil current IL directly by a current sensor. The slope voltage Vslp only needs to function in an obvious way during an on period of the transistor MH, and can be fixed at 0 V during an off period of the transistor MH.

The error voltage Vcmp and the slope voltage Vslp are supplied to the reset comparator 214. The reset comparator 214 generates and outputs the signal RST based on the error voltage Vcmp and the slope voltage Vslp. In the reset comparator 214, an inverting input terminal is connected to the wiring WR211 and receives the error voltage Vcmp, and a non-inverting input terminal receives the slope voltage Vslp. Thus, the reset comparator 214 outputs the signal RST at a low level when “Vemp>Vslp” holds true, and outputs the signal RST at a high level when “Vemp<Vslp” holds true. When “Vemp=Vslp” holds true, the signal RST is at a low level or a high level.

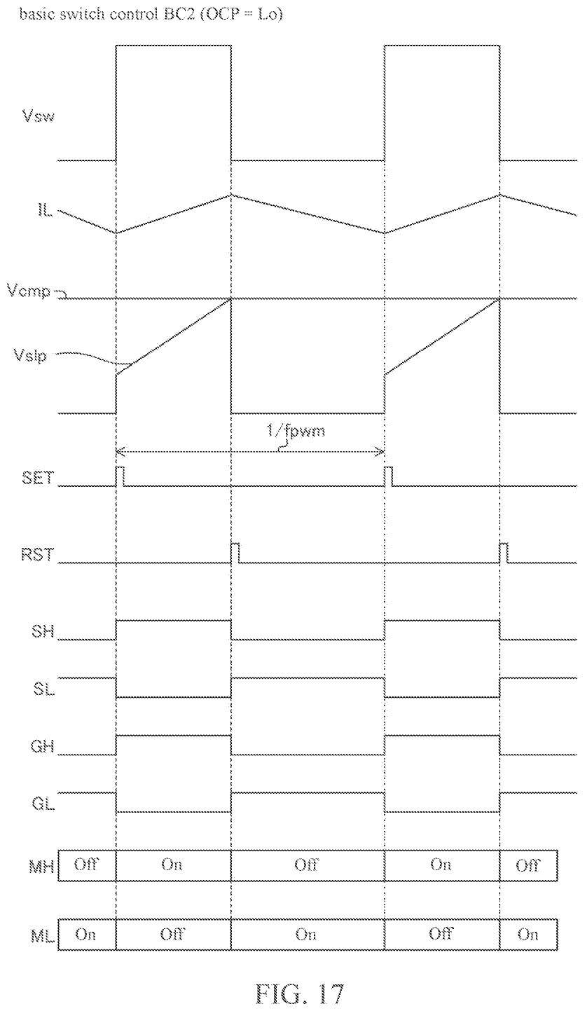

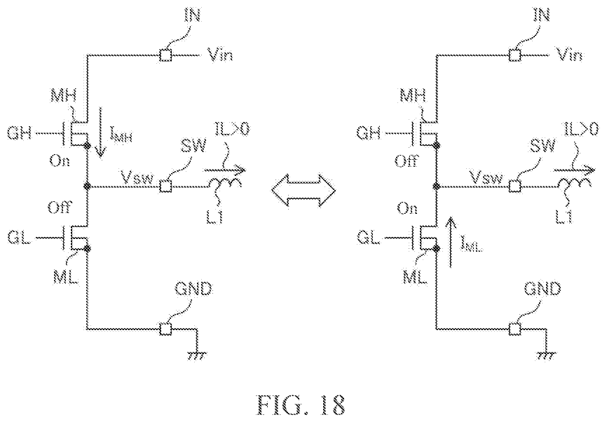

FIG. 17 shows waveforms of several signals including the signal RST. During an on period of the transistor MH, the slope voltage Vslp monotonically increases. When the slope voltage Vslp switches from a state of “Vemp>Vslp” to a state of “Vemp<Vslp” during a rising process, the reset comparator 214 causes the signal RST to generate a rising edge. Since the rising edge of the signal RST is used as an opportunity to transit to an off period of the transistor MH and to return the slope voltage Vslp to 0 V, a high level period of the signal RST is relatively small. Except for a special condition such as immediately after power is supplied to the power supply control device 210, “Vcmp>0” holds true.

The setting signal generation circuit 215 generates and outputs the signal SET having a predetermined frequency fpwm. The signal SET is a signal that generates a pulse at the frequency fpwm. That is to say, according to each cycle of the signal SET, a pulse that becomes a high level only in a minute time is generated in the signal SET. The setting signal generation circuit 215 can be formed by using an oscillator oscillating at the frequency fpwm. A length of one cycle of the signal SET is a reciprocal of the frequency fpwm. A rising edge is generated in the signal SET at an interval of the reciprocal of the frequency fpwm. The reciprocal of the frequency fpwm is referred to as a PWM cycle.

The logic circuit 216 generates and outputs the control signals SH and SL based on the signals SET and RST. As shown in FIG. 17, the logic circuit 216 generates a rising edge in the control signal SH and generates a falling edge in the control signal SL by using a rising edge of the signal SET as an opportunity, and generates a falling edge in the control signal SH and generates a rising edge in the control signal SL by using a rising edge of the signal RST as an opportunity. Moreover, after the rising edge in the control signal SL is generated by using the rising edge of the signal RST as an opportunity, when a reverse current detection signal ZXOUT at a high level is input to the logic circuit 216, the logic circuit 216 does not wait for a next rising edge of the signal SET but generates a falling edge in the control signal SL.

Herein, an output signal (including a signal OCP) of the overcurrent protection circuit 220 is input to the logic circuit 216. It is also to be described below that, the operation of the logic circuit 216 is stopped during a period in which an overcurrent protection is performed based on the output signal of the overcurrent protection circuit 220.

The driver 217 is connected to the gates of the transistors MH and ML, the switch terminal SW and the ground terminal GND. The driver 217 individually turns on or turns off the transistors MH and ML by respectively supplying the gate signals GH and GL corresponding to the control signals SH and SL to the gates of the transistors MH and ML. The driver 217 turns on the transistor MH by setting the gate signal GH to a high level when the control signal SH is at a high level, and turns off the transistor MH by setting the gate signal GH to a low level when the control signal SH is at a low level. The driver 217 turns on the transistor ML by setting the gate signal GL to a high level when the control signal SL is at a high level, and turns off the transistor ML by setting the gate signal GL to a low level when the control signal SL is at a low level.

The logic circuit 216 does not set both of the control signals SH and SL at a high level at the same time. Thus, the transistor ML is always off during an on period of the transistor MH, and the transistor MH is always off during an on period of the transistor ML.

The reverse current detection circuit 218 compares the switching voltage Vsw with the ground potential during an on period of the transistor ML to detect whether there is a reverse current, and generates a reverse current detection signal ZXOUT indicating the detection result. The reverse current detection signal ZXOUT is supplied to the logic circuit 216. The reverse current refers to a current flowing from the switch terminal SW to the ground portion through the transistor ML, and is equivalent to the coil current IL in a negative value. A level of the reverse current detection signal ZXOUT is low when the switching voltage Vsw is lower than the ground potential, and is high when the switching voltage Vsw is greater than the ground potential. That is to say, the level of the reverse current detection signal ZXOUT becomes a high level when the coil current IL in a negative value is generated. By switching the transistor ML from on to off upon detecting the reverse current so as to cut off the reverse current, efficiency during a light load can be improved. The signal ZXOUT is maintained at a low level unless otherwise specifically necessary.

The overcurrent protection circuit 220 detects whether the output stage MM is in a state of overcurrent based on a size of a current flowing to the output stage MM, and generates and outputs a signal OCP corresponding to the detection result. Upon detecting that the output stage MM is in a state of overcurrent, the overcurrent protection circuit 220 supplies the signal OCP at a high level to the logic circuit 216 and the error voltage change suppression circuit 221. Operation details of the circuits 220 and 221 as well as those of the logic circuit 216 in response to the signal OCP at a high level are provided below. First of all, a basic switching control BC2 shown in FIG. 17 is described below.

### [Basic Switching Control BC2]

The switching control circuit SWC can switch and drive the output stage MM by using PWM control. PWM is an abbreviation for pulse width modulation. FIG. 17 shows a timing diagram of the basic switching control BC2 that can be performed by the switching control circuit SWC. The basic switching control BC2 is a PWM control performed in a current continuous mode, and is a PWM control performed while the signal OCP is maintained at a low level. In the current continuous mode, the coil current IL always flows from the switch terminal SW to the output terminal OUT. On the premise that the signal OCP is kept at a low level, the logic circuit 216 generates a rising edge in the control signal SH and generates a falling edge in the control signal SL by using a rising edge of the signal SET as an opportunity, and generates a falling edge in the control signal SH and generates a rising edge in the control signal SL by using a rising edge of the signal RST as an opportunity. In the basic switching control BC2, a switching operation of alternately and periodically turning on and turning off the transistors MH and ML at the frequency fpwm is performed.

In the basic switching control BC2, the control signals SH and SL are PWM signals having the frequency fpwm. In the basic switching control BC2, a switching drive is performed on the transistors MH and ML at the frequency fpwm, and as a result, the switching voltage Vsw has the frequency fpwm. That is to say, in the basic switching control BC2, a switching frequency of the output stage MM is consistent with the frequency fpwm. In the basic switching control BC2, the output voltage Vout is stabilized at a target voltage Vtg by adjusting a length of a high level period of the control signal SH (that is, an on period of the transistor MH) in each cycle. The target voltage Vtg is determined by a ratio of the output voltage Vout to the feedback voltage Vfb and the reference voltage Vref, and is represented by “Vtg=(Vout/Vfb)×Vref”. The ratio of the output voltage Vout to the feedback voltage Vfb is equal to a voltage dividing ratio of the output voltage Vout of the feedback voltage generation circuit (R1 and R2).

An increase in the output current Iout causes a decrease in the output voltage Vout, and when viewing from the target voltage Vtg, the decrease in the output voltage Vout causes an increase in the error voltage Vcmp. A decrease in the output current Iout causes an increase in the output voltage Vout, and when viewing from the target voltage Vtg, the increase in the output voltage Vout causes a decrease in the error voltage Vcmp. A duty cycle is increased in response to the increase in the error voltage Vcmp and is decreased in response to the decrease in the error voltage Vcmp, and the reset comparator 214 generates the signal RST based on the error voltage Vcmp and the slope voltage Vslp. The on duty cycle represents a ratio of a length of an on period of the transistor MH with respect to a sum of a length of an on period of the transistor MH and a length of an off period of the transistor MH.

In the basic switching control BC2, the logic circuit 216 can set an upper duty cycle limit for the on duty cycle, and generate the control signals (SH and SL) in a manner that the on duty cycle does not exceed the upper duty cycle limit. Thus, for example, assuming that the switching frequency is 1 MHz and the upper duty cycle limit is 95%, when no rising edge is generated in the signal RST after 0.95 ms has elapsed from a rising edge generated in the control signal SH, the logic circuit 216 can immediately generate a falling edge in the control signal SH and generate a rising edge in the control signal SL instead of depending on the signal RST.

### [Overcurrent Protection Operation]

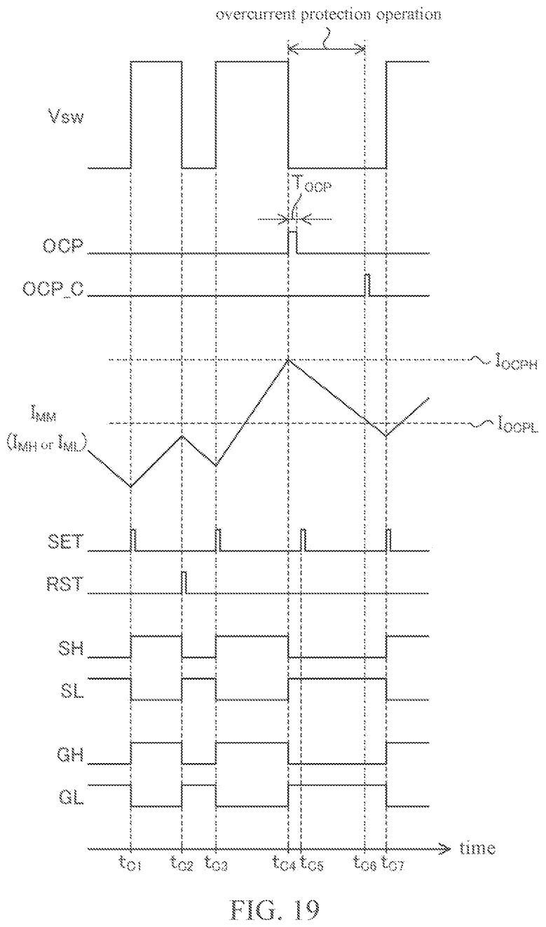

Next, the overcurrent protection operation implemented by the overcurrent protection circuit 220 is described. Herein, as shown in FIG. 18, when “IL>0”, a symbol “I_{MH}” is used to represent a current flowing to the transistor MH, and a symbol “I_{ML}” is used to represent a current flowing the transistor ML. The current I_{MH} represents a current flowing from the drain to the source of the transistor MH during an on period of the transistor MH, and the current I_{ML} represents a current flowing from the source to the drain of the transistor ML during an on period of the transistor ML. Thus, a value of the current I_{MH} represents a value (a size) of the current flowing to the transistor MH during an on period of the transistor MH, and a value of the current I_{ML} represents a value (a size) of the current flowing to the transistor ML during an on period of the transistor ML. Moreover, a symbol “I_{MM}” is used to represent a current flowing to the output stage MM (referring to FIG. 19). During an on period of the transistor MH, “I_{MM}=I_{MH}=IL”; during an on period of the transistor ML, “I_{MM}=I_{ML}=IL”.

FIG. 19 shows a timing diagram when an overcurrent protection operation is performed. In FIG. 19, waveforms of the switching voltage V_{sw}, the signal OCP, a signal OCP_C, the current I_{MM}, the signal SET, the signal RST, the control signal SH, the control signal SL, the gate signal GH and the gate signal GL are sequentially represented from top to bottom. The signals OCP and OCP_C are signals output from the overcurrent protection circuit 220. Similar to the signal OCP, the signal OCP_C is a binary signal having a high level or a low level.

The signals OCP and OCP_C in principle have a low level. The overcurrent protection circuit 220 causes the signal OCP to have a high level when a predetermined overcurrent detection condition is established, and causes the signal OCP_C to have a high level when a predetermined release condition is established. The signal OCP at a high level functions as an overcurrent protection signal (in other words, as an overcurrent detection signal), and the signal OCP_C at a high level functions as a release signal.

As the time progresses, timings t_{C1}, t_{C2}, t_{C3}, t_{C4}, t_{C5}, t_{C6} and t_{C7} sequentially arrive. The basic switching control BC2 is performed continually from a timing before the timing t_{C1} to a timing before the timing t_{C4}. At the timing t_{C1}, a rising edge is generated in the signal SET. The timing t_{C3} is a timing of one PWM cycle (that is, the time (1/fpwm)) after the timing t_{C1}, the timing t_{C5} is a timing of two PWM cycles (that is, the time (2/fpwm)) after the timing t_{C1}, and the timing t_{C7} is a timing of three PWM cycles (that is, the time (3/fpwm)) after the timing t_{C1}.

The transistor MH is turned on and the transistor ML is turned off by using a rising edge of the signal SET at the timing t_{C1} as an opportunity. The transistor MH is turned on and the transistor ML is turned on by using a rising edge of the signal RST at the timing t_{C2} as an opportunity. Then, the transistor MH is turned on and the transistor ML is turned off further by using a rising edge of the signal SET at the timing t_{C3} as an opportunity. From the timing t_{C3} to the timing t_{C4}, the current I_{MM} consistent with the current I_{MH} gradually increases. Before the timing t_{C4}, a value of the current I_{MM} is less than a predetermined overcurrent threshold I_{OCPH}. At the timing t_{C4}, the value of the current I_{MM} has reached and exceeds the overcurrent threshold I_{OCPH}. Moreover, after the timing t_{C2}, no rising edge is generated in the signal RST until the timing t_{C4}. In the example in FIG. 19, a next rising edge (not shown) of the signal RST is generated at the timing t_{C7} after the rising edge of the signal RST at the timing t_{C2}.

The overcurrent protection circuit 220 has a function of detecting a size relationship between the value of the current I_{MM} (the value of the current I_{MH} herein) and the predetermined overcurrent threshold I_{OCPH} during an on period of the transistor MH. At the timing t_{C4}, the value of the current I_{MM} (the value of the current I_{MH} herein) changes from a state of not exceeding the overcurrent threshold I_{OCPH} to a state of exceeding the overcurrent threshold I_{OCPH}, and the overcurrent protection circuit 220, upon detecting the change, determines that the output stage MM is in an overcurrent state and generates a rising edge in the signal OCP. Thus, at the timing t_{C4} herein, a rising edge is generated in the signal OCP (that is, an overcurrent protection signal is output from the circuit 220 at the timing t_{C4}). By changing from a state of “I_{MM}≤I_{OCPH}” to a state of “I_{MM}>I_{OCPH}”, the overcurrent detection condition is established.

The overcurrent protection circuit 220 generates a falling edge in the signal OCP after a predetermined time T_{OCP} has elapsed from generating a rising edge in the signal OCP. In this embodiment, the time T_{OCP} is a predetermined fixed time.

The signal OCP at a high level is input to the logic circuit 216. At the timing t_{C4}, by using the signal OCP at a high level as an opportunity, the logic circuit 216 does not depend on the level of the signal RST but executes the overcurrent protection operation. The logic circuit 216 does not depend on the level of the signal SET during execution of the overcurrent protection operation, and keep the transistor MH off and keep the transistor ML on. Thus, during execution of the overcurrent protection operation, the current I_{MM} flowing to the output stage MM gradually decreases as accumulated energy of the coil L1 decreases. During execution of the overcurrent protection operation, “I_{MM}=I_{ML}”.

The overcurrent protection circuit 220 has a function of detecting a size relationship between the value of the current I_{MM} (the value of the current I_{ML} herein) and the predetermined release threshold I_{OCPL} during an on period of the transistor ML. At the timing t_{C6}, the value of the current I_{MM} (the value of the current I_{ML} herein) changes from a state of exceeding the release threshold I_{OCPL} to a state of being lower than the release threshold I_{OCPL}, and the overcurrent protection circuit 220, upon detecting the change, determines that the overcurrent state of the output stage MM is eliminated and generates a rising edge in the signal OCP_C. Thus, at the timing t_{C6} herein, a rising edge is generated in the signal OCP_C (that is, a release signal is output from the circuit 220 at the timing t_{C6}). By changing from a state of “I_{MM}≥I_{OCPL}” to a state of “I_{MM}<I_{OCPL}”, the release condition is established. The overcurrent protection circuit 220 generates a falling edge in the signal OCP_C after a predetermined minute time has elapsed from generating a rising edge in the signal OCP_C. The release threshold I_{OCPL} is lower than the overcurrent threshold I_{OCPH}.

The signal OCP_C at a high level is input to the logic circuit 216. The logic circuit 216 receives the signal OCP_C at a high level at the timing t_{C6}, and ends the overcurrent protection operation. Thus, in the example in FIG. 19, the overcurrent protection operation starts at the timing t_{C4}, and the overcurrent protection operation ends at the timing t_{C6}.

Then, at the timing t_{C7}, a rising edge is generated in the signal SET. Since the overcurrent protection operation is not performed at the timing t_{C7}, the transistor MH is turned on and the transistor ML is turned off by using a rising edge of the signal SET at the timing t_{C7} as an opportunity. At the timing t_{C5}, a rising edge is also generated in the signal SET. However, because the timing t_{C5} belongs to a period of execution of the overcurrent protection operation, the rising edge of the signal SET at the timing t_{C5} is considered invalid in the logic circuit 216. Thus, the logic circuit 216 does not depend on the rising edge of the signal SET at the timing t_{C5}, and maintain the control signal SH at a low level and maintain the control signal SL at a high level from the timing t_{C4} to the timing t_{C7}.

The overcurrent protection circuit 220 is capable of detecting the current I_{MH} based on a drain-source voltage of the transistor MH (hence a voltage between the input terminal IN and the switch terminal SW herein) and an on resistance of the transistor MH. The overcurrent protection circuit 220 is capable of detecting the current I_{ML} based on a drain-source voltage of the transistor ML (hence a voltage between the ground terminal GND and the switch terminal SW herein) and an on resistance of the transistor ML. The on resistances of the transistors MH and ML are known to the overcurrent protection circuit 220. In practice, the overcurrent protection circuit 220 can detect a size relationship between the current I_{MH} and the overcurrent threshold I_{OPCH} by comparing the drain-source voltage of the transistor MH with a predetermined first voltage threshold. The first voltage threshold is equivalent to a product of the overcurrent threshold I_{OCPH} and the on resistance of the transistor MH. Similarly, the overcurrent protection circuit 220 can detect a size relationship between the current I_{ML} and the release threshold I_{OPCL} by comparing the drain-source voltage of the transistor ML with a predetermined second voltage threshold. The second voltage threshold is equivalent to a product of the release threshold I_{OCPL} and the on resistance of the transistor ML.

During the overcurrent protection operation executed at an opportunity when “I_{MM}>I_{OCPH}” is established, the transistor MH is kept in an off state, and thus the current I_{MM} flowing to the output stage MM gradually decreases as the accumulated energy of the coil L1 decreases. Thus, in the overcurrent protection operation, an increase in the current I_{MM} exceeding the overcurrent threshold I_{OCPH} is limited (suppressed). That is to say, with execution of the overcurrent protection operation, a further increase in the value of the current I_{MM} exceeding the overcurrent threshold I_{OCPH} is limited (suppressed).

Moreover, a variation configuration in which the logic circuit 216, starting from the overcurrent protection operation to when a predetermined cooling time has elapsed, continues the overcurrent protection operation (that is, maintaining an off state of the transistor MH) is used. When the variation configuration above is used, after the overcurrent protection operation starts at the timing t_{C4}, the overcurrent protection operation does not end even if a rising edge is generated in the signal OCP_C before a timing after a cooling time has elapsed from the timing t_{C4} (hereinafter referred to as an elimination allowed timing). In the variation configuration, if a rising edge is generated in the signal OCP_C between the timing t_{c4} and the elimination allowed timing, the logic circuit 216 causes the overcurrent protection operation to end at the elimination allowed timing. In the variation configuration, if a rising edge is not generated in the signal OCP_C between the timing t_{C4} and the elimination allowed timing, the logic circuit 216 causes the overcurrent protection operation to end when a rising edge is later generated in the signal OCP_C.

[Operation of Hypothetical Configuration Associated with Overcurrent Protection]

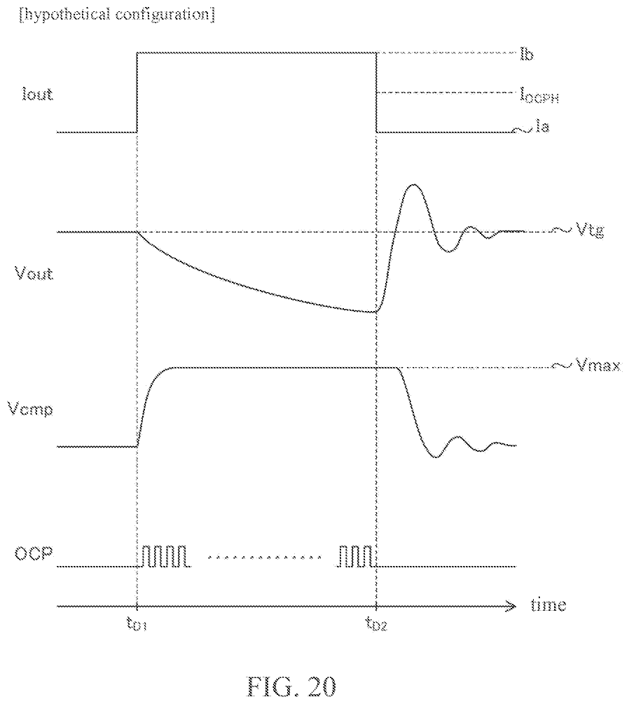

One main reason for execution of the overcurrent protection operation is an increase in an output current I_{OUT}, which should be referred to as a load current. Referring to FIG. 20, behaviors of the overcurrent protection operation performed based on an increase in the output current I_{OUT} are described. The hypothetical configuration refers to a configuration different from the power supply control device 210 of the embodiment EX2_1, and is a configuration in which the error voltage change suppression circuit 221 is removed from the power supply control device 210 in FIG. 16.

In the example shown in FIG. 20 (hereinafter referred to as an example α for illustration purposes), the output current Iout has a current value Ia before a timing t_{D1}. In the example a, a current consumed by the load LD at the timing t_{D1} increases drastically, and accordingly a value of the output current Iout increases drastically from the current value Ia to a current value Ib. Then, in the example α, the current consumed by the load LD at the timing t_{D2} decreases, and accordingly the value of the output current Iout drops drastically from the current value Ib to a current value Ia. In the example α, the value of the output current Iout is kept at the current value Tb from the timings t_{D1} to t_{D2}.

Herein, “Ia<I_{OCPH}<Ib” holds true. Thus, between the timings t_{D1} and t_{D2}, the overcurrent protection operation is performed for once or more. In the example α, the duration between the timings t_{D1} and t_{D2} is at an extent that the overcurrent protection operation is performed repeatedly between the timings t_{D1} and t_{D2}. Thus, between the timings t_{D1} and t_{D2}, an operation the same as the operation from the timing t_{c3} to the timing t_{C7} (referring to FIG. 19) is performed repeatedly. FIG. 20 depicts a situation where pulsation is generated repeatedly in the signal OCP between the timings t_{D1} and t_{D2}.

The basic switching control BC2 not accompanied with the overcurrent protection operation is performed before the timing t_{D1}, and the output voltage Vout is stabilized at the target voltage Vtg. Between timings t_{D1} and t_{D2}, the current I_{MM} flowing to the output stage MM is limited to below the overcurrent threshold I_{OCPH}, and so the output voltage Vout gradually decreases compared to the target voltage Vtg. In the hypothetical configuration, after the timing t_{D1}, the error voltage Vcmp increases because “Vout<Vtg” holds true, and before the timing t_{D2} is reached, the value of the error voltage Vcmp reaches a maximum value Vamx of a variation range of the error voltage Vcmp. In the hypothetical configuration, when the value of the error voltage Vcmp reaches the maximum value Vmax, the value of the error voltage Vmax is kept at the maximum value Vmax before the timing t_{D2}.

In the hypothetical configuration, when the value of the output voltage Vout decreases from the current value Ib to the current value Ia by using the timing t_{D2} as a boundary, the basic switching control BC2 not accompanied with the overcurrent protection operation is restarted. However, in the hypothetical configuration, after the timing t_{D2}, the error voltage Vcmp has the maximum value Vmax or has a value close to the maximum value Vmax, and so the on duty cycle (a pulse width of the control signal SH) is overly large with respect to a situation of “Iout=Ia”. In the hypothetical configuration, due to the overly large on duty cycle, an overshoot of the output voltage Vout exceeding the target voltage Vtg increases immediately after the timing t_{D2} occurs. In the hypothetical configuration, after the timings t_{D2}, the output voltage Vout gradually converges to the target voltage Vtg after going through the overshoot and ringing.

An overly large overshoot in the output voltage Vout may damage the load LD. Therefore, the overshoot in the output voltage Vout needs to be suppressed as much as possible.

[Operation of Improved Configuration Associated with Overcurrent Protection]

The power supply control device 210 has an improved configuration which is a configuration improved from the hypothetical configuration. For the improvement, the error voltage change suppression circuit 221 is provided in the power supply control device 210. As shown in FIG. 16, the circuit 221 of the embodiment EX2_1 includes a transistor 221a as a discharge switch. The transistor 221a is an N-channel MOSFET. The transistor 221a is connected in parallel to the capacitor 212b.

More specifically, a first end of the resistor 212a is connected to the wiring WR211, a second end of the resistor 212a is connected to a first end of the capacitor 212b and a drain of the transistor 221a, and a second end of the capacitor 212b and a source of the transistor 221a are connected to a potential point having a predetermined potential. Herein, the potential point having the predetermined potential is a ground portion having a fixed potential of 0 V. However, the potential point having the predetermined potential can also be a potential point having a potential other than 0 V (for example, a positive or negative minute potential). Moreover, a minimum value of the variation range of the error voltage Vcmp has a potential of the potential point. The signal OCP is input to a gate of the transistor 221a. The transistor 221a is in an on state during a high level period of the signal OCP, and the transistor 221a is in an off state during a low level period of the signal OCP.

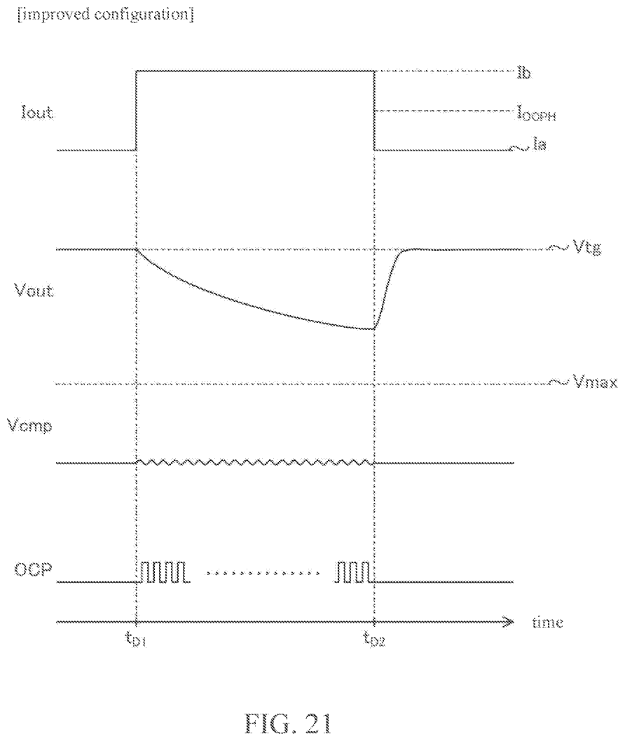

Referring to FIG. 21, behaviors of the overcurrent protection operation performed based on an increase in the output current I_{OUT} in the improved configuration (that is, in the power supply control device 210) are described.

The example α is also considered in FIG. 21. As described above, the overcurrent protection operation is performed repeatedly between the timings t_{D1} and t_{D2}. That is to say, between the timings t_{D1} and t_{D2}, an operation the same as the operation from the timing t_{c3} to the timing t_{C7} (referring to FIG. 19) is performed repeatedly. FIG. 21 depicts a situation where pulsation is generated repeatedly in the signal OCP between the timings t_{D1} and t_{D2}. That is to say, between the timings t_{D1} and t_{D2}, a rising edge and a falling edge of the signal OCP alternately and repeatedly take place.

The basic switching control BC2 not accompanied with the overcurrent protection operation is performed before the timing t_{D1}, and the output voltage Vout is stabilized at the target voltage Vtg. Between timings t_{D1} and t_{D2}, the current I_{MM} flowing through the output stage MM is limited to below the overcurrent threshold I_{OCPH}, and so the output voltage Vout gradually decreases compared to the target voltage Vtg.

A current (supplied with a positive charge) is output to the wiring WR211 from the error amplifier 211 by holding “Vout<Vtg” true, and the current causes an increase in the error voltage Vcmp. The charge caused by the output current of the error amplifier 211 is accumulated in the capacitor 212b, and an increase in the charge accumulated in the capacitor 212b helps the error voltage Vcmp to increase. However, in the improved configuration, each time when the signal OCP becomes at a high level (that is, each time the overcurrent protection signal is output), the transistor 221a is turned on, and accordingly the charge accumulated in the capacitor 212b is discharged. Thus, between the timings t_{D1} and t_{D2}, the error voltage Vcmp in the improved configuration is suppressed to be lower than the error voltage Vcmp in the hypothetical configuration.

In the improved configuration, when the value of the output voltage Vout decreases from the current value Ib to the current value Ia by using the timing t_{D2} as a boundary, the basic switching control BC2 not accompanied with the overcurrent protection operation is restarted. Herein, in the improved configuration, between the timings t_{D1} and t_{D2}, the value of the error voltage Vcmp is suppressed to be sufficiently lower than the maximum value Vmax. Thus, in the improved configuration, an on duty cycle (the pulse width of the control signal SH) after the timing t_{D2} is not overly large with respect to a situation of “Iout=Ia”. As a result, in the improved configuration, after the timing t_{D2}, the output voltage Vout does not at all or almost does not generate an overshoot in the output voltage Vout, and gradually converge to the target voltage Vtg.

Thus, the circuit 221 has a function of suppressing the error voltage Vcmp from changing in an upward direction based on the overcurrent protection signal (the signal OCP at a high level).

Accordingly, once recovered from a state of overcurrent, the overshoot and ringing in the output voltage Vout can be suppressed.

More specifically, when the feedback voltage Vfb is lower than the reference voltage Vref by performing the overcurrent protection operation in response to the overcurrent protection signal (the signal OCP at a high level), the error amplifier 211 outputs the current signal 1211 that increases the error voltage Vcmp to the wiring WR211, while the circuit 211 performs an operation to decrease the error voltage Vcmp in opposite to the error amplifier 211 based on the overcurrent protection signal, accordingly suppressing the error voltage Vcmp from changing in an upward direction.

More specifically, the circuit 211 discharges the charge accumulated in the capacitor 212b by turning on the discharge switch (the transistor 221a herein) based on the overcurrent protection signal, accordingly suppressing the error voltage Vcmp from changing in an upward direction.

### Embodiment EX2_2

The embodiment EX2_2 is described below. The embodiment EX2_2 and embodiments EX2_3 to EX2_5 described below are embodiments based on the embodiment EX2_1. Provided that there are no contradictions, for the matters not particularly described in the embodiment EX2_2, the details of the embodiment EX2_1 are also applicable to the embodiment EX2_2 (the same applies to the embodiments EX2_3 to EX2_5 below).

In the embodiment EX2_1, the length of the high level period of the signal OCP, that is, the time T_{OCP}, is a fixed time. However, the time T_{OCP} is not limited to being a fixed time. In the embodiment EX2_2, an example of other setting methods is given.

In the power supply control device 210, an off detection circuit (not shown) that detects switching from an on state to an off state of the transistor MH is disposed. The off detection circuit is connected to the switch terminal SW and the gate of the transistor MH, and detects whether the transistor MH has switched from an on state to an off state based on the gate-source voltage of the transistor MH (that is, based on the potential of the gate signal GH viewing from the switching voltage Vsw). The off detection circuit, upon detecting that the gate-source voltage of the transistor MH has changed from a state of being greater than the gate threshold voltage of the transistor MH to a state of being less than the gate threshold voltage of the transistor MH, determines that the transistor MH has switched from an on state to an off state, and outputs an off detection signal. The off detection signal is input to the overcurrent protection circuit 220.

The overcurrent protection circuit 220 of the embodiment EX2_2, after a rising edge is generated in the signal OCP, maintains the signal OCP at a high level until the input of the off detection signal is received, and generates a falling edge in the signal OCP by using the input of the off detection signal received as an opportunity.

The logic circuit 216 generates a falling edge in the control signal SH by using the rising edge of the signal OCP as an opportunity, and the driver 217 causes the gate signal GH to lower from a high level to a low level in response to the falling edge of the control signal SH so as to turn off the transistor MH. At this point in time, a corresponding delay exists in the time from the rising edge of the signal OCP to the actual turning off of the transistor MH. The time T_{OCP} of the embodiment EX2_2 depends on a size of the delay.

In the switching drive of the output stage MM, the state of the output stage MM switches between a first output stage state causing the current I_{MM} flowing to the output stage MM to increase, and a second output stage state causing the current I_{MM} flowing to the output stage MM to decrease. The first output stage state is a state in which the transistor MH is on and the transistor ML is off. The second output stage state is a state in which the transistor MH is off. In the second output stage state, typically speaking, the transistor ML is on, but it is possible that the transistor ML is off. When the state of the output stage MM is in the first output stage state, the overcurrent protection circuit 220 starts to output the overcurrent protection signal (the signal OCP at a high level) when the value of the current I_{MM} exceeds the overcurrent threshold I_{OCPH}, and later when the state of the output stage MM changes to the second output stage state, stops outputting the overcurrent protection signal. The change in the state of the output stage MM to the second output stage state is detected by the off detection circuit, and the overcurrent protection circuit 220 stops outputting the overcurrent protection signal by using the input of the off detection signal as an opportunity. Within a period of outputting the overcurrent protection signal, the discharge switch (the transistor 221a herein) is turned on.

### Embodiment EX2_3

The embodiment EX2_3 is described below. Given that the circuit 21 has a function of suppressing the error voltage Vcmp from changing in an upward direction based on the overcurrent protection signal (the signal OCP at a high level), the circuit 21 is not limited to being in the configuration shown in FIG. 16.

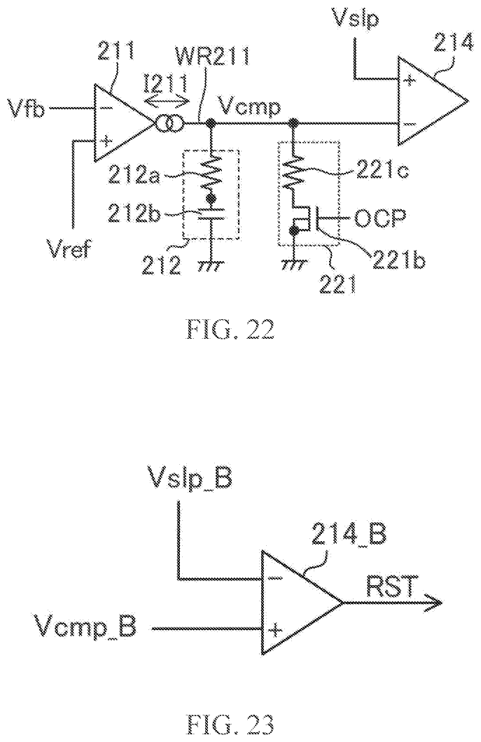

For example, a circuit 221 can also be used in substitution for the transistor 221a in FIG. 16, and includes a transistor 221b and a resistor 221c as shown in FIG. 22. The transistor 221b is an N-channel MOSFET. A drain of the transistor 221b is connected to the wiring WR211 via the resistor 221c. A source of the transistor 221b is grounded. The signal OCP is input to a gate of the transistor 221b. The transistor 221b is in an on state during a high level period of the signal OCP, and the transistor 221b is in an off state during a low level period of the signal OCP.

When the circuit 221 in FIG. 22 is used, the transistor 221b is turned on each time the signal OCP is at a high level (that is, each time the overcurrent protection signal is output), and turning on of the transistor 221b helps to decrease the error voltage Vcmp. That is to say, the circuit 221 in FIG. 22 has a function of suppressing the error voltage Vcmp from changing in an upward direction based on the overcurrent protection signal (the signal OCP at a high level). Moreover, in the circuit 221 in FIG. 22, the resistor 221c can also be omitted according to an on resistance of the transistor 221b. When the resistor 221c is omitted, the drain of the transistor 221b is directly connected to the wiring WR211.

### Embodiment EX2_4

The embodiment EX2_4 is described below. In the embodiments EX2_1 to EX2_3, a configuration in which the error voltage increases when “Vfb<Vref” and the error voltage decreases when “Vfb>Vref” is used. However, a direction of change in the error voltage can also be designed to be opposite to the direction shown in the embodiments EX2_1 to EX2_3. However, in this case, a direction of change in the slope voltage Vslp is also designed to be opposite to that of the embodiments EX2_1 to EX2_3.

That is to say, the configuration shown in FIG. 23 can be used in the power supply control device 210. FIG. 23 is a diagram of a partial configuration of the power supply control device 210 of an embodiment EX2_4. The power supply control device 210 of the embodiment EX2_4 includes a reset comparator 214_B as the reset comparator 214.

In the power supply control device 210 of the embodiment EX2_4, a slope voltage Vslp_B is generated by the slope voltage generation circuit 213, and an error voltage Vcmp_B is generated by an error voltage generation circuit including the error amplifier 211. For example, the error voltage generation circuit can be formed by the error amplifier 211 and a level shifter (not shown) that generates the error voltage Vcmp_B from the error voltage Vcmp. Herein, equations (1) and (2) hold true. Vslp and Vcmp on the right of equations (1) and (2) are the voltages Vslp and Vcmp described in the embodiments EX2_1 to EX2_3. Vcc on the right of equations (1) and (2) is a positive DC voltage. The voltage Vcc can be the input voltage Vin itself, or can be an internal power supply voltage generated in the power supply control device 210.

$$Vslp\_B = Vcc - Vslp \qquad ( 1 )$$

$$Vcmp\_B = Vcc - Vcmp \qquad ( 2 )$$

In the reset comparator 214_B, the slope voltage Vslp_B is input to an inverting input terminal, and the error voltage Vcmp_B is input to a non-inverting input terminal. The reset comparator 214_B compares the voltages Vslp_B and Vcmp_B, outputs the signal RST at a low level when “Vslp_B>Vemp_B” holds true, outputs the signal RST at a high level when “Vslp_B<Vcmp_B” holds true, and outputs the signal RST at a low level or a high level when “Vslp_B=Vemp_B” holds true.

In the embodiment EX2_4, the signal RST output from the reset comparator 214_B is supplied to the logic circuit 216. Operation details that are not specifically described in the embodiment EX2_4 are the same as those given in the embodiment EX2_1, EX2_2 or EX2_3.

A direction of change in a voltage includes a first direction, and a second direction opposite to the first direction. Either of the first direction and the second direction is an upward direction and the other is a downward direction. The directions of changes in the error voltage and the slope voltage of the embodiments EX2_1 to EX2_3 are respectively reversed from those of the embodiment EX2_4.

The slope voltage generation circuit 213 of the embodiment EX2_4 monotonically decreases the slope voltage Vslp_B during an on period of the transistor MH. The error voltage generation circuit of the embodiment EX2_4 operates to decrease the error voltage Vcmp_B when “Vfb<Vref”, and increase the error voltage Vcmp_B when “Vfb>Vref”.

In the embodiment EX2_4, between the timing t_{D1} and the timing t_{D2} in FIG. 21, the error voltage generation circuit operates to decrease the error voltage Vcmp_B, while the circuit 221 suppresses the error voltage Vcmp_B from changing in a downward direction based on the overcurrent protection signal (the signal OCP at a high level).

More specifically, when the feedback voltage Vfb is lower than the reference voltage Vref by performing the overcurrent protection operation in response to the overcurrent protection signal (the signal OCP at a high level), the error amplifier 211 of the embodiment EX2_4 outputs the current signal 1211 that decreases the error voltage Vcmp_B to the wiring WR211, while the circuit 211 performs an operation to increase the error voltage Vcmp_B in opposite to the error amplifier 211 based on the overcurrent protection signal, accordingly suppressing the error voltage Vcmp_B from changing in a downward direction.

### Embodiment EX2_5

The embodiment EX2_5 is described below. In the embodiment EX2_5, supplement items and variation techniques of the matters are described.

The power supply control device 210 in FIG. 16 includes a control drive circuit. The control drive circuit performs the switching drive of the output stage MM according to the error voltage Vcmp (more specifically, according to the error voltage Vcmp and the slope voltage Vslp) during a non-execution period of the overcurrent protection operation. The control drive circuit of the configuration in FIG. 16 includes the reset comparator 214, the setting signal generation circuit 215, the logic circuit 216 and the driver 217 as constituting elements. However, a concept of including the slope voltage generation circuit 213 as a constituting element of the control drive circuit can also be adopted.

The switching power supply device 1 is a step-down switching power supply device; however, a switching power supply device applying the techniques of the present disclosure can also be a step-up switching power supply device. The step-up switching power supply device generates the output voltage Vout greater than the input voltage Vin by stepping up the input voltage Vin. When the switching power supply device 1 is a step-up switching power supply device, as shown in FIG. 15, a first end of the coil L1 is connected to an application end of the input voltage Vin (a terminal applied with the input voltage Vin), a second end of the coil L1 is connected to the drain of the transistor MH and the source of the transistor ML, the source of the transistor MH is grounded, and the drain of the transistor ML is connected to the output terminal OUT and is grounded via the capacitor C1. In the configuration in FIG. 15, the transistor ML serving as a rectifier can also be replaced by a synchronous rectifier diode having an anode connected to the drain of the transistor MH and a cathode connected to the output terminal OUT. In all cases, by switching the output element (MH) between on and off during the switching drive of the output stage MM, the output voltage Vout is generated based on the current (IL) flowing through the coil L1.

### <<Note 2>>

Note 2 is attached to the present disclosure to show specific configuration examples of the embodiments above (more particularly the embodiments EX2_1 to EX2_5).

A power supply control device according to an aspect of the present disclosure is configured as (an eleventh configuration), a power supply control device (210) configured to control an output stage (MM) of a switching power supply device (1) that generates an output voltage (Vout) from an input voltage (Vin), the power supply control device comprising:
an error voltage generation circuit (11), configured to generate an error voltage (Vcmp) according to a difference between a feedback voltage (Vfb) corresponding to the output voltage and a predetermined reference voltage (Vref);
a control drive circuit (214 to 217), configured to perform a switching drive of the output stage based on the feedback voltage;
an overcurrent protection circuit (220), configured to output an overcurrent protection signal when the value of a current flowing through the output stage exceeds a predetermined overcurrent threshold (I_{OCPH}); and
an error voltage change suppression circuit (221), wherein
   the output voltage is generated from the input voltage through the switching drive of the output stage,
   the control drive circuit, in response to the overcurrent protection signal, performs an overcurrent protection operation that limits an increase in the current flowing through the output stage exceeding the overcurrent threshold, and
   the error voltage change suppression circuit is configured to suppress change in the error voltage based on the overcurrent protection signal.

Thus, a change in an error voltage accompanied by execution of an overcurrent protection operation can be suppressed, and an undesired change (for example, overshoot) in an output voltage after an overcurrent state can also be suppressed or eliminated.

The power supply control device of the eleventh configuration can also be configured as (a twelfth configuration), wherein
the feedback voltage increases or decreases as the output voltage increases or decreases;
the error voltage generation circuit is configured to generate the error voltage in an error output wiring (WR211) by outputting a current signal (1211) corresponding to the difference, to the error output wiring in a manner that the error voltage changes in a first direction (for example, an upward direction) when the feedback voltage is lower than the reference voltage, and the error voltage changes in a second direction (for example, a downward direction) opposite to the first direction when the feedback voltage is greater than the reference voltage; and
the error voltage change suppression circuit is configured to suppress the change in the error voltage in the first direction based on the overcurrent protection signal.

The power supply control device of the twelfth configuration can also be configured as (a thirteenth configuration), wherein in a state when the feedback voltage becomes lower than the reference voltage through execution of the overcurrent protection operation in response to the overcurrent protection signal, the error voltage generation circuit is configured to output the current signal for changing the error voltage in the first direction to the error output wiring; and on the other hand, the error voltage change suppression circuit is configured to suppress a change in the error voltage in the first direction by changing the error voltage in the second direction based on the overcurrent protection signal.

The power supply control device of the twelfth or thirteenth configuration can also be configured as (a fourteenth configuration), wherein
a phase compensation circuit (212) is disposed between the error output wiring and a potential point having a predetermined potential and configured to compensate for a phase of the error voltage;
the phase compensation circuit includes:
   a phase compensation resistor (212a) connected to the error output wiring; and
   a phase compensation capacitor (212b) connected between the phase compensation resistor and the potential point; and
the error voltage change suppression circuit is configured to suppress a change in the error voltage in the first direction by discharging accumulated charges of the phase compensation capacitor based on the overcurrent protection signal.

The power supply control device of the fourteenth configuration can also be configured as (a fifteenth configuration), wherein
the error voltage change suppression circuit includes a discharge switch (221a) connected in parallel to the phase compensation capacitor, and
the accumulated charges in the phase compensation capacitor are discharged by turning on the discharge switch based on the overcurrent protection signal.

The power supply control device of the fifteenth configuration can also be configured as (a sixteenth configuration), wherein
the overcurrent protection circuit is configured to output the overcurrent protection signal for a predetermined period of time when a value of the current flowing through the output stage exceeds the overcurrent threshold, and
the error voltage change suppression circuit is configured to turn on the discharge switch during an output period of the overcurrent protection signal.

The power supply control device of the fifteenth configuration can also be configured as (a seventeenth configuration), wherein
during the switching drive of the output stage, a state of the output stage is switched between a first state in which the current flowing through the output stage is increased and a second state in which the current flowing in the output stage is decreased,
the overcurrent protection circuit is configured to start outputting the overcurrent protection signal when the value of the current flowing through the output stage exceeds the overcurrent threshold while the output stage is in the first state, and then, stop outputting the overcurrent protection signal when the state of the output stage changes to the second state, and
the error voltage change suppression circuit is configured to turn on the discharge switch during the output period of the overcurrent protection signal.

The power supply control device of any one of the twelfth to seventeenth configurations can also be configured as (an eighteenth configuration), wherein the output stage includes:
an output element (MH) comprising a switching element; and
a rectifier (ML) connected to the output element,
a coil (L1) is connected to a connection node between the output element and the rectifier,
the output voltage is generated based on the current flowing through the coil by switching the output element between on and off during the switching drive of the output stage,
the power supply control device further includes a slope voltage generation circuit (213) configured to generate a slope voltage (Vslp) according to a current information of the coil,
the control drive circuit performs the switching drive of the output stage according to the error voltage and the slope voltage,
the slope voltage generation circuit monotonically changes the slope voltage in the first direction during an on period of the output element, and
the control drive circuit, after the output element is switched from off to on, switches the output element from on to off when the slope voltage reaches the error voltage in a process of changing the slope voltage in the first direction.

The power supply control device of the eighteenth configuration can also be configured as (a nineteenth configuration), wherein when the overcurrent protection signal is output when the value of the current flowing through the output stage exceeds the overcurrent threshold while the output element is controlled to be turned on, the control drive circuit is configured to switch off the output element in the overcurrent protection operation, and then maintain the output element off at least until the value of the current flowing through the output stage falls below a predetermined release threshold (I_{OCPL}), and the release threshold is lower than the overcurrent threshold.

### Embodiment EX3_1

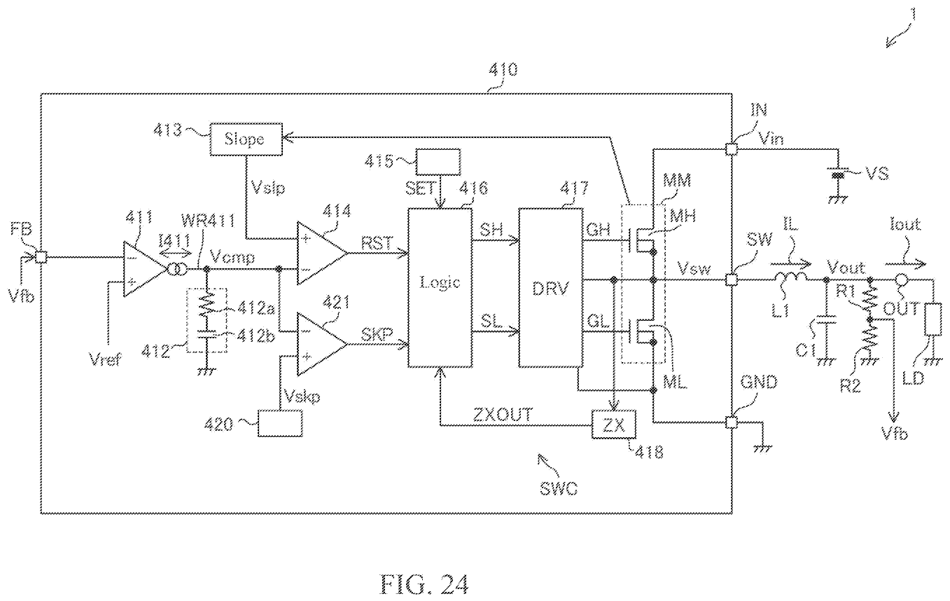

The embodiment EX3_1 is described below. FIG. 24 shows a diagram of a configuration of the switching power supply device 1 according to the embodiment EX3_1. The switching power supply device 1 of the embodiment EX3_1 includes a power supply control device 410 as the power supply control device 10.

An internal configuration of the power supply control device 410 of the embodiment EX3_1 is described below. The power supply control device 410 includes an output stage MM, an error amplifier 411, a phase compensation circuit 412, a slope voltage generation circuit 413, a reset comparator 414, a setting signal generation circuit 415, a logic circuit 416, a driver 417, a reverse current detection circuit 418, a skip determination voltage generation circuit 420 and a skip comparator 421 (a skip signal generation circuit). In the embodiment EX3_1, the switching control circuit SWC in FIG. 1 has various parts denoted by numerals 411 to 418, 420 and 421. Signals RST, SET, SH, SL and ZXOUT described below are binary signals with a signal level in a high level or a low level. The signal SET functions as a setting signal, and the signal RST functions as a reset signal. Alternatively, it can also be considered that only the signal SET at a high level functions as a setting signal, and only the signal RST at a high level functions as a reset signal.

The error amplifier 411 is a current output transconductance amplifier. The error amplifier 411 includes an inverting input terminal, a non-inverting input terminal and an output terminal. The inverting input terminal of the error amplifier 411 is connected to the feedback terminal FB to receive the feedback voltage Vfb. A predetermined reference voltage Vref is supplied to the non-inverting input terminal of the error amplifier 411. The reference voltage Vref is a DC voltage having a positive predetermined voltage value, and is generated by a reference voltage generation circuit (not shown) in the power supply control device 410. An output terminal of the error amplifier 411 is connected to a wiring WR411 (an error output wiring).

The error amplifier 411 generates a voltage according to a difference between the feedback voltage Vfb and the reference voltage Vref in the wiring WR411 by outputting a current signal 1411 corresponding to the difference between the feedback voltage Vfb and the reference voltage Vref from its output terminal. In the embodiment EX3_1, the voltage applied to the wiring WR411 is the error voltage Vcmp. However, a voltage after level shifting the voltage applied to the wiring WR411 can also be the error voltage Vcmp. A charge of the current signal 1411 is input to the wiring WR411. More specifically, the error amplifier 411 outputs a current of the current signal 1411 from the error amplifier 411 to the wiring WR411 in a manner that a potential of the wiring WR411 increases when the feedback voltage Vfb is lower than the reference voltage Vref, and sinks the current of the current signal 1411 from the wiring WR411 to the error amplifier 411 in a manner that the potential of the wiring WR411 decreases when the feedback voltage Vfb is greater than the reference voltage Vref. As an absolute value of the difference between the feedback voltage Vfb and the reference voltage Vref increases, a size of the current of the current signal 1411 also increases.

Moreover, at a start of the power supply control device 410, a soft-start voltage that slowly increases from 0 V to a voltage exceeding the reference voltage Vref can be generated in the power supply control device 410. In this case, the error amplifier 411 compares the lower one of the reference voltage Vref and the soft-start voltage with the feedback voltage Vfb, and generates the current signal 1411 based on the comparison result. However, in the embodiment EX3_1, a condition after the soft-start voltage is greater than the reference voltage Vref is taken into consideration, and the presence of the soft-start voltage is omitted.

The phase compensation circuit 412 is disposed between the wiring WR411 and the ground portion, and receives an input of the current signal 1411 and compensates for a phase of the voltage of the wiring WR411 (a phase of the error voltage Vcmp). The phase compensation circuit 412 includes a series circuit of a resistor 412a (a phase compensation resistor) and a capacitor 412b (a phase compensation capacitor). More specifically, one end of the resistor 412a is connected to the wiring WR411, and the other end of the resistor 412a is grounded via the capacitor 412b. By appropriately setting a resistance value of the resistor 412a and an electrostatic capacitance value of the capacitor 412b, the phase of the voltage of the wiring WR411 (the phase of the error voltage Vcmp) can be compensated and an oscillation in an output feedback loop can be prevented.

The slope voltage generation circuit 413 generates and outputs a slope voltage Vslp in a ramp waveform. The slope voltage Vslp has information indicating a value of the coil current IL (hereinafter referred to as current information of the coil L1). More specifically, the circuit 413 generates a sensing voltage proportional to a current flowing to the transistor MH (hence the coil current IL) during an on period of the transistor MH, and a slope voltage gradually increasing from 0 V during an on period of the transistor MH. A voltage obtained by adding the sensing voltage and the slope voltage generated by the circuit 413 during an on period of the transistor MH (that is, a sum of the sensing voltage and the slope voltage) is used as the slope voltage Vslp. Thus, during an on period of the transistor MH, the slope voltage Vslp monotonically increases. By adding the slope voltage, a sub-harmonic oscillation that may occur in a current mode control can be suppressed.

Moreover, given that the sensing voltage has current information of the coil L1, any method for generating the sensing voltage can be used. For example, the sensing voltage can be generated by detecting a current flowing to the transistor ML (hence the coil current IL) during an on period of the transistor ML. Alternatively, the sensing voltage can be generated by detecting the coil current IL directly by a current sensor. The slope voltage Vslp only needs to function in an obvious way during an on period of the transistor MH, and can be fixed at 0 V during an off period of the transistor MH.

The error voltage Vcmp and the slope voltage Vslp are supplied to the reset comparator 414. The reset comparator 414 generates and outputs the signal RST based on the error voltage Vcmp and the slope voltage Vslp. In the reset comparator 414 of the embodiment EX3_1, an inverting input terminal is connected to the wiring WR411 and receives the error voltage Vcmp, and a non-inverting input terminal receives the slope voltage Vslp. Thus, the reset comparator 414 of the embodiment EX3_1 outputs the signal RST at a low level when “Vemp>Vslp” holds true, and outputs the signal RST at a high level when “Vemp<Vslp” holds true. When “Vemp=Vslp” holds true, the signal RST is at a low level or a high level.

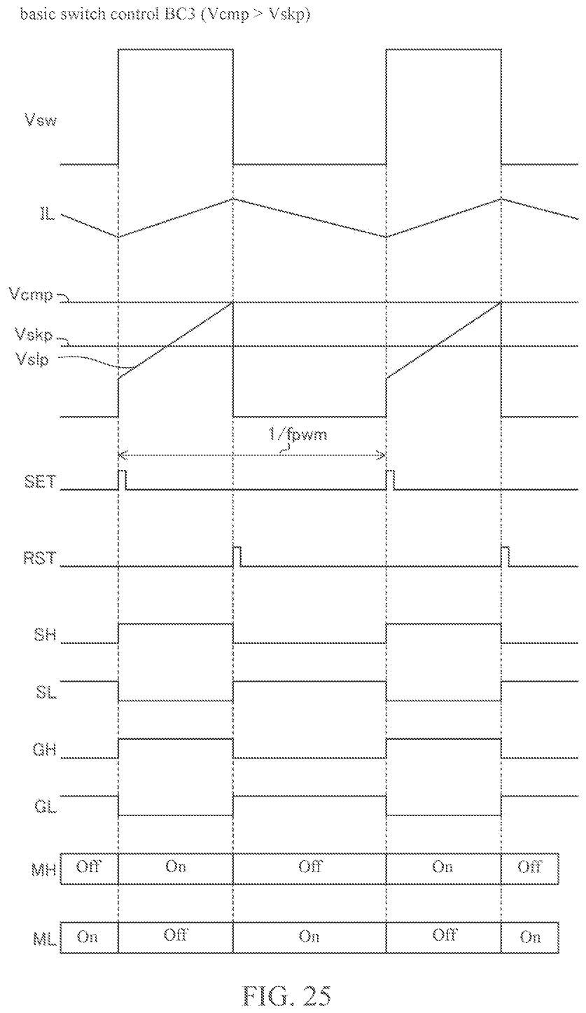

FIG. 25 shows waveforms of several signals including the signal RST. During an on period of the transistor MH, the slope voltage Vslp monotonically increases. When the slope voltage Vslp switches from a state of “Vemp>Vslp” to a state of “Vemp<Vslp” during a rising process, the reset comparator 414 generates a rising edge in the signal RST. Since the rising edge of the signal RST is used as an opportunity to transit to an off period of the transistor MH and to return the slope voltage Vslp to 0 V, a high level period of the signal RST is relatively small. Except for a special condition such as immediately after power is supplied to the power supply control device 410, “Vcmp>0” holds true.

The setting signal generation circuit 415 generates and outputs the signal SET having a predetermined frequency fpwm. The signal SET is a signal that generates a pulse at the frequency fpwm. That is to say, according to each cycle of the signal SET, a pulse that becomes a high level only in a minute time is generated in the signal SET. The setting signal generation circuit 415 can be formed by using an oscillator oscillating at the frequency fpwm. A length of one cycle of the signal SET is a reciprocal of the frequency fpwm. A rising edge is generated in the signal SET at an interval of the reciprocal of the frequency fpwm. The reciprocal of the frequency fpwm is referred to as a PWM cycle.

The logic circuit 416 generates and outputs the control signals SH and SL based on the signals SET and RST. As shown in FIG. 25, the logic circuit 416 generates a rising edge in the control signal SH and generates a falling edge in the control signal SL by using a rising edge of the signal SET as an opportunity, and generates a falling edge in the control signal SH and generates a rising edge in the control signal SL by using a rising edge of the signal RST as an opportunity. Moreover, after the rising edge in the control signal SL is generated by using the rising edge of the signal RST as an opportunity, when a reverse current detection signal ZXOUT at a high level is input to the logic circuit 416, the logic circuit 416 does not wait for a next rising edge of the signal SET but generate a falling edge in the control signal SL.

Herein, a signal SKP described below is also input to the logic circuit 416, given that the logic circuit 416 performs the operation (the operation of generating a rising edge of the control signal SH and a falling edge of the control signal SL based on a rising edge of the signal SET) during a low level period of the signal SKP. Details associated with the above are described below.

The driver 417 is connected to the gates of the transistors MH and ML, the switch terminal SW and the ground terminal GND. The driver 417 individually turns on or turns off the transistors MH and ML by respectively supplying the gate signals GH and GL corresponding to the control signals SH and SL to the gates of the transistors MH and ML. The driver 417 turns on the transistor MH by setting the gate signal GH to a high level when the control signal SH is at a high level, and turns off the transistor MH by setting the gate signal GH to a low level when the control signal SH is at a low level. The driver 417 turns on the transistor ML by setting the gate signal GL to a high level when the control signal SL is at a high level, and turns off the transistor ML by setting the gate signal GL to a low level when the control signal SL is at a low level.

The logic circuit 416 does not set both of the control signals SH and SL at a high level at the same time. Thus, the transistor ML is always off during an on period of the transistor MH, and the transistor MH is always off during an on period of the transistor ML.

The reverse current detection circuit 418 compares the switching voltage Vsw with the ground potential during an on period of the transistor ML to detect whether there is a reverse current, and generates a reverse current detection signal ZXOUT indicating the detection result. The reverse current detection signal ZXOUT is supplied to the logic circuit 416. The reverse current refers to a current flowing from the switch terminal SW to the ground portion through the transistor ML, and is equivalent to the coil current IL in a negative value. A level of the reverse current detection signal ZXOUT is low when the switching voltage Vsw is lower than the ground potential, and is high when the switching voltage Vsw is greater than the ground potential. That is to say, the level of the reverse current detection signal ZXOUT becomes a high level when the coil current IL in a negative value is generated. By switching the transistor ML from on to off upon detecting the reverse current so as to cut off the reverse current, efficiency during a light load can be improved. The signal ZXOUT is maintained at a low level unless otherwise specifically necessary.

The skip determination voltage generation circuit 420 generates and outputs a skip determination voltage Vskp. Characteristics of the skip determination voltage Vskp are described below.

The error voltage Vcmp and the skip determination voltage Vskp are supplied to the skip comparator 421. The skip comparator 421 generates and outputs the signal SKP based on the error voltage Vcmp and the skip determination voltage Vskp. In the skip comparator 421 of the embodiment EX3_1, an inverting input terminal is connected to the wiring WR411 and receives the error voltage Vcmp, and a non-inverting input terminal receives the skip determination voltage Vskp. Thus, the skip comparator 421 of the embodiment EX3_1 outputs the signal SKP at a low level when “Vemp>Vskp” holds true, and outputs the signal SKP at a high level when “Vemp<Vskp” holds true. When “Vemp=Vskp” holds true, the signal SKP is at a low level or a high level. The signal SKP functions as a skip signal, and has a first logical value or a second logical value. Herein, the signal SKP at a low level has the first logical value, and the signal SKP at a high level has the second logical value.

### [Basic Switching Control BC3]

The switching control circuit SWC can switch and drive the output stage MM by using PWM control. PWM is an abbreviation for pulse width modulation. FIG. 25 shows a timing diagram of the basic switching control BC3 that can be performed by the switching control circuit SWC. The basic switching control BC3 is a PWM control performed in a current continuous mode, and is a PWM control performed while “Vcmp>Vskp” continuously holds true. In the current continuous mode, the coil current IL always flows from the switch terminal SW to the output terminal OUT. On the premise that the signal SKP is at a low level, the logic circuit 416 generates a rising edge in the control signal SH and generates a falling edge in the control signal SL by using a rising edge of the signal SET as an opportunity, and generates a falling edge in the control signal SH and generates a rising edge in the control signal SL by using a rising edge of the signal RST as an opportunity. In the basic switching control BC3, a switching operation of alternately and periodically turning on and turning off the transistors MH and ML at the frequency fpwm is performed.

In the basic switching control BC3, the control signals SH and SL are PWM signals having the frequency fpwm. In the basic switching control BC3, a switching drive is performed on the transistors MH and ML at the frequency fpwm, and as a result, the switching voltage Vsw has the frequency fpwm. That is to say, in the basic switching control BC3, a switching frequency of the output stage MM is consistent with the frequency fpwm. In the basic switching control BC3, the output voltage Vout is stabilized at a target voltage Vtg by adjusting a length of a high level period of the control signal SH (that is, an on period of the transistor MH) in each cycle. The target voltage Vtg is determined by a ratio of the output voltage Vout to the feedback voltage Vfb and the reference voltage Vref, and is represented by “Vtg=(Vout/Vfb)×Vref”. The ratio of the output voltage Vout to the feedback voltage Vfb is equal to a voltage dividing ratio of the output voltage Vout of the feedback voltage generation circuit (R1 and R2).

An increase in the output current Iout causes a decrease in the output voltage Vout, and when viewing from the target voltage Vtg, the decrease in the output voltage Vout causes an increase in the error voltage Vcmp. A decrease in the output current Iout causes an increase in the output voltage Vout, and when viewing from the target voltage Vtg, the increase in the output voltage Vout causes a decrease in the error voltage Vcmp. The reset comparator 414 generates the signal RST based on the error voltage Vcmp and the slope voltage Vslp such that an on duty cycle is increased in response to the increase in the error voltage Vcmp, and the on duty cycle is decreased in response to the decrease in the error voltage Vcmp. The on duty cycle represents a ratio of a length of an on period of the transistor MH with respect to a sum of a length of an on period of the transistor MH and a length of an off period of the transistor MH.

In the basic switching control BC3, the logic circuit 416 can set an upper duty cycle limit for the on duty cycle, and generate the control signals (SH and SL) in a manner that the on duty cycle does not exceed the upper duty cycle limit. Thus, for example, assuming that the switching frequency is 1 MHz and the upper duty cycle limit is 95%, when no rising edge is generated in the signal RST after 0.95 ms has elapsed from a rising edge generated in the control signal SH, the logic circuit 416 can immediately generate a falling edge in the control signal SH and generate a rising edge in the control signal SL instead of depending on the signal RST.

### [Pulse Skip Control]

Next, a pulse skip control that can be executed by the switching control circuit SWC is described below. The switching control circuit SWC executes the pulse skip control when the signal SKP is at a high level. The pulse skip control is basically executed when the output current Iout is relatively small. Moreover, it can be understood that an execution entity of the pulse skip control is the logic circuit 416.

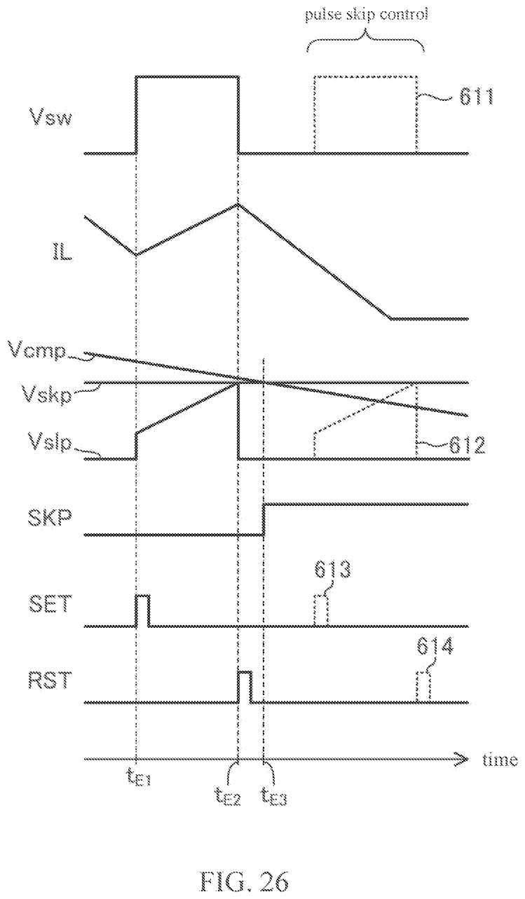

The pulse skip control is described with reference to FIG. 26. The basic switching control BC3 is continuously performed before a timing t_{E1}, and a rising edge is generated in the signal SET at the timing t_{E1}. Then, since “Vemp>Vskp” after a time from a timing t_{E2} to a timing t_{E3} has elapsed, the signal SKP is maintained at a low level. The transistor MH is turned on and the transistor ML is turned off by the logic circuit 416 and the driver 417 by using a rising edge of the signal SET at the timing t_{E1} as an opportunity, and accordingly the coil current IL gradually increases, and the slope voltage Vslp also gradually increases in conjunction. In addition, a rising edge is generated in the signal RST when the slope voltage Vslp not yet reached the error voltage Vcmp reaches the error voltage Vcmp at the timing t_{E2}. The transistor MH is turned off and the transistor ML is turned on by the logic circuit 416 and the driver 417 by using a rising edge of the signal RST at the timing t_{E2} as an opportunity.

In an operation example in FIG. 26, it is assumed that the error voltage Vcmp monotonically decreases from a timing before the timing t_{E1} to after the timing t_{E3} as the output current Iout decreases, and after the timing t_{E2}, the error voltage Vcmp is caused to be lower than the skip determination voltage Vskp by using the timing t_{E3} before a next rising edge generated in the signal SET as a boundary. As a result, a rising edge is generated in the signal SKP at the timing t_{E3}. The timing t_{E3} is a timing before the time of one PWM cycle has elapsed from the timing t_{E2}. The logic circuit 416 performs the pulse skip control during a high level period of the signal SKP.

In the pulse skip control, the switching drive of the output stage MM is stopped. More specifically, in the pulse skip control, a signal that masks the signal SET is issued in the logic circuit 416 based on the signal SKP at a high level, and accordingly, the signal SET is maintained at a low level in the logic circuit 416 regardless of the output signal of the circuit 415. Therefore, after the timing t_{E3}, the signal SKP is maintained at the high level and the signal SET is maintained at the low level, and thus the transistor MH is kept off. The slope voltage Vslp is fixed at 0 V if the transistor MH is kept off during a high level period of the signal SKP, and so the transistor ML is also kept off as the signal RST is also maintained at a low level. Thus, the transistors MH and ML are kept off during an execution period of the pulse skip control.

In FIG. 26, a dotted pulse 613 indicates a pulse of the masked signal SET, and a dotted pulse 614 indicates a pulse that would have been generated in the signal RST if the pulse skip control is not performed. Dotted waveforms 611 and 612 indicate waveforms of voltages that would have been included in the switching voltage Vsw and the slope voltage Vslp if the pulse skip control is not performed. Since switching loss can be reduced by performing the pulse skip control when the switching power supply device 1 is in a light load state (that is, the output current Iout is relatively small), improved efficiency for a light load can be achieved.

Moreover, the method for masking the signal SET in the logic circuit 416 when the signal SKP is at a high level is described. However, the output signal SET of the circuit 415 can also be fixed at a low level by stopping the operation of the setting signal generation circuit 415 when the signal SKP is at a high level.

[Recovery Operation from Pulse Skip Control]

A recovery operation from the pulse skip control is described below. After a start of the pulse skip control, when a falling edge is generated in the signal SKP as the output current Iout increases, the logic circuit 416 releases masking of the signal SET, and restarts the basic switching control BC3.

However, if an oscillation operation for generating the signal SET in the circuit 415 is asynchronous with the timing of a falling edge of the signal SKP, a gap from generation of a falling edge in the signal SKP to generation of a rising edge in the signal SET may be increased. This may cause an overly decrease in the output voltage Vout or an increase in the pulse of the output voltage Vout. Thus, it is desired that the circuit 415 performs an improved recovery operation, which is synchronous with a falling edge of the signal SKP and restarts the pulse generation operation of the signal SET. That is to say, the circuit 415 of the improved recovery operation is synchronous with a falling edge of the signal SKP and thus generates a rising edge in the signal SET, and then generates a rising edge in the signal SET at the frequency fpwm. The improved recovery operation is set to be performed in the circuit 415 in the description below.

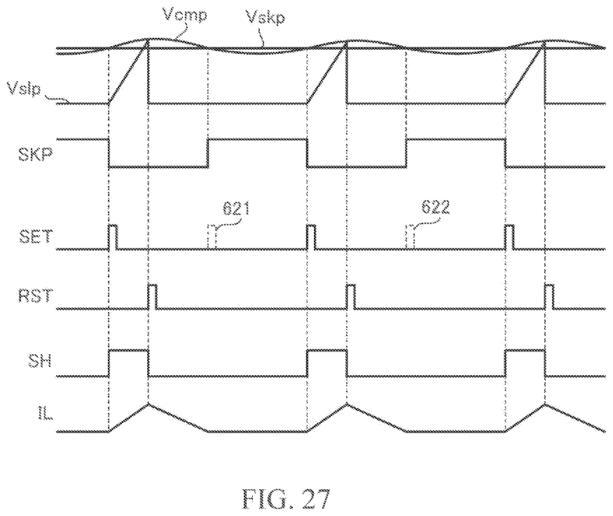

FIG. 27 shows a timing diagram when the basic switching control BC3 and the pulse skip control are alternately repeated due to the relatively small output current Iout. In the example in FIG. 27, a falling edge of the signal SKP, a recovery to the basic switching control BC3, a decrease in the error voltage Vcmp generated as the output voltage Vout increases, a rising edge of the signal SKP, an implementation of the pulse skip control (masking of the signal SET), an increase in the error voltage Vcmp generated as the output voltage Vout decreases, and a falling edge of the signal SKP are sequentially generated and repeated. In FIG. 27, dotted pulses 621 and 622 indicate pulses of the masked signal SET.

In the example in FIG. 27, the error voltage Vcmp is stabilized near the skip determination voltage Vskp. Moreover, when a slope of the slope voltage Vslp during a high level period of the control signal SH is fixed, a length of a high level period of the control signal SH generated according to each rising edge of the signal SET is substantially fixed. In view of the above, in the example in FIG. 27, it may be said that a control substantially equivalent to a constant on-time control is performed.

Moreover, a generation interval of a rising edge of the signal SET in the constant on-time control depends on the output current Iout. Specifically, the generation interval of a rising edge of the signal SET gets shorter as the output current Iout increases. Then, when the generation interval of a rising edge of the signal SET decreases to a predetermined interval, the signal SET is no longer masked and a transfer is made to the basic switching control BC3.

### [Characteristics of Skip Determination Voltage]

Characteristics of the skip determination voltage Vskp are described below. The circuit 420 changes the skip determination voltage Vskp according to a target temperature TT. Herein, the target temperature TT is a temperature of the power supply control device 410. More specifically, the target temperature TT is a temperature of a target position in the power supply control device 410. The target position is a predetermined position. The target position can be determined to have the target temperature TT become a temperature close to a temperature (more particularly a junction temperature of the transistor MH) of the output stage MM. The target temperature TT also increases or decreases in conjunction at least as the temperature of the output stage MM (more particularly a junction temperature of the transistor MH) increases or decreases. The circuit 420 includes an element (such as a bipolar transistor and a resistor) having a physical quantity of which a value changes in conjunction with a change in the target temperature TT. The circuit 420 changes the skip determination voltage Vskp according to the target temperature TT by generating the skip determination voltage Vskp by using the element.

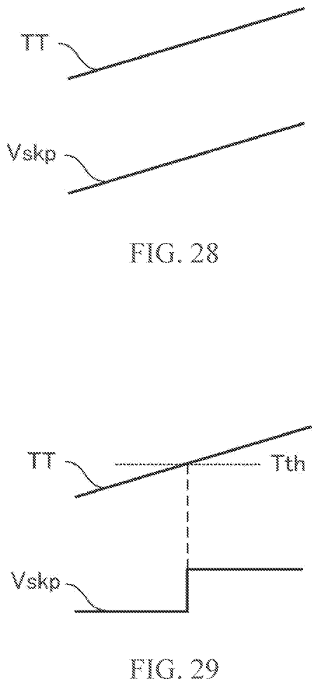

As shown in FIG. 28, the circuit 420 causes the skip determination voltage Vskp to rise continuously as the target temperature TT increases. For example, the circuit 420 can generate the skip determination voltage Vskp to have “Vskp=Vskp_ref+k_{A}·(TT−Tref)” hold true. Herein, k_{A} is a coefficient having a positive predetermined value. Tref represents a predetermined temperature (for example, 25° C.). At this point in time, when “TT=Tref”, the skip determination voltage Vskp becomes consistent with a reference voltage Vskp_ref. The voltage Vskp_ref can be a predetermined fixed voltage, or can be a voltage corresponding to the output voltage Vout.

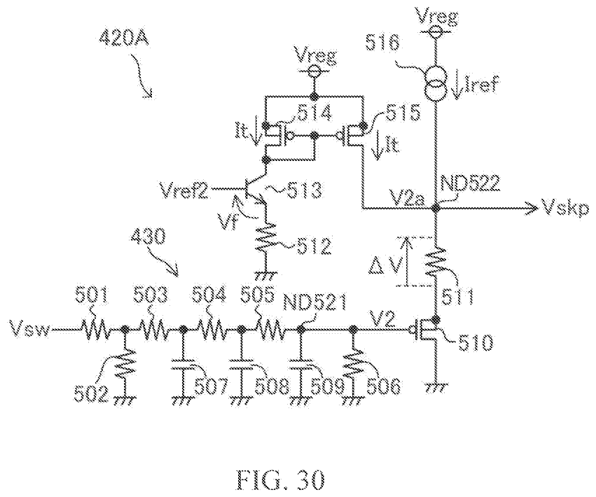

As shown in FIG. 29, the circuit 420 can cause the skip determination voltage Vskp to rise stepwise as the target temperature TT increases. For example, the circuit 420 can cause the skip determination voltage Vskp to have a first voltage value when the target temperature TT is below a predetermined threshold temperature Tth, and to have a second voltage value greater than the first voltage value when the target temperature TT exceeds the threshold temperature Tth. In FIG. 29, the skip determination voltage Vskp changes in two steps according to the target temperature TT, but can also change in three or more steps.

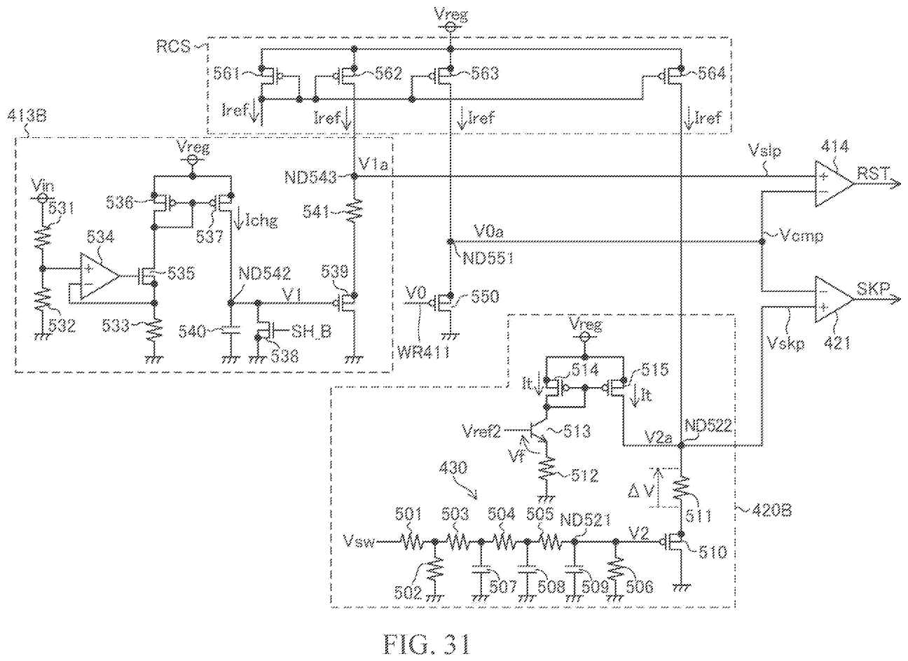

FIG. 30 shows a configuration in which a skip determination voltage generation circuit 420A can be used as the circuit 420 in FIG. 24. If the circuit 420A is used, the skip determination voltage Vskp becomes a voltage corresponding to the output voltage Vout, and continuously rises as the target temperature TT increases.

The circuit 420A in FIG. 30 includes resistors 501 to 506, 511 and 512, capacitors 507 to 509, transistors 510 and 513 to 515, and a current source 516. The transistors 510, 514 and 515 are P-channel MOSFETs, and the transistor 513 is a negative-positive-negative NPN bipolar transistor.

A first end of the resistor 501 is connected to the switch terminal SW and thus receives the switching voltage Vsw. A second end of the resistor 501 is grounded via the resistor 502. A divided voltage of the switching voltage Vsw is generated at a connection node between the resistors 501 and 502. A smoothing circuit 430 is formed by the resistors 503 to 505 and the capacitors 507 to 509. The smoothing circuit 430 smooths (in other words, averages) the voltage at the connection node between the resistors 501 and 502. The smoothing circuit 430 is a multi-stage low-pass filter (LPF) having a resistance-capacitance (RC) low-pass filter with multiple stages of resistors and capacitors. The number of stages of the RC low-pass filter disposed in the smoothing circuit 430 is not limited to the example shown in FIG. 30 but can be any as desired.

In the configuration example in FIG. 30, a first end of the resistor 503 is connected to the connection node between the resistors 501 and 502, and a second end of the resistor 503 is connected to a first end of the resistor 504 and is grounded via the capacitor 507. A second end of the resistor 504 is connected to a first end of the resistor 505 and is grounded via the capacitor 508. A second end of the resistor 505 is connected to a node ND521. The node ND521 is grounded via a parallel circuit of the capacitor 509 and the resistor 506. Moreover, the node ND521 is connected to a gate of the transistor 510. A voltage V2 at the node ND521 is a voltage obtained by dividing and smoothing (in other words, averaging) the switching voltage Vsw, and is proportional to the output voltage Vout. A source of the transistor 510 is connected to a node ND522 via the resistor 511. A drain of the transistor 510 is grounded.

A current generation circuit that generates a current It corresponding to the target temperature TT is formed by the resistor 512 and the transistors 513 to 515. More specifically, an emitter of the transistor 513 is grounded via the resistor 512. A reference voltage Vref2 is applied to a base of the transistor 513. The reference voltage Vref2 has a fixed predetermined positive DC voltage value. The reference voltage Vref2 can be the same as or different from the reference voltage Vref. The reference voltage Vref2 can be generated by such as a bandgap reference. The reference voltage Vref2 can change slightly in conjunction as the target temperature TT changes; however, the change in the reference voltage Vref2 herein is sufficiently small and can be omitted.

A collector of the transistor 513 is commonly connected to a drain and a gate of the transistor 514 and a gate of the transistor 515. An internal power supply voltage Vreg is supplied to each of sources of the transistors 514 and 515. The internal power supply voltage Vreg has a positive DC voltage value. A drain of the transistor 515 is connected to the node ND522.

A voltage Vf is used to represent a base-emitter voltage (a base potential viewing from an emitter potential) of the transistor 513. With a current mirror circuit formed by the transistors 514 and 515, the current It having a same current value as the current It flowing between the drain and the source of the transistor 514 serves as a drain current of the transistor 515 flowing between the drain and the source of the transistor 515. The drain current It of the transistor 515 flows to the ground portion through the resistor 511 and the transistor 510. A current source 516 is disposed between an application end of the internal power supply voltage Vreg and the node ND522, and supplies a constant reference current Iref from the application end of the internal power supply voltage Vreg to the node ND522.

A voltage V2a at the node ND522 is greater than the voltage V2 at the node ND521 by a sum of the gate-source voltage of the transistor 510 and a voltage drop generated in the resistor 511. The circuit 420A in FIG. 30 outputs the voltage V2a serving as the skip determination voltage Vskp. The voltage drop generated in the resistor 511 is referred to as a voltage ΔV. If resistance values of the resistors 511 and 512 are respectively represented by R511 and R512, then “It=(Vref2−Vf)/R512” and so the voltage ΔV is represented by an equation below.

$$\begin{matrix}Δ V = It \times R 511 + Iref \times R 511 \\ = ( Vref 2 - Vf ) \times ( R 511 / R 512 ) + Iref \times R 511\end{matrix}$$

A temperature of the circuit 420A (temperatures of elements forming the circuit 420A) is equal to or substantially equal to the target temperature TT, and thus the voltage Vf decreases as the target temperature TT increases. Thus, the voltage ΔV increases as the target temperature TT increases, and as a result, the skip determination voltage Vskp increases as the target temperature TT increases.

With the resistors 511 and 512 formed by the same type of resistors, temperature characteristics of the resistor 511 can be the same as temperature characteristics of the resistor 512. In this case, a temperature dependency of a ratio (R511/R512) is completely or substantially non-existent. However, the resistor 511 can also have a positive temperature characteristic, and the resistor 512 can have a negative temperature characteristic. In this case, since the ratio (R511/R512) has a positive temperature characteristic, compared to the situation where the ratio (R511/R512) is not temperature dependent, an increasing slope of the skip determination voltage Vskp also increases as the target temperature TT increases.

In this embodiment, since the skip determination voltage Vskp increases as the target temperature TT increases, the pulse skip control can be more easily performed as the target temperature TT gets greater. Compared to when the pulse skip control is not performed, the switching frequency of the output stage MM decreases during execution of the pulse skip control, and so the switching loss is decreased. The decrease in the switching loss suppresses or decreases an increase in the target temperature TT. That is to say, with the skip determination voltage Vskp that increases as the target temperature TT increases, an increase of the target temperature TT is suppressed or decreased. The pulse skip control originally aims at reducing the switching loss for a light load; however, with such control, an overly increase in the target temperature TT can also be suppressed.

The configuration of this embodiment helps miniaturization of the coil L1. Specific examples are enumerated below. In a first reference configuration, an inductance value of the coil L1 is 22 μH, and the frequency fpwm is 1 MHz. Moreover, in the first reference configuration, the skip determination voltage Vskp is not dependent on the target temperature TT and thus does not change. In addition, in the first reference configuration, when the signal SKP is maintained at a low level and a switching drive below 1 MHz continues, a junction temperature of the transistor MH or ML exceeds a predetermined upper temperature limit (for example, 150° C.). From the perspective of protecting the transistor MH or ML, the junction temperature of the transistor MH or ML is not allowed to exceed the predetermined upper temperature limit.

Thus, the first reference configuration needs to be modified into a second reference configuration. By using the first reference configuration as a reference, in the second reference configuration, the frequency fpwm is reduced from 1 MHz to 500 kHz, and the inductance value of the coil L1 is increased from 22 pH to 100 pH as the frequency fpwm reduces. Viewing from the first reference configuration, switching loss is decreased by reducing the frequency fpwm in the second reference configuration. Thus, even if the signal SKP is maintained at a low level and the switching drive is continued at 500 kHz, the junction temperature of the transistor MH or ML is converged to be lower than the predetermined upper temperature limit. However, the coil L1 of the second reference configuration is increased in size compared to the first reference configuration.

If the configuration of this embodiment is used, when the target temperature TT increases to a level that the junction temperature of the transistor MH or ML is close to the predetermined upper temperature limit, the pulse skip control can be easily performed, or the pulse skip control is inevitably performed by sufficiently increasing the skip determination voltage Vskp. Thus, in the configuration shown in this embodiment, the inductance value of the coil L1 can be set to 22 μH and the frequency fpwm can be set to 1 MHz. In the configuration of this embodiment, when the signal SKP is maintained at a low level and the switching drive is continued at 1 MHz, the junction temperature of the transistor MH or ML gradually increases to the predetermined upper temperature limit. At this point in time, for example, a situation such as shown in FIG. 27 takes place (a situation in which a constant on-time control is substantially performed by the pulse skip control). As a result, for example, with the pulse skip control, the switching frequency is decreased from 1 MHz to 500 kHz, and as the second reference configuration, the junction temperature of the transistor MH or ML is converged to be lower than the predetermined upper temperature limit.

### Embodiment EX3_2

The embodiment EX3_2 is described below. The embodiment EX3_2 as well as embodiments EX3_3 and EX3_4 described below are embodiments based on the embodiment EX3_1. Provided that there are no contradictions, for the matters not particularly described in the embodiment EX3_2, the details of the embodiment EX3_1 are also applicable to the embodiment EX3_2 (the same applies to the embodiments EX3_3 and EX3_4 below).

FIG. 31 is a partial circuit diagram of the power supply control device 410 of the embodiment EX3_2. In the power supply control device 410 of the embodiment EX3_2, a slope voltage generation circuit 413B, a skip determination voltage generation circuit 420B, a reference current source RSC and a transistor 550 are provided. In the embodiment EX3_2, the circuits 413B and 420B are respectively used as the slope voltage generation circuit 413 and the skip determination voltage generation circuit 420 in FIG. 24. In the embodiment EX3_2, a voltage obtained from level shifting the voltage in the wiring WR411 functions as the error voltage Vcmp. The circuit 420B has a same configuration as the circuit 420A in FIG. 30, and thus associated details of the circuit 420B are omitted. However, in the configuration in FIG. 31, a reference current source RCS supplies a reference current Iref to the node ND522. It can be understood that a transistor 564 in FIG. 31 is equivalent to the current source 516 in FIG. 30.

A configuration of the circuit 413B is described below. The circuit 413B includes resistors 531 to 533 and 541, an operational amplifier 534, transistors 535 to 539, and a capacitor 540. The transistors 535 and 538 are N-channel MOSFETs, and the transistors 536, 537 and 539 are P-channel MOSFETs.

One end of the resistor 531 is connected to an application end of the input voltage Vin, and the other end of the resistor 531 is grounded via the resistor 532. A connection node between the resistors 531 and 532 is connected to a non-inverting input terminal of the operational amplifier 534. An inverting input terminal of the operational amplifier 534 is connected to a source of the transistor 535, and is grounded via the resistor 533. An output terminal of the operational amplifier 534 is connected to a gate of the transistor 535. A drain of the transistor 535 is commonly connected to a drain and a gate of the transistor 536 and a gate of the transistor 537. An internal power supply voltage Vreg is supplied to each of sources of the transistors 536 and 537. A drain of the transistor 537 is connected to a node ND542. The node ND542 is grounded via the capacitor 540. Moreover, the node ND542 is commonly connected to a drain of the transistor 538 and a gate of the transistor 539. A source of the transistor 538 and a drain of the transistor 539 are grounded. A source of the transistor 539 is connected to a node ND543 via the resistor 541. A voltage at the node ND542 is referred to as a voltage V1, and a voltage at the node ND543 is referred to as a voltage V1a.

A configuration of the reference current source RCS is described below. The reference current source RCS includes transistors 561 to 564. The transistor 561 to 564 are P-channel MOSFETs. An internal power supply voltage Vreg is supplied to each of sources of the transistors 561 to 564. A drain and a gate of the transistor 561 are commonly connected to respective gates of the transistors 562 to 564. A drain of the transistor 562 is connected to the node ND543. A drain of the transistor 563 is connected to a node ND551. A drain of the transistor 564 is connected to the node ND522.

The transistor 550 is a P-channel MOSFET. A gate of the transistor 550 is connected to the wiring WR411 (referring to FIG. 24). A drain of the transistor 550 is grounded. A source of the transistor 550 is connected to the node ND551. A voltage at the wiring WR411 is referred to as a voltage V0, and a voltage at the node ND551 is referred to as a voltage V0a.

Operation details of the circuits shown in FIG. 31 are described below. By connecting the drain of the transistor 561 to a circuit (not shown) introducing the reference current Iref, the reference current Iref flows as a drain current of the transistor 561. A current mirror circuit is formed by the transistors 561 to 564. Thus, the reference current Iref flows between the drain and the source of each of the transistors 562 to 564. That is to say, the reference current Iref flows from the transistor 562 to the node ND543, the reference current Iref flows from the transistor 563 to the node ND551, and the reference current Iref flows from the transistor 564 to the node ND522.

A divided voltage of the input voltage Vin is generated at a connection node between the resistors 531 and 532. The operational amplifier 534 controls a gate potential of the transistor 535 in a manner that a voltage at the connection node between the resistors 531 and 532 is equal to a voltage drop generated in the resistor 533. Thus, a drain current corresponding to the voltage at the connection node between the resistors 531 and 532 flows to the transistor 536. Since the transistors 536 and 537 form a current mirror circuit, a current Ichg proportional to the drain current of the transistor 536 is generated in the transistor 537. The current Ichg serving as the drain current of the transistor 537 flows from the application end of the internal power supply voltage Vreg to the node ND542.

A signal SH_B is supplied to a gate of the transistor 538. The signal SH_B is an inverted signal of the control signal SH. Thus, during a low level period of the control signal SH, the transistor 538 becomes an on state by having the signal SH_B be at a high level. When the transistor 538 is in an on state, the node ND542 is shorted with the ground portion via a channel of the transistor 538, and so the voltage V1 is substantially 0 V. Thus, during a high level period of the control signal SH, the transistor 538 becomes an off state by having the signal SH_B be at a low level. When the transistor 538 is in an off state, the capacitor 540 is charged by the current Ichg and the voltage V1 increases gradually.

The reference current Iref supplied through the transistor 562 and the resistor 541 flows through a channel of the transistor 539. Thus, the voltage V1a at the node ND543 is greater than the voltage V1 by a sum voltage of the gate-source voltage of the transistor 539 and a voltage drop generated in the resistor 541. That is to say, a voltage obtained by level shifting the voltage V1 upward by the sum voltage is generated at node ND543 as the voltage V1a.

On the other hand, the reference current Iref supplied through the transistor 563 flows through a channel of the transistor 550. Thus, the voltage V0a at the node ND551 is greater than the voltage V0 by a gate-source voltage of the transistor 550. That is to say, a voltage obtained by level shifting the gate-source voltage of the transistor 550 upward is generated at the node ND551 as the voltage V0a.

In the embodiment EX3_2, by connecting the node ND543 to a non-inverting input terminal of the reset comparator 414, the voltage V1a functions as the slope voltage Vslp. In the embodiment EX3_2, by connecting the node ND551 to each of the inverting input terminals of the reset comparator 414 and the skip comparator 421, the voltage V0a functions as the error voltage Vcmp. In the embodiment EX3_2, by connecting the node ND522 to a non-inverting input terminal of the skip comparator 421, the voltage V2a functions as the skip determination voltage Vskp.

Thus, the reset comparator 414 of the embodiment EX3_2 outputs the signal RST at a high level when “V1a>V0a” holds true, outputs the signal RST at a low level when “V1a<V0a” holds true, and outputs the signal RST at a high level or at a low level when “V1a=V0a” holds true. Thus, the skip comparator 421 of the embodiment EX3_2 outputs the signal SKP at a high level when “V2a>V0a” holds true, outputs the signal SKP at a low level when “V2a<V0a” holds true, and outputs the signal SKP at a high level or at a low level when “V2a=V0a” holds true. Moreover, characteristics of the circuit elements are determined in a manner that the signal RST becomes a low level during a low level period of the control signal SH (that is, in a manner that “V1a<V0a” during a low level period of the control signal SH).

In the power supply control device 410, an error voltage generation circuit that generates the error voltage Vcmp based on the feedback voltage Vfb and the reference voltage Vref is provided. In the embodiment EX3_1, the error amplifier 411 itself is equivalent to an error voltage generation circuit. In the embodiment EX3_2, it can be understood that an error voltage generation circuit is formed by the error amplifier 411 and the transistor 550. Alternatively, in the embodiment EX3_2, it can be considered that the voltage V0 in the wiring WR411 is an error voltage, and the voltage V0a is a level-shifted error voltage.

In all cases, with the circuit 420B, the skip determination voltage Vskp is caused to increase as the target temperature TT increases. Thus, the effects and functions described in the embodiment EX3_1 are achieved.

### Embodiment EX3_3

The embodiment EX3_3 is described below. In the embodiments EX3_1 and EX3_2, a configuration in which the error voltage increases when “Vfb<Vref” and the error voltage decreases when “Vfb>Vref” is used. However, a direction of change in the error voltage can also be designed to be opposite to the direction shown in the embodiments EX3_1 and EX3_2. However, in this case, a direction of change in the slope voltage Vslp is opposite to that of the embodiments EX3_1 and EX3_2, and a direction of change in the skip determination voltage Vskp that is accompanied with the increases in the target temperature TT is also opposite to that of the embodiments EX3_1 and EX3_2.

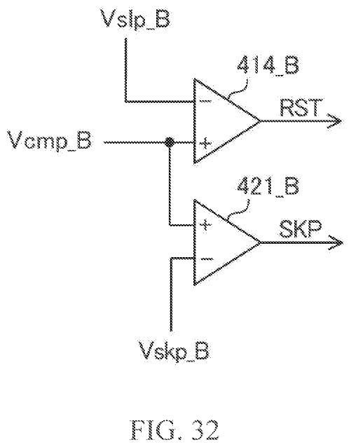

That is to say, the configuration shown in FIG. 32 can be used in the power supply control device 410. FIG. 32 is a diagram of a partial configuration of the power supply control device 410 of the embodiment EX3_3. The power supply control device 410 of the embodiment EX3_3 includes a reset comparator 414_B as the reset comparator 414, and includes a skip comparator 421_B as the skip comparator 421.

In the power supply control device 410 of the embodiment EX3_3, a slope voltage Vslp_B is generated by the slope voltage generation circuit 413, a skip determination voltage Vskp_B is generated by the skip determination voltage generation circuit 420, and an error voltage Vcmp_B is generated by an error voltage generation circuit including the error amplifier 411. For example, the error voltage generation circuit can be formed by the error amplifier 411 and a level shifter (not shown) that generates the error voltage Vcmp_B from the error voltage Vcmp. Herein, equations (3) to (5) below hold true. Vslp, Vskp and Vcmp on the right of equations (3) to (5) are the voltages Vslp, Vskp and Vcmp described in the embodiment EX3_1 or EX3_2. Vcc on the right of equations (3) to (5) is a positive DC voltage. The voltage Vcc can be the input voltage Vin itself, or can be an internal power supply voltage generated in the power supply control device 410.

$$Vslp\_B = Vcc - Vslp \qquad ( 3 )$$

$$Vskp\_B = Vcc - Vskp \qquad ( 4 )$$

$$Vcmp\_B = Vcc - Vcmp \qquad ( 5 )$$

Thus, the slope voltage Vslp_B of the embodiment EX3_3 monotonically decreases during an on period of the transistor MH. The skip determination voltage Vskp_B of the embodiment EX3_3 lowers continuously or stepwise as the target temperature TT increases. The error voltage Vcmp_B of the embodiment EX3_3 decreases when “Vfb<Vref” and increases when “Vfb>Vref”.

In the reset comparator 414_B, the slope voltage Vslp_B is input to an inverting input terminal, and the error voltage Vcmp_B is input to a non-inverting input terminal. The reset comparator 414_B compares the voltages Vslp_B and Vcmp_B, outputs the signal RST at a low level when “Vslp_B>Vcmp_B” holds true, outputs the signal RST at a high level when “Vslp_B<Vcmp_B” holds true, and outputs the signal RST at a low level or a high level when “Vslp_B=Vcmp_B” holds true.

In the skip comparator 421_B, the skip determination voltage Vskp_B is input to an inverting input terminal, and the error voltage Vcmp_B is input to a non-inverting input terminal. The skip comparator 421_B compares the voltages Vskp_B and Vcmp_B, outputs the signal SKP at a low level when “Vskp_B>Vcmp_B” holds true, outputs the signal SKP at a high level when “Vskp_B<Vcmp_B” holds true, and outputs the signal SKP at a low level or a high level when “Vskp_B=Vcmp_B” holds true.

In the embodiment EX3_3, the signal RST output from the reset comparator 414_B and the signal SKP output from the skip comparator 421_B are supplied to the logic circuit 416. Operation details that are not specifically described in the embodiment EX3_3 are the same as those recited in the embodiment EX3_1 or EX3_2.

A direction of change in a voltage includes a first direction, and a second direction opposite to the first direction. Either of the first direction and the second direction is an upward direction and the other is a downward direction. The directions of changes in the error voltage, the slope voltage and the skip determination voltage of the embodiment EX3_1 or EX3_2 are respectively reversed from those of the embodiment EX3_3.

### Embodiment EX3_4

The embodiment EX3_4 is described below. In the embodiment EX3_4, supplement items and variation techniques of the matters are described.

The power supply control device 410 in FIG. 24 includes a control drive circuit. The control drive circuit performs the switching drive of the output stage MM according to the error voltage Vcmp (more specifically, according to the error voltage Vcmp and the slope voltage Vslp) when the signal SKP is at a low level. The control drive circuit of the configuration in FIG. 24 includes the reset comparator 414, the setting signal generation circuit 415, the logic circuit 416 and the driver 417 as constituting elements. However, a concept of including the slope voltage generation circuit 413 as a constituting element of the control drive circuit can also be adopted.

The switching power supply device 1 is a step-down switching power supply device; however, a switching power supply device applying the techniques of the present disclosure can also be a step-up switching power supply device. The step-up switching power supply device generates the output voltage Vout greater than the input voltage Vin by stepping up the input voltage Vin. When the switching power supply device 1 is a step-up switching power supply device, as shown in FIG. 15, a first end of the coil L1 is connected to an application end of the input voltage Vin (a terminal applied with the input voltage Vin), a second end of the coil L1 is connected to the drain of the transistor MH and the source of the transistor ML, the source of the transistor MH is grounded, and the drain of the transistor ML is connected to the output terminal OUT and is grounded via the capacitor C1. In the configuration in FIG. 15, the transistor ML serving as a rectifier can also be replaced by a synchronous rectifier diode having an anode connected to the drain of the transistor MH and a cathode connected to the output terminal OUT. In all cases, by switching the output element (MH) between on and off during the switching drive of the output stage MM, the output voltage Vout is generated based on the current (IL) flowing to the coil L1.

### <<Note 3>>

Note 3 is attached to the present disclosure to show specific configuration examples of the embodiments above (more particularly the embodiments EX3_1 to EX3_4).

A power supply control device according to an aspect of the present disclosure is configured as (a twentieth configuration), a power supply control device (410) configured to control an output stage (MM) of a switching power supply device (1) that generates an output voltage (Vout) from an input voltage (Vin), the power supply control device comprising:
an error voltage generation circuit (411), configured to generate an error voltage (Vcmp) according to a difference between a feedback voltage (Vfb) corresponding to the output voltage and a predetermined reference voltage (Vref);
a skip determination voltage generation circuit (420), configured to generate a skip determination voltage (Vskp);
a skip signal generation circuit (421), configured to generate a skip signal (SKP) having a first logical value or a second logical value based on the error voltage and the skip determination voltage; and
a control drive circuit (414 to 417), configured to perform a switching drive of the output stage according to the error voltage when the skip signal has the first logical value, while stop the switching drive of the output stage when the skip signal has the second logical value, wherein
the output voltage is generated from the input voltage through the switching drive of the output stage, and the skip determination voltage generation circuit changes the skip determination voltage according to a temperature of the power supply control device.

Thus, for example, it is made easier for the skip signal to have the second logical value in a relationship with the error voltage as the temperature of the power supply control device increases. The switching drive is stopped based on the skip signal having the second logical value and switching loss is decreased, and as a result, an overly rise in the temperature of the power supply control device can be suppressed. This facilitates miniaturization of a coil used in a switching control device.

The power supply control device of the twentieth configuration can also be configured as (a twenty-first configuration), wherein
the feedback voltage increases or decreases as the output voltage increases or decreases,
the error voltage generation circuit is configured to change the error voltage in a first direction when the feedback voltage is lower than the reference voltage, while change the error voltage in a second direction opposite to the first direction when the feedback voltage is greater than the reference voltage,
the skip signal generation circuit is configured to generate the skip signal based on a level relationship between the error voltage and the skip determination voltage, wherein
the skip signal generation circuit generates the skip signal having the first logical value when the skip determination voltage is different from the error voltage in the second direction, while generates the skip signal having the second logical value when the skip determination voltage is different from the error voltage in the first direction, and
the skip signal generation circuit changes the skip determination voltage in the first direction as the temperature increases.

The power supply control device of the twenty-first configuration can also be configured as (a twenty-second configuration), wherein the skip signal generation circuit changes the skip determination voltage continuously or stepwise in the first direction as the temperature increases.

The power supply control device of the twenty-first or twenty-second configuration can also be configured as (a twenty-third configuration), wherein
the first direction is an upward direction, and the second direction is a downward direction, and
the skip signal generation circuit is configured to generate the skip signal having the first logical value when the skip determination voltage is lower than the error voltage, while generate the skip signal having the second logical value when the skip determination voltage is greater than the error voltage.

The power supply control device of the twenty-first or twenty-second configuration can also be configured as (a twenty-fourth configuration), wherein
the first direction is a downward direction, and the second direction is an upward direction, and
the skip signal generation circuit is configured to generate the skip signal having the first logical value when the skip determination voltage is greater than the error voltage, while generate the skip signal having the second logical value when the skip determination voltage is lower than the error voltage.

The power supply control device of any one of the twentieth to twenty-fourth configurations can also be configured as (a twenty-fifth configuration), wherein
the output stage includes an output element (MH) comprising a switching element, and a rectifier (ML) connected to the output element,
a coil (L1) is connected to a connection node between the output element and the rectifier,
the output voltage is generated based on the current flowing through the coil by switching the output element between on and off during the switching drive of the output stage,
the power supply control device further includes a slope voltage generation circuit (413) configured to generate a slope voltage (Vslp) according to a current information of the coil, and
the control drive circuit performs the switching drive of the output stage according to the error voltage and the slope voltage when the skip signal has the first logical value.

### <<Note 4>>

A note (Note 4) commonly applicable to various items is provided below.

For an arbitrary signal or voltage, a relationship between a high level and a low level thereof may be opposite to the relationship described, provided that the form of the subject matter is not compromised.

The types of the channels of the field-effect transistors (FET) shown in the embodiments are examples. Without compromising the form of the subject matter, the type of channels of the FETs may be changed between the P-type channel and the N-type channel.

Given that no anomalies are incurred, any transistor may also be any type of transistor. For example, given that no anomalies are incurred, an arbitrary transistor implemented by a MOSFET may be replaced by a junction FET, an insulated gate bipolar transistor (IGBT) or a bipolar transistor. Any transistor includes a first electrode, a second electrode and a control electrode. In an FET, one of the first and second electrodes is the drain and the other is the source, and the control electrode is the gate. In an IGBT, one of the first and second electrodes is the collector and the other is the emitter, and the control electrode is the gate. For a bipolar transistor that is not an IGBT, one of the first and second electrodes is the collector and the other is the emitter, and the control electrode is the base.

Various modifications may be appropriately made to the embodiments of the present disclosure within the scope of the technical concept of the claims. The embodiments above are only examples of possible implementations of the present disclosure, and the meanings of the terms of the constituents of the present disclosure are not limited to the meanings of the terms recited in the embodiments above. The specific numerical values used in the description above are only examples, and these numerical values may of course be modified to various other numerical values.

1. A power supply control device, configured to control an output stage of a switching power supply device that generates an output voltage from an input voltage, the power supply control device comprising:
a switching control circuit, configured to switch and drive the output stage based on a feedback voltage corresponding to the output voltage, wherein the output voltage is generated from the input voltage through a switching drive of the output stage, wherein the switching control circuit includes:
a threshold setting circuit, configured to set an overcurrent threshold; and
an overcurrent protection circuit, configured to
output an overcurrent protection signal when a value of a current flowing through the output stage exceeds the overcurrent threshold, and
perform an overcurrent protection operation that limits an increase in the current flowing through the output stage exceeding the overcurrent threshold in response to an output of the overcurrent protection signal, wherein
the threshold setting circuit sets the overcurrent threshold according to an elapsed time from a start of the switching drive of the output stage.

2. The power supply control device of claim 1, wherein the threshold setting circuit is configured to
set the overcurrent threshold to a first threshold or a second threshold lower than the first threshold, and
switch the overcurrent threshold from the first threshold to the second threshold as the elapsed time increases.

3. The power supply control device of claim 2, wherein
the switching control circuit is configured to switch and drive the output stage so as to reduce an error between the feedback voltage and a comparison voltage,
the switching control circuit, after the start of the switching drive of the output stage,
uses a soft-start voltage that gradually increases from an initial voltage lower than a predetermined reference voltage as the comparison voltage, and
uses the reference voltage as the comparison voltage after the soft-start voltage exceeds the reference voltage, and
the threshold setting circuit switches the overcurrent threshold from the first threshold to the second threshold according to the soft-start voltage that depends on the elapsed time.

4. The power supply control device of claim 3, wherein the threshold setting circuit is configured to switch the overcurrent threshold from the first threshold to the second threshold when the soft-start voltage reaches a predetermined voltage higher than the reference voltage.

5. The power supply control device of claim 1, wherein as the elapsed time increases and after the overcurrent threshold is continuously lowered from a first threshold to a second threshold lower than the first threshold, the threshold setting circuit is configured to set the overcurrent threshold as the second threshold.

6. The power supply control device of claim 5, wherein
the switching control circuit is configured to switch and drive the output stage so as to reduce an error between the feedback voltage and a comparison voltage,
the switching control circuit, after the start of the switching drive of the output stage,
uses a soft-start voltage that gradually increases from an initial voltage lower than a predetermined reference voltage as the comparison voltage, and
uses the reference voltage as the comparison voltage after the soft-start voltage exceeds the reference voltage, and
after the overcurrent threshold is continuously lowered from the first threshold to the second threshold according to the soft-start voltage that depends on the elapsed time, the threshold setting circuit sets the overcurrent threshold as the second threshold.

7. The power supply control device of claim 6, wherein
the switching control circuit, after the start of the switching drive of the output stage, gradually increases the soft-start voltage to a predetermined upper limit voltage higher than the initial voltage, and
the threshold setting circuit is configured to
continuously lower the overcurrent threshold from the first threshold to the second threshold according to the soft-start voltage during a rising period of the soft-start voltage, and
set the overcurrent threshold to the second threshold after the soft-start voltage reaches the upper limit voltage.

8. The power supply control device of claim 1, wherein the switching drive of the output stage begins with supplying the input voltage to the power supply control device.

9. The power supply control device of claim 1, comprising an enable terminal, configured to receive an enable signal, wherein the switching drive of the output stage begins when a level of the enable signal changes from a first level to a second level while the input voltage is supplying to the power supply control device.

10. The power supply control device of claim 1, wherein
the output stage includes:
an output element comprising a switching element; and
a rectifier connected to the output element,
a coil is connected to a connection node between the output element and the rectifier, and
the output voltage is generated based on the current flowing through the coil by switching the output element between on and off during the switching drive of the output stage.

11. A power supply control device, configured to control an output stage of a switching power supply device that generates an output voltage from an input voltage, the power supply control device comprising:
an error voltage generation circuit, configured to generate an error voltage according to a difference between a feedback voltage corresponding to the output voltage and a predetermined reference voltage;
a control drive circuit, configured to perform a switching drive of the output stage based on the feedback voltage;
an overcurrent protection circuit, configured to output an overcurrent protection signal when the value of a current flowing through the output stage exceeds a predetermined overcurrent threshold; and
an error voltage change suppression circuit, wherein
the output voltage is generated from the input voltage through the switching drive of the output stage,
the control drive circuit, in response to the overcurrent protection signal, performs an overcurrent protection operation that limits an increase in the current flowing through the output stage exceeding the overcurrent threshold, and
the error voltage change suppression circuit is configured to suppress change in the error voltage based on the overcurrent protection signal.

12. The power supply control device of claim 11, wherein
the feedback voltage increases or decreases as the output voltage increases or decreases,
the error voltage generation circuit is configured to generate the error voltage in an error output wiring by outputting a current signal corresponding to the difference, to the error output wiring in a manner that
the error voltage changes in a first direction when the feedback voltage is lower than the reference voltage, and
the error voltage changes in a second direction opposite to the first direction when the feedback voltage is higher than the reference voltage, and
the error voltage change suppression circuit is configured to suppress the change in the error voltage in the first direction based on the overcurrent protection signal.

13. The power supply control device of claim 12, wherein
in a state when the feedback voltage becomes lower than the reference voltage through execution of the overcurrent protection operation in response to the overcurrent protection signal,
the error voltage generation circuit is configured to output the current signal for changing the error voltage in the first direction to the error output wiring, and
the error voltage change suppression circuit is configured to suppress change in the error voltage in the first direction by changing the error voltage in the second direction based on the overcurrent protection signal.

14. The power supply control device of claim 12, wherein
a phase compensation circuit is disposed between the error output wiring and a potential point having a predetermined potential and configured to compensate for a phase of the error voltage,
the phase compensation circuit includes:
a phase compensation resistor connected to the error output wiring; and
a phase compensation capacitor connected between the phase compensation resistor and the potential point, and
the error voltage change suppression circuit is configured to suppress change in the error voltage in the first direction by discharging accumulated charges of the phase compensation capacitor based on the overcurrent protection signal.

15. The power supply control device of claim 14, wherein
the error voltage change suppression circuit includes a discharge switch connected in parallel to the phase compensation capacitor, and
the accumulated charges in the phase compensation capacitor are discharged by turning on the discharge switch based on the overcurrent protection signal.

16. The power supply control device of claim 15, wherein
the overcurrent protection circuit is configured to output the overcurrent protection signal for a predetermined period of time when a value of the current flowing through the output stage exceeds the overcurrent threshold, and
the error voltage change suppression circuit is configured to turn on the discharge switch during an output period of the overcurrent protection signal.

17. The power supply control device of claim 15, wherein
during the switching drive of the output stage, a state of the output stage is switched between a first state in which the current flowing through the output stage is increased and a second state in which the current flowing in the output stage is decreased,
the overcurrent protection circuit is configured to
start outputting the overcurrent protection signal when the value of the current flowing through the output stage exceeds the overcurrent threshold when the output stage is in the first state, and then,
stop outputting the overcurrent protection signal when the state of the output stage changes to the second state, and
the error voltage change suppression circuit is configured to turn on the discharge switch during the output period of the overcurrent protection signal.

18. The power supply control device of claim 12, wherein
the output stage includes:
an output element comprising a switching element; and
a rectifier connected to the output element,
a coil is connected to a connection node between the output element and the rectifier,
the output voltage is generated based on the current flowing through the coil by switching the output element between on and off during the switching drive of the output stage,
the power supply control device further includes a slope voltage generation circuit configured to generate a slope voltage according to a current information of the coil,
the control drive circuit performs the switching drive of the output stage according to the error voltage and the slope voltage,
the slope voltage generation circuit monotonically changes the slope voltage in the first direction during an on period of the output element, and
the control drive circuit, after the output element is switched from off to on, switches the output element from on to off when the slope voltage reaches the error voltage in a process of changing the slope voltage in the first direction.

19. The power supply control device of claim 18, wherein when the overcurrent protection signal is output when the value of the current flowing through the output stage exceeds the overcurrent threshold while the output element is controlled to be turned on, the control drive circuit is configured to
switch off the output element in the overcurrent protection operation, and then
maintain the output element off at least until the value of the current flowing through the output stage falls below a predetermined release threshold, and the release threshold is lower than the overcurrent threshold.

20. A power supply control device, configured to control an output stage of a switching power supply device that generates an output voltage from an input voltage, the power supply control device comprising:
an error voltage generation circuit, configured to generate an error voltage according to a difference between a feedback voltage corresponding to the output voltage and a predetermined reference voltage;
a skip determination voltage generation circuit, configured to generate a skip determination voltage;
a skip signal generation circuit, configured to generate a skip signal having a first logical value or a second logical value based on the error voltage and the skip determination voltage; and
a control drive circuit, configured to
perform a switching drive of the output stage according to the error voltage when the skip signal has the first logical value, while
stop the switching drive of the output stage when the skip signal has the second logical value, wherein
the output voltage is generated from the input voltage through the switching drive of the output stage, and
the skip determination voltage generation circuit changes the skip determination voltage according to a temperature of the power supply control device.

21. The power supply control device of claim 20, wherein
the feedback voltage increases or decreases as the output voltage increases or decreases,
the error voltage generation circuit is configured to
change the error voltage in a first direction when the feedback voltage is lower than the reference voltage, while
change the error voltage in a second direction opposite to the first direction when the feedback voltage is higher than the reference voltage,
the skip signal generation circuit is configured to generate the skip signal based on a level relationship between the error voltage and the skip determination voltage, wherein
the skip signal generation circuit
generates the skip signal having the first logical value when the skip determination voltage is different from the error voltage in the second direction, while
generates the skip signal having the second logical value when the skip determination voltage is different from the error voltage in the first direction, and
the skip signal generation circuit changes the skip determination voltage in the first direction as the temperature increases.

22. The power supply control device of claim 21, wherein the skip signal generation circuit changes the skip determination voltage continuously or stepwise in the first direction as the temperature increases.

23. The power supply control device of claim 21, wherein
the first direction is an upward direction, and the second direction is a downward direction, and
the skip signal generation circuit is configured to
generate the skip signal having the first logical value when the skip determination voltage is lower than the error voltage, while
generate the skip signal having the second logical value when the skip determination voltage is higher than the error voltage.

24. The power supply control device of claim 21, wherein
the first direction is a downward direction, and the second direction is an upward direction, and
the skip signal generation circuit is configured to
generate the skip signal having the first logical value when the skip determination voltage is higher than the error voltage, while
generate the skip signal having the second logical value when the skip determination voltage is lower than the error voltage.

25. The power supply control device of claim 20, wherein
the output stage includes:
an output element comprising a switching element; and
a rectifier connected to the output element,
a coil is connected to a connection node between the output element and the rectifier,
the output voltage is generated based on the current flowing through the coil by switching the output element between on and off during the switching drive of the output stage,
the power supply control device further includes a slope voltage generation circuit configured to generate a slope voltage according to a current information of the coil, and
the control drive circuit performs the switching drive of the output stage according to the error voltage and the slope voltage when the skip signal has the first logical value.
